(19) United States
(12) Patent Application Publication
(10) Pub. No.: US 2002/0019983 A1
(43) Pub. Date: Feb. 14, 2002

(54) Testing instrument

(76) Inventors: Brett W. Emsley, Indianapolis, IN (US); James E. Harris, Indianapolis, IN (US); Dennis Orndorff, Greenfield, IN (US); Gregg S. Rodgers, Noblesville, IN (US); Gary W. Sinde, Indianapolis, IN (US)

Correspondence Address: Barnes & Thornburg, 11 S. Meridian Street, Indianapolis, IN, 46204, US

(21) Appl. No.: 09/844,413

(22) Filed: Apr. 27, 2001

Related U.S. Application Data
(63) Continuation-in-part of application No. 09/796,258, filed on Feb. 28, 2001.
(60) Provisional application No. 60/209,236, filed on Jun. 5, 2000.

(51) Int. Cl. H04N 7/173; H04N 17/02

(52) U.S. Cl. 725/107; 348/180

(57) ABSTRACT

An instrument for testing a CATV network includes an input port for receiving first information from the network, a computer coupled to the input port for processing the first information received from the network, a user interface permitting a user to create second information for communication over the network, and a serial port for coupling the second information to the network. The instrument also includes a signature pad permitting a user to enter handwritten communication for transmission over the network, and a port for coupling handwritten communication-related signals to the network. The instrument also includes an ethernet interface for coupling the second information to the network.

### FIELD OF THE INVENTION

This invention relates to instruments for the testing of networks. It is disclosed in the context of a test instrument for testing CATV systems, but is believed to be useful in other applications as well.

### DISCLOSURE OF THE INVENTION

According to one aspect of the invention, an instrument for testing a CATV network includes an input port for receiving first information from the network, a computer coupled to the input port for processing the first information received from the network, a user interface permitting a user to create second information for communication over the network, and a serial port for coupling the second information to the network.

According to another aspect of the invention, an instrument for testing a CATV network includes an input port for receiving first information from the network, a computer coupled to the input port for processing the first information, a signature pad permitting a user to enter handwritten communication for transmission over the network, and a port for coupling handwritten communication-related signals to the network.

According to another aspect of the invention, an instrument for testing a CATV network includes an input port for receiving first information from the network, a computer coupled to the input port for processing the first information, a user interface permitting a user to create second information for communication over the network, and an ethernet interface for coupling the second information to the network.

Illustratively according to the invention, the instrument includes a Web browser capable of handling internet communication protocols.

Illustratively according to the invention, the input port and output port are RF ports.

Illustratively according to the invention, the instrument further includes an analog-to-digital (A/D) converter for converting first analog information to first digital information.

Illustratively according to the invention, the instrument further includes a digital signal processor (DSP), the A/D converter coupled to the DSP for processing the first digital information.

Illustratively according to the invention, the serial port is an RS-232 port.

Illustratively according to the invention, the instrument further includes an audio transducer coupled to the computer for producing audio signals in response to third information received from the computer.

Illustratively according to the invention, the instrument further includes a digital-to-analog (D/A) converter coupled between the computer and the audio transducer for converting the third information into signals to be transduced by the audio transducer.

Illustratively according to the invention, the instrument further includes a digital signal processor (DSP) coupled to the computer and to the D/A converter for processing third information and for supplying processed third information to the D/A converter.

According to another aspect of the invention, an instrument for determining received signal power includes a receiver for receiving the signal and a device for multiplying the received signal amplitude by the sine and cosine, squaring these products, and adding the squared products together to produce an indication of the received signal power.

Illustratively according to the invention, the instrument further includes an analog-to-digital (A/D) converter coupled to the receiver for sampling the received signal amplitude and to the device for providing sampled received signal amplitudes to the device for multiplying by the sine and cosine.

### BRIEF DESCRIPTION OF THE DRAWINGS

The invention may best be understood by referring to the following detailed description and accompanying drawings which illustrate the invention. In the drawings:

FIG. 1 illustrates a block diagram of the digital portion of a test instrument constructed according to the invention;

FIG. 2 illustrates a block diagram of the RF portion of a test instrument constructed according to the invention;

FIG. 3 illustrates block diagrams of additional and/or alternative details to some of the details illustrated in FIG. 2; and, FIGS. 4a-66 illustrate more detailed schematic diagrams of an instrument constructed according to the invention.

### DETAILED DESCRIPTIONS OF ILLUSTRATIVE EMBODIMENTS

In the descriptions that follow, circuit schematic and block diagrams will be described. In many cases, specific components, specific sources, and in some cases, specific terminal, pin and port names and numbers of those components will be provided. However, it is to be understood that other components capable of performing equivalent functions to those specifically identified components may be available from the same, or different, sources, and that the various terminals, pins and ports of any such equivalent components may have different names and numbers. Thus, this invention is not limited to the specifically identified components or the specifically identified sources.

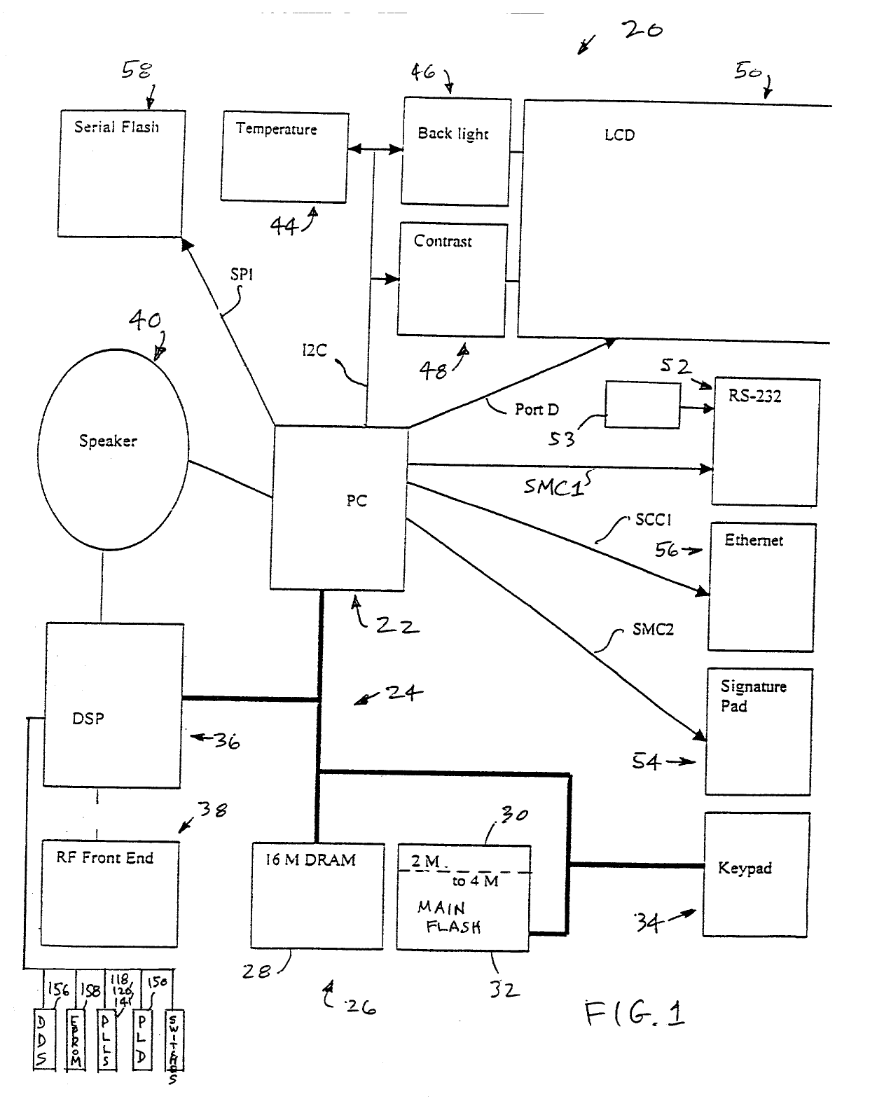

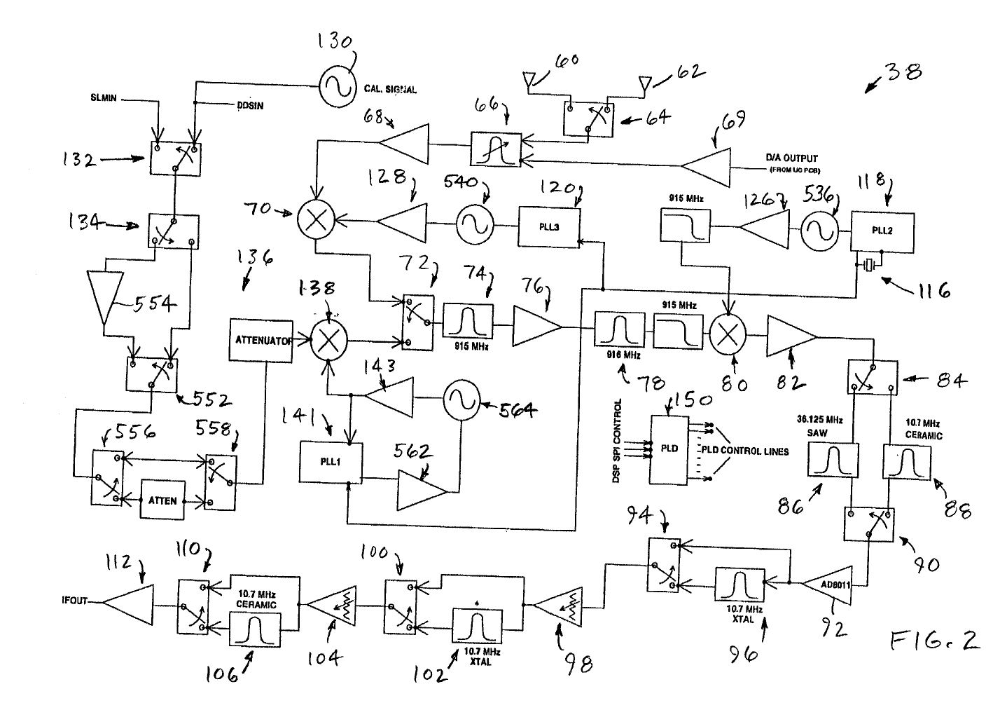

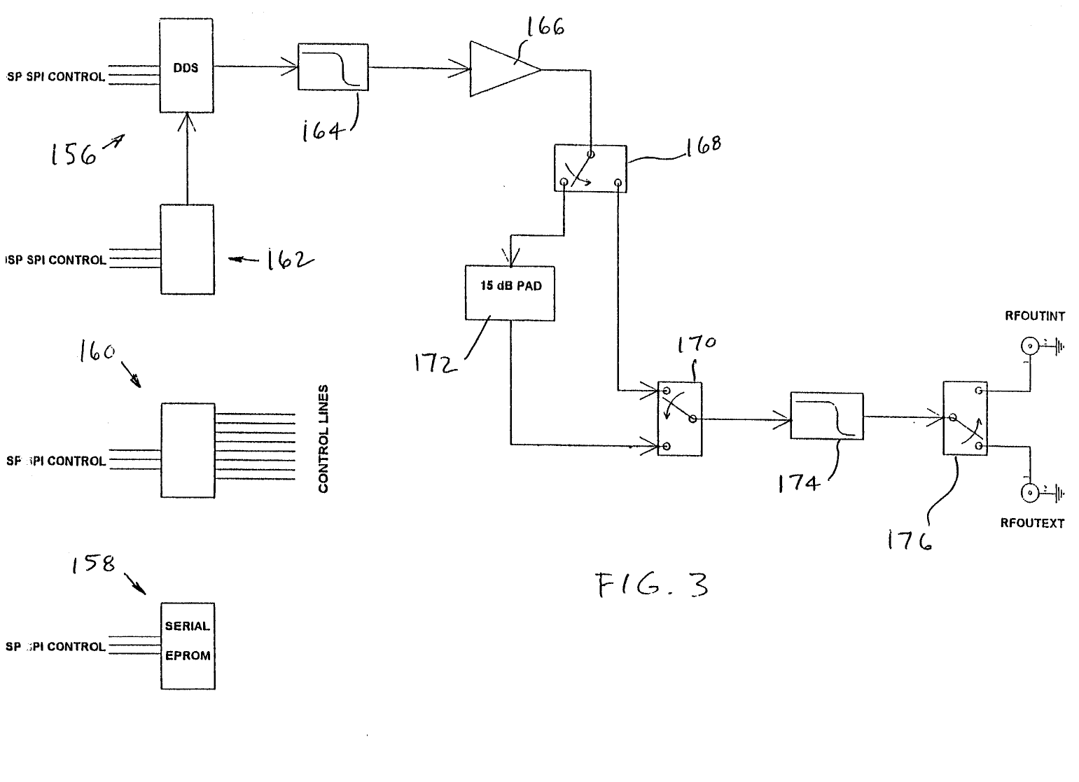

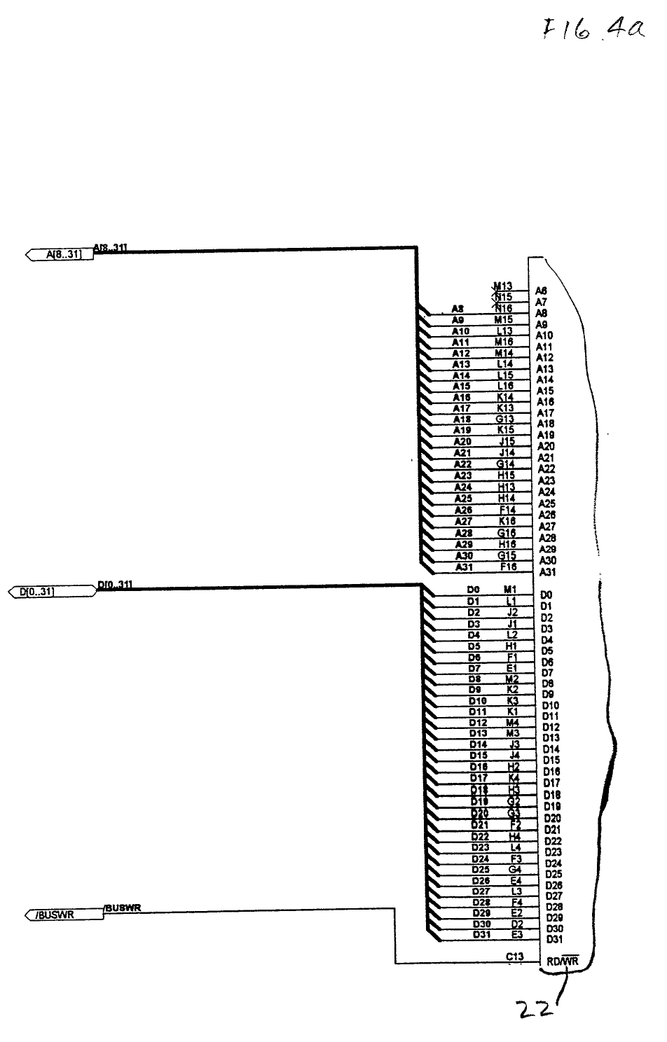

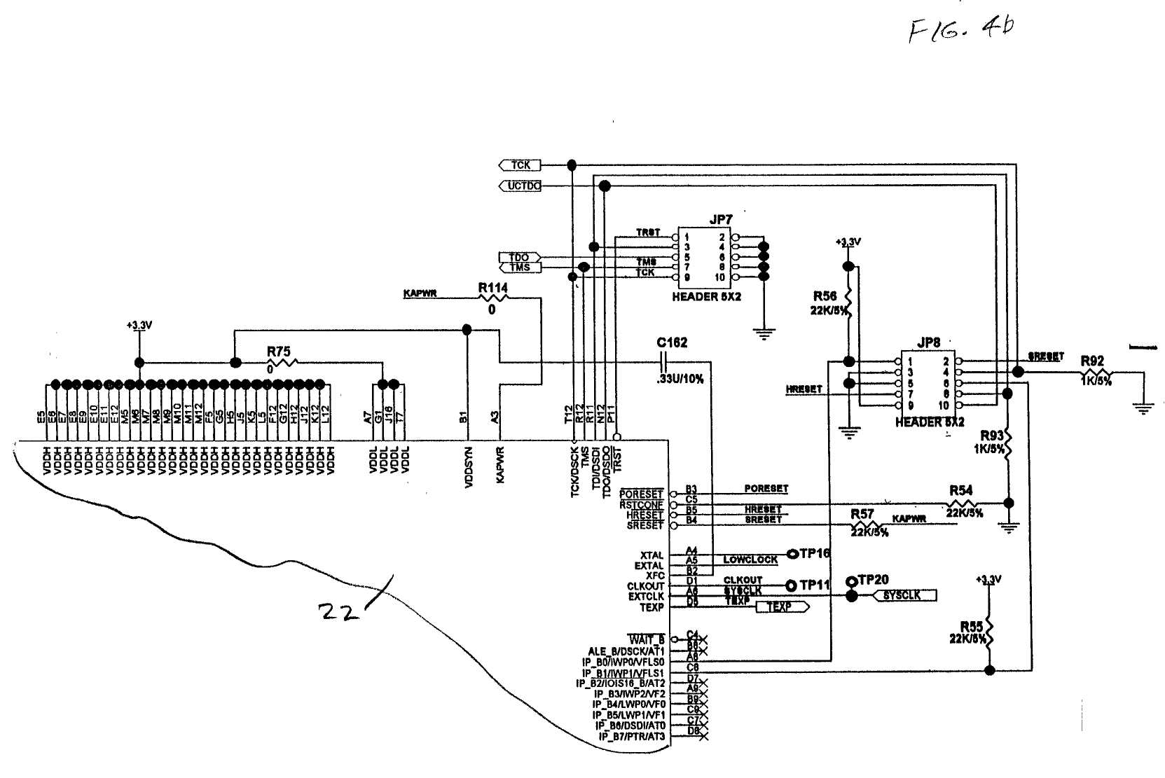

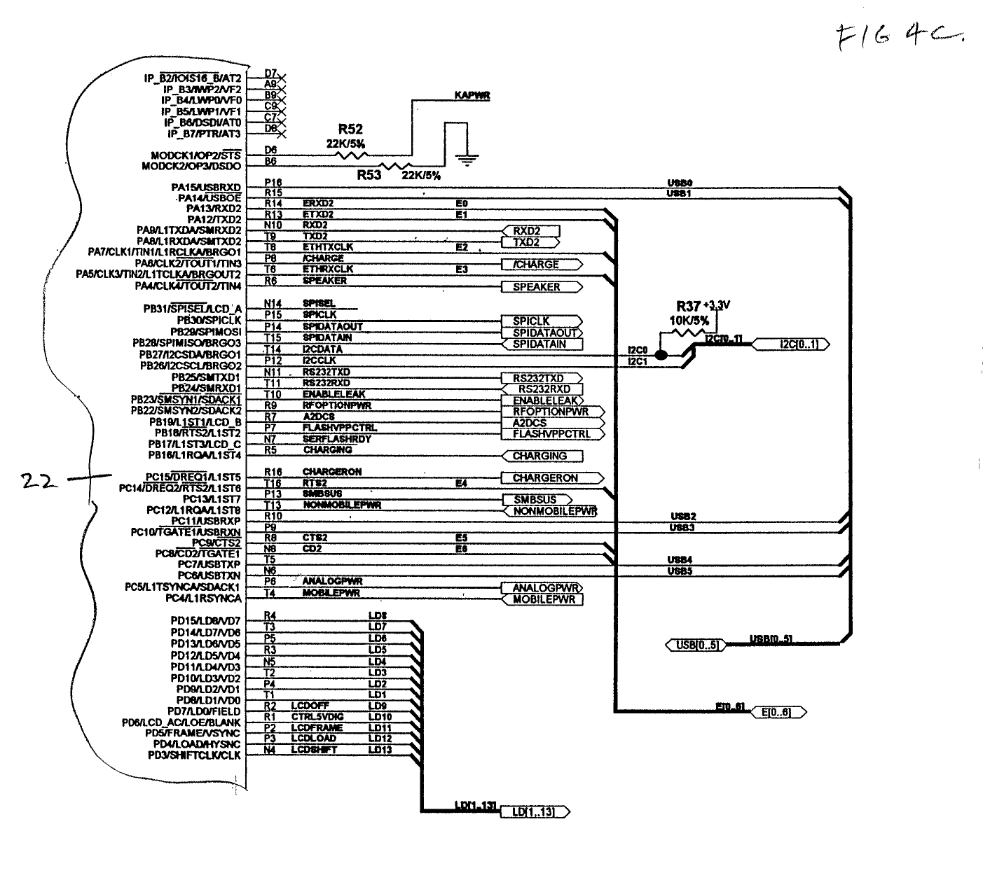

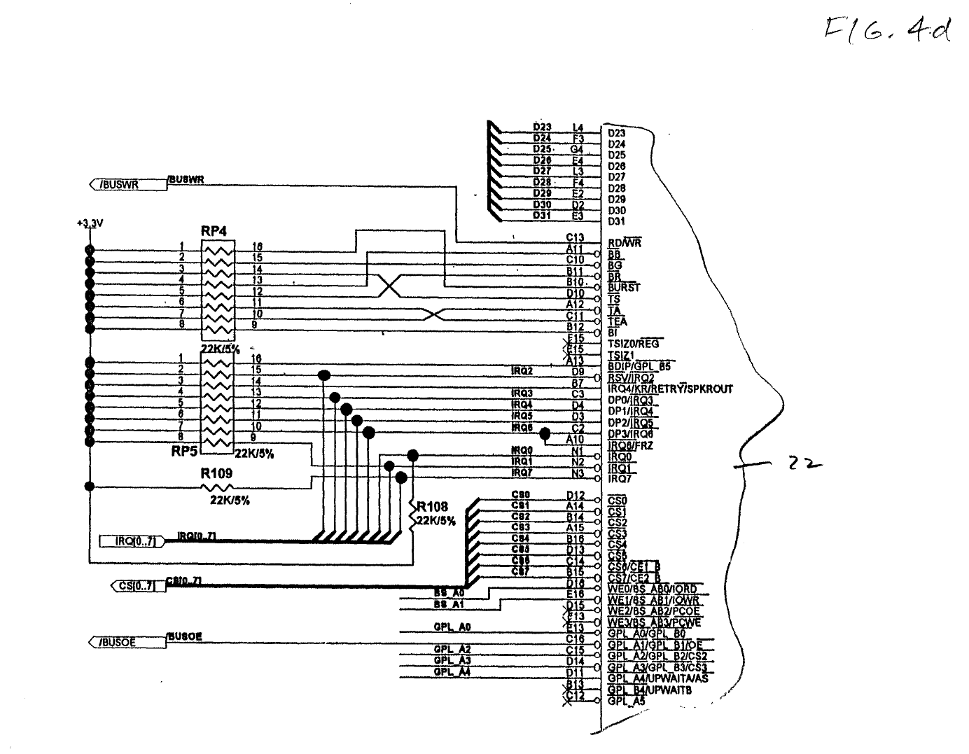

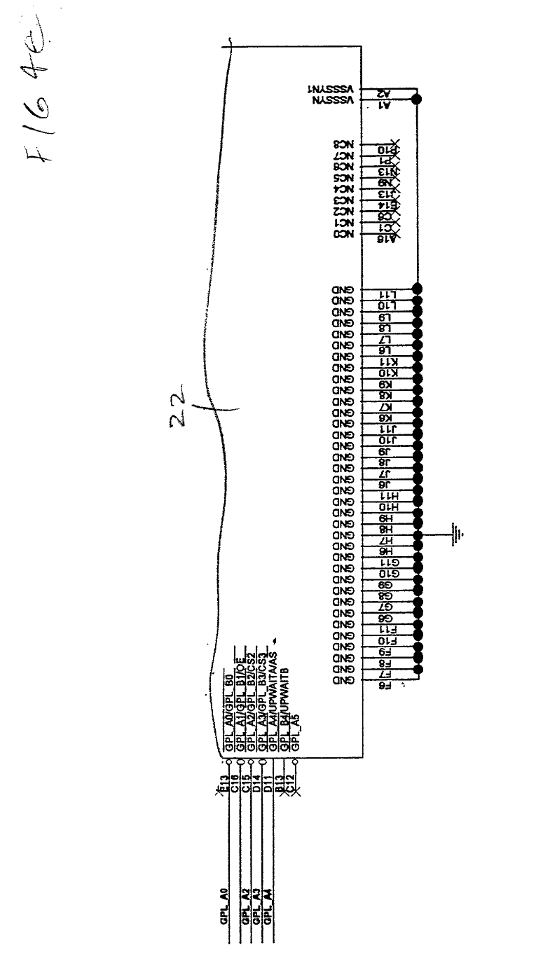

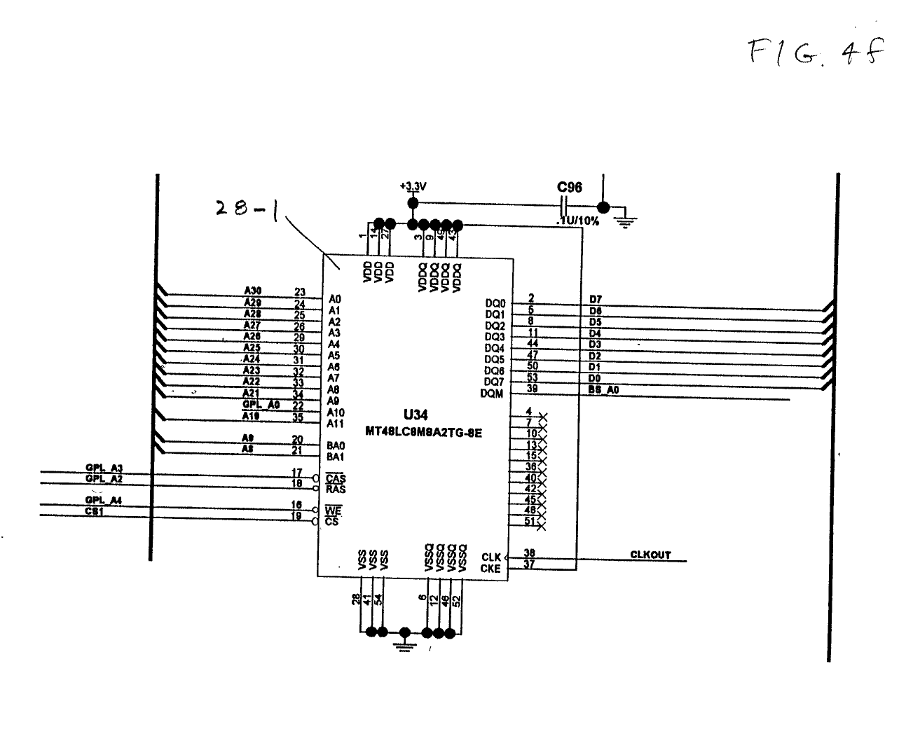

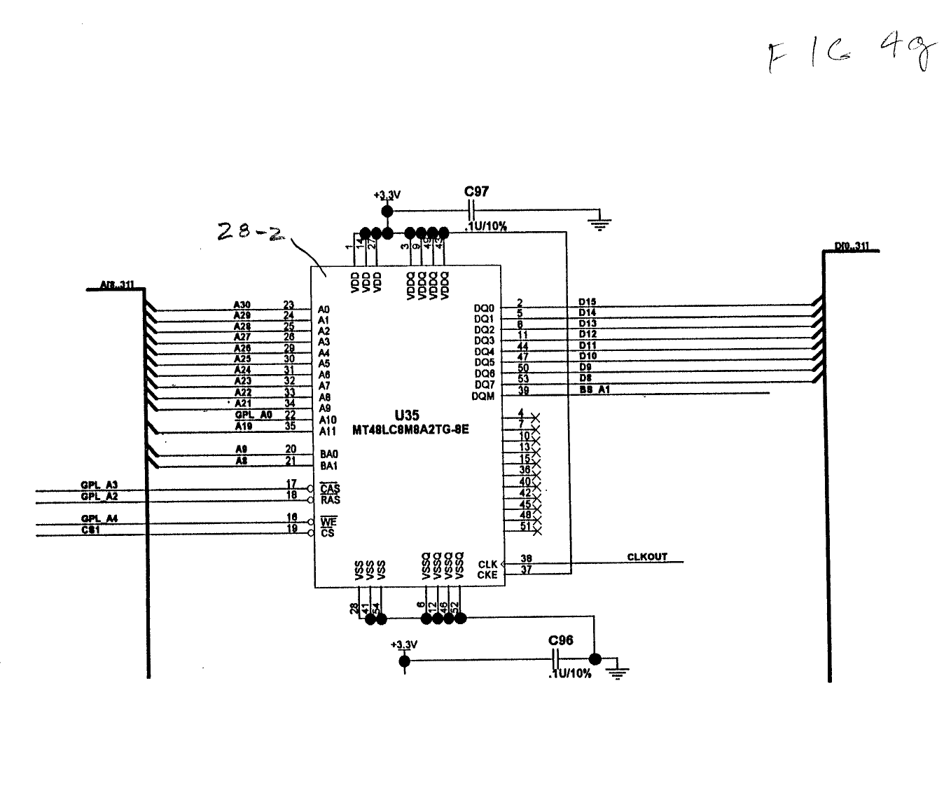

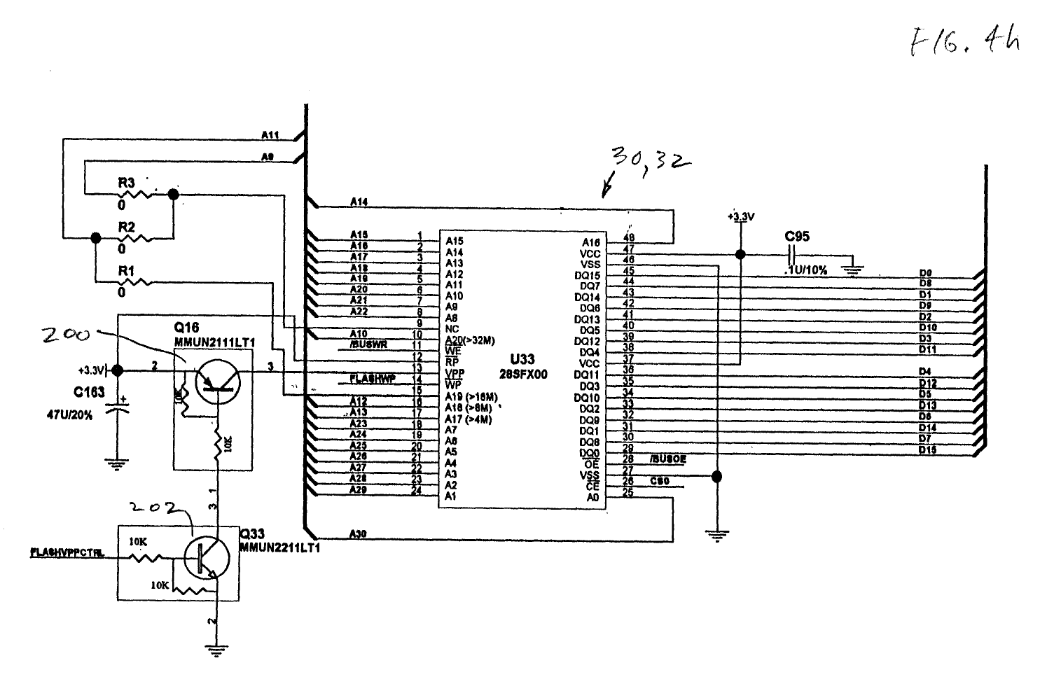

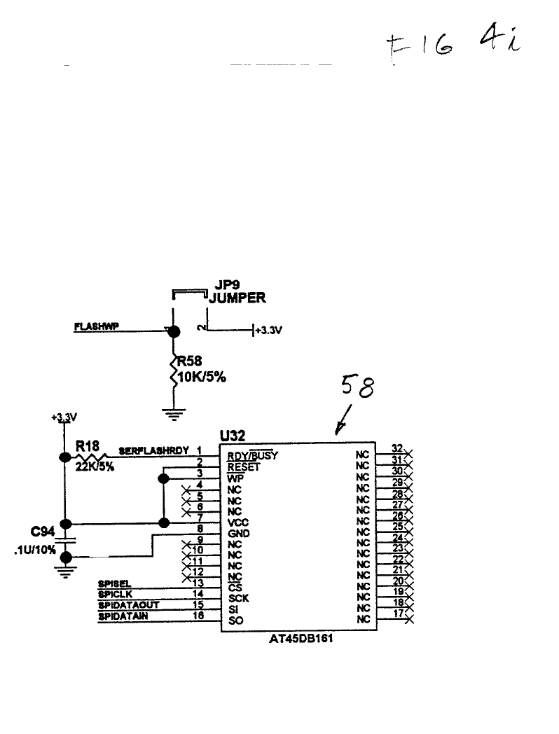

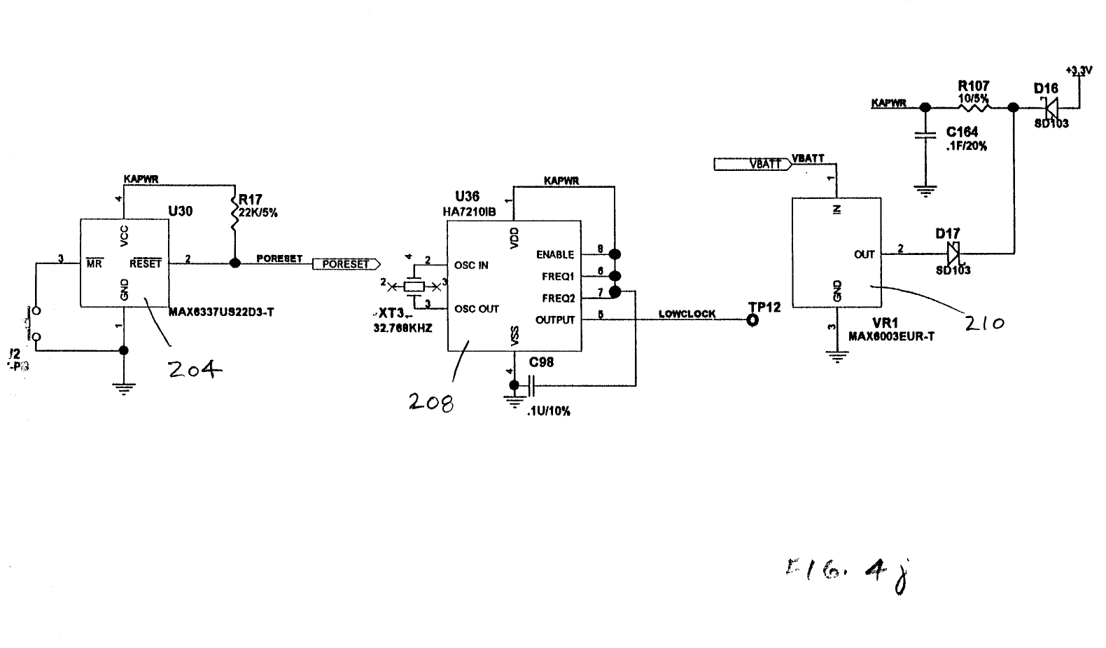

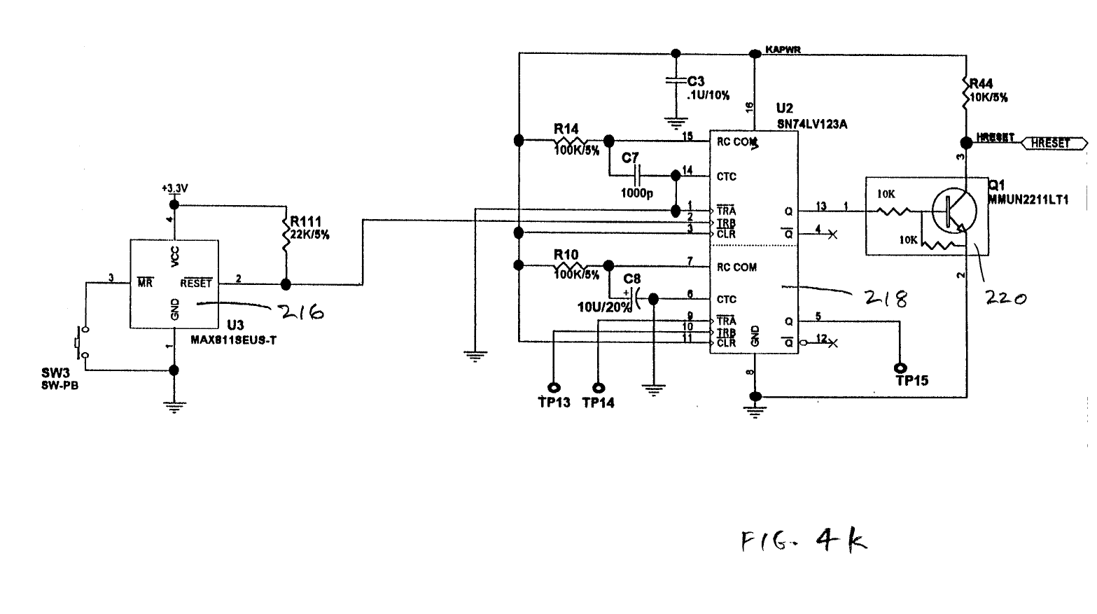

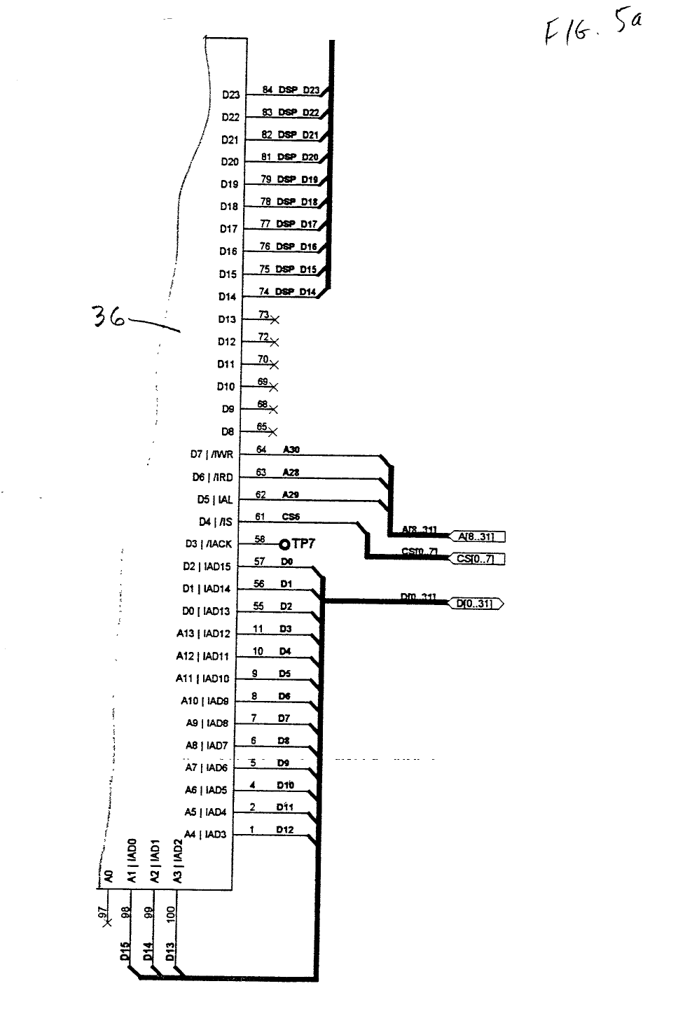

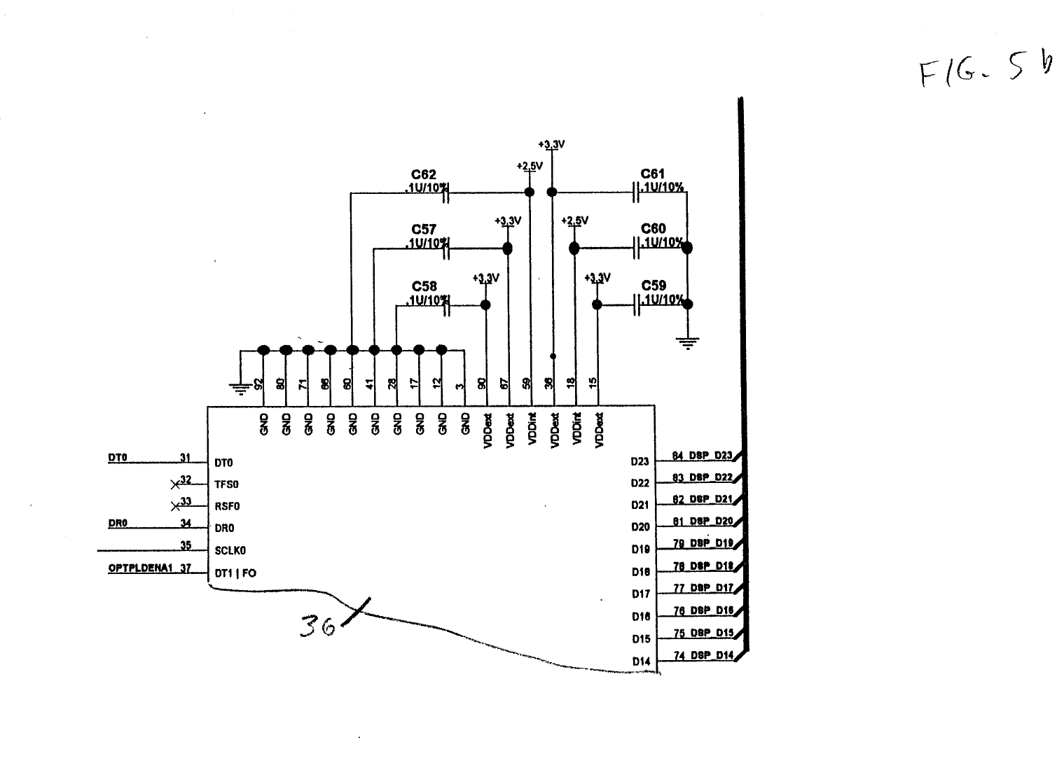

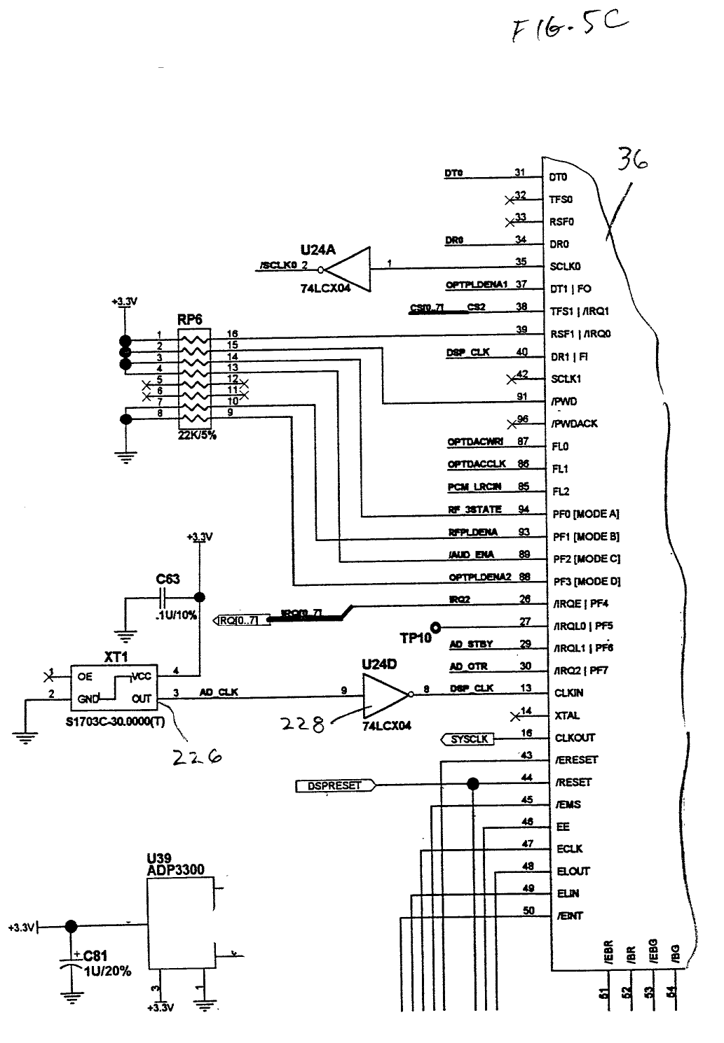

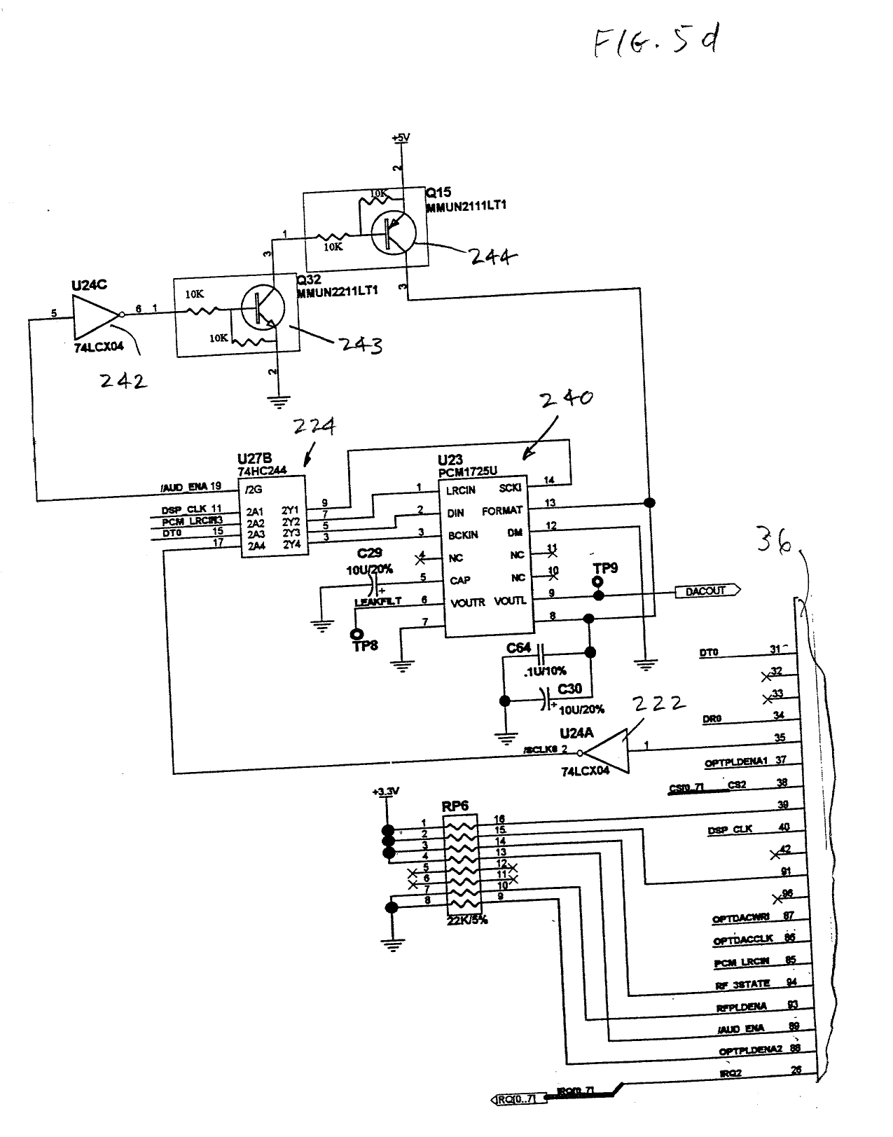

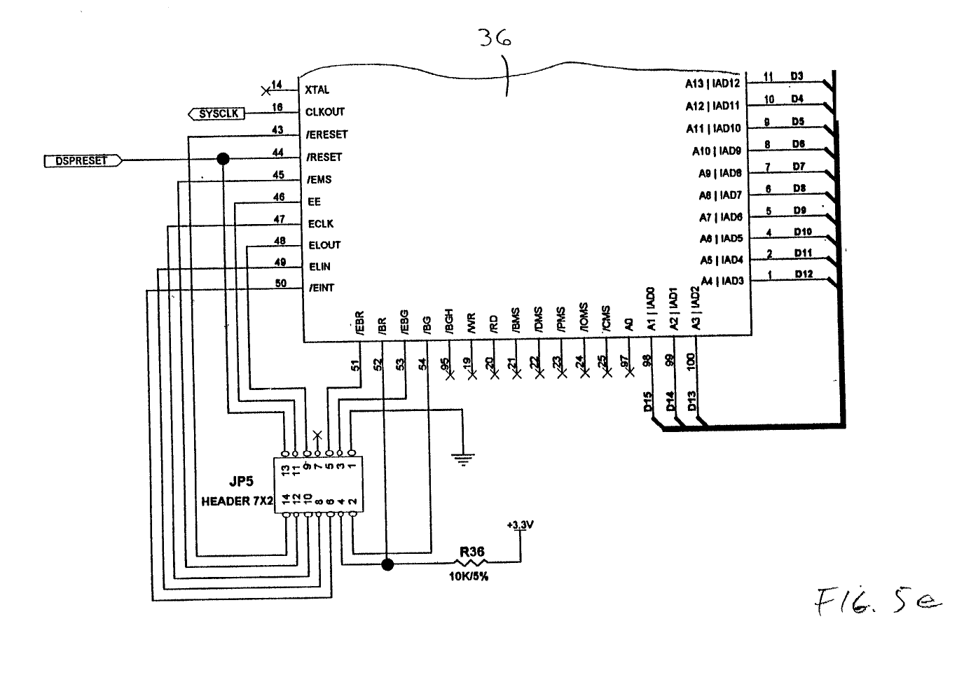

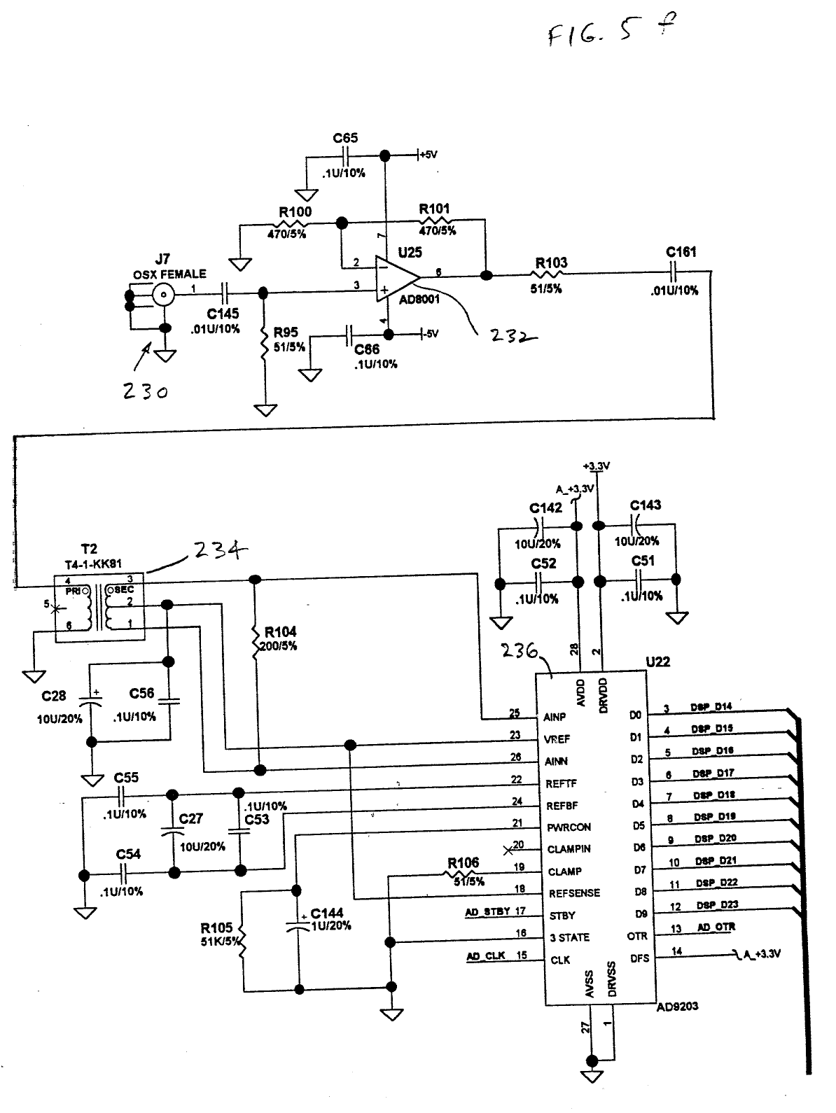

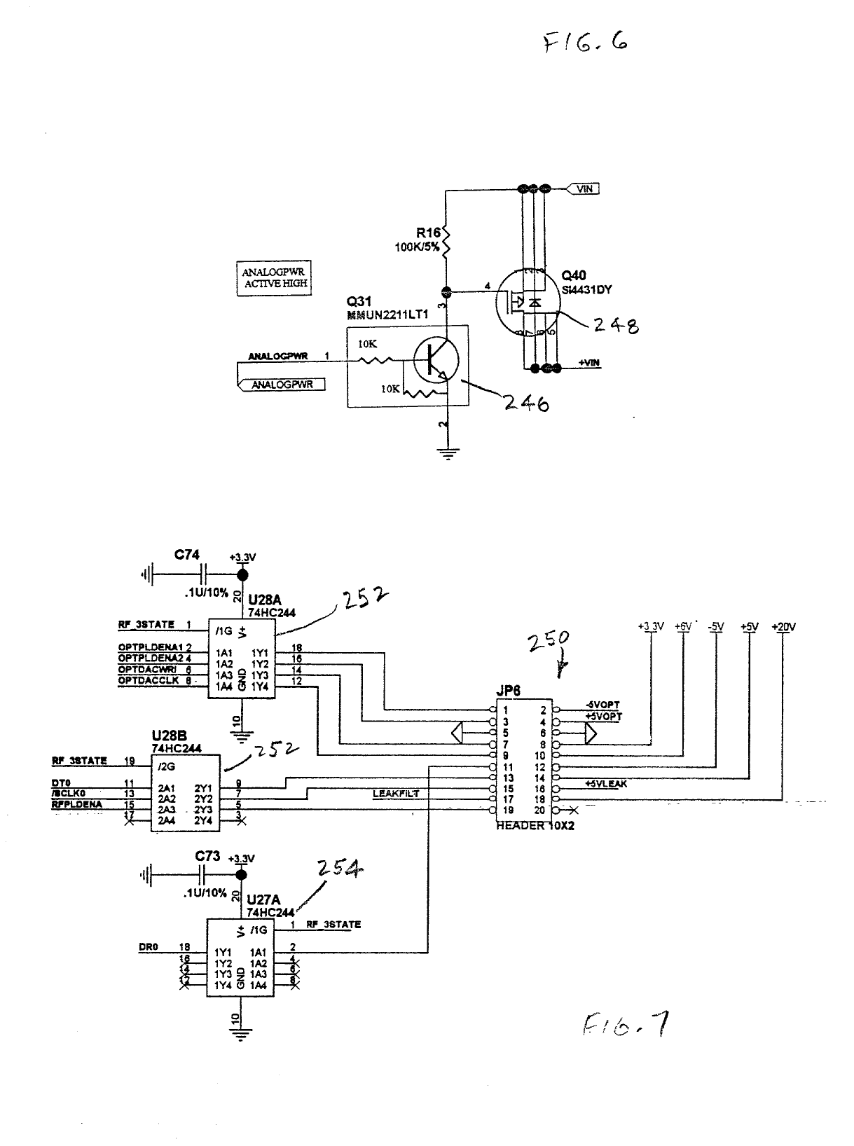

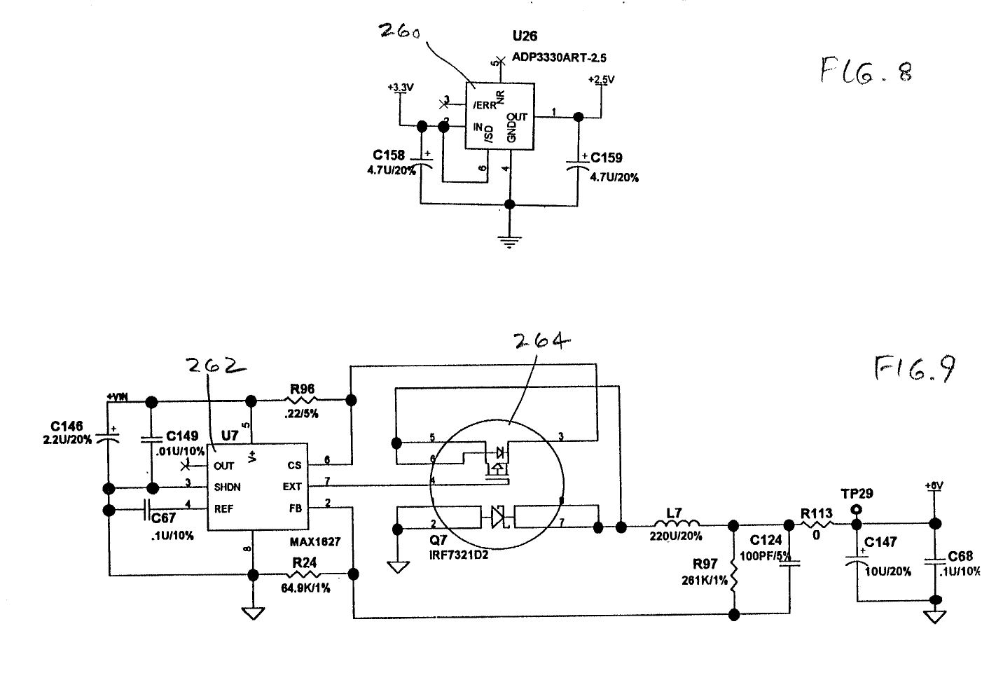

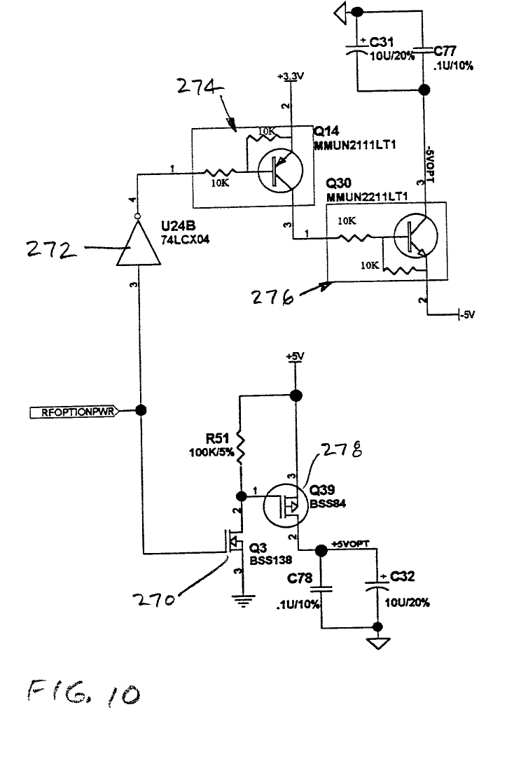

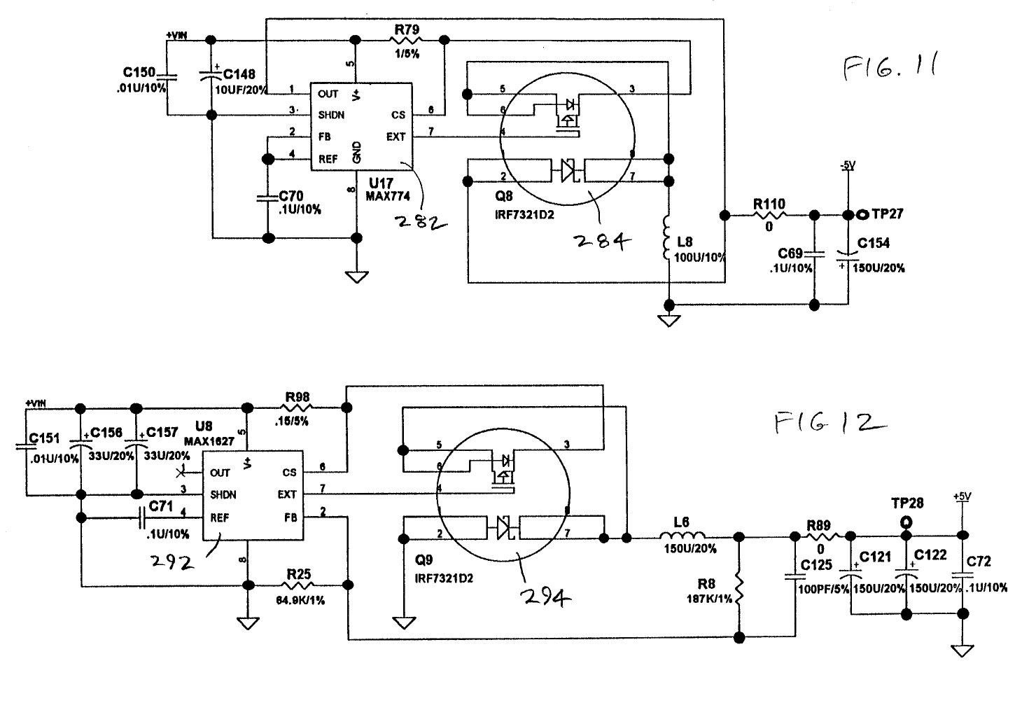

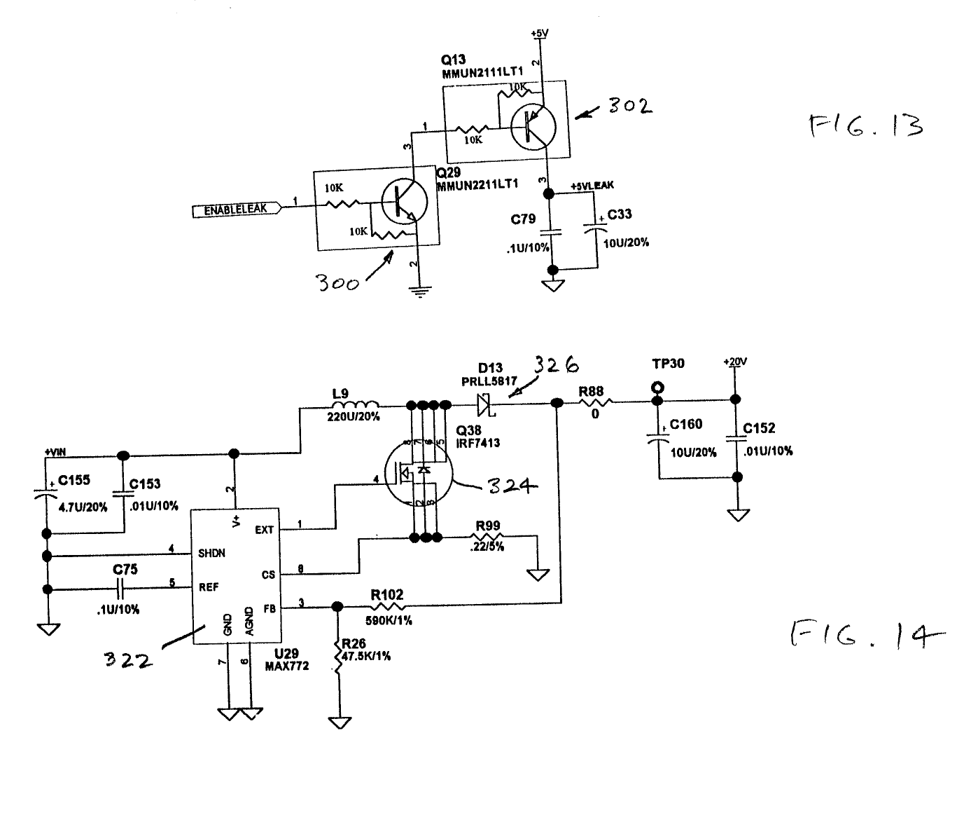

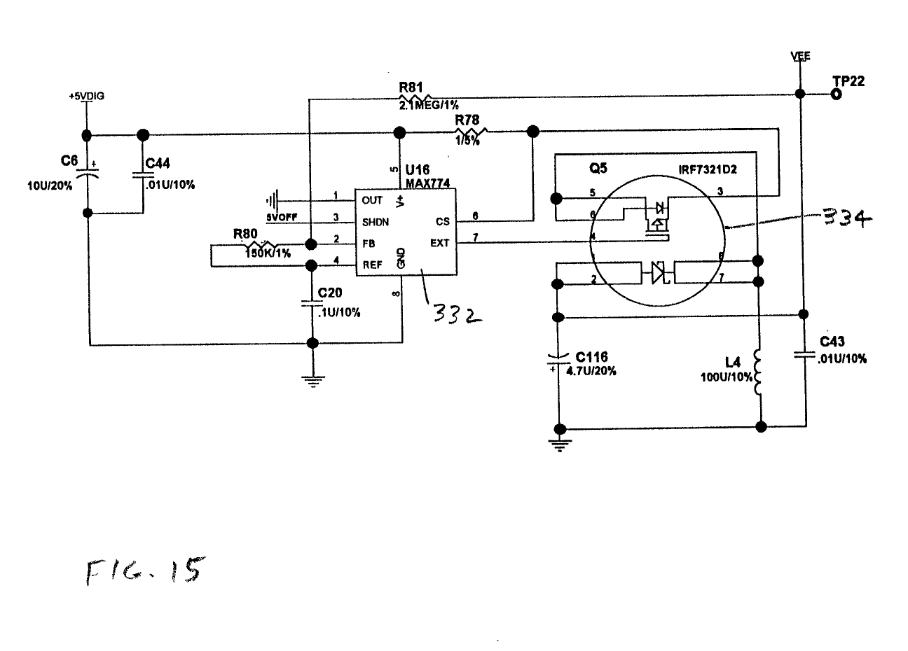

Turning now to FIG. 1, an instrument 20 constructed according to the invention is controlled by a computer 22 such as, for example, a Motorola XPC823ZT66 Power PC. Computer 22 will sometimes be referred to hereinafter as μC 22. A thirty-two bit bus 24 couples μC 22 to a memory 26 including, for example, a 16 Mbyte dynamic random access memory (DRAM) 28, a 2 Mbyte main up to a 4 Mbyte main flash memory 30. DRAM 28 may be, for example, a Micron type MT48LC8M8A2TG-8E DRAM. Main flash memory 30 may be, for example, a Sharp type LH28F160BVHE-BTL90 memory. A telephone-type keypad user interface 34 resides on bus 24. A digital signal processor (DSP) 36, such as, for example, an Analog Devices type ADSP-2189 DSP, is also coupled to the bus 24. DSP 36, under the control of μC 22, provides the instrument 20's interface to the instrument 20's RF section 38 and analog-to-digital converter (A/D) that converts signals from the RF section 38 for processing by the digital section of instrument 20. A/D may be, for example, an Analog Devices AD9203. An audio transducer 40 receives input both from the μC 22, for simple tones, and from the DSP 36, for more complex audio control.

An I² C port of μC 22 is coupled to a temperature sensor 44 such as, for example, a Dallas Semiconductor type DS75S temperature sensor, to an LCD backlight controller 46, such as, for example, a Maxim type MAX1611 IC, and to an LCD contrast controller 48, such as, for example, a Maxim type MAX1621 IC. The backlight and contrast controllers 46, 48, and port D of the μC 22 are all coupled to a display 50, such as, for example, a Hantronix, Inc., type HDM3224-1-M20F, one-quarter VGA LCD subsystem running 2-bit per pixel gray scale, or a color LCD display. The SMC1 port of μC 22 is coupled to an RS-232 port 52, such as, for example, a Maxim type MAX3226ECAE IC RS-232 interface IC. A bar code scanner 53 can be coupled to the RS-232 port 52 to permit scanning of the bar codes with which CATV system equipment, including subscriber terminal equipment, is often provided. The SMC2 port of μC 22 is coupled to a signature pad 54, such as, for example, a 9600 baud serial Interlink Electronics Versapad VP8000 touchpad. The SCC1 port of μC 22 is coupled to an ethernet interface 56, such as, for example, a 10 Mbit Level One type LXT901ALC IC ethernet interface IC. The SPI port of μC 22 is coupled to a memory 58, such as, for example, an Atmel type AT45DB161-TC 256K to 4 M serial flash memory, for storing customer files, DSP algorithms, calibration tables, channel plans, and the like.

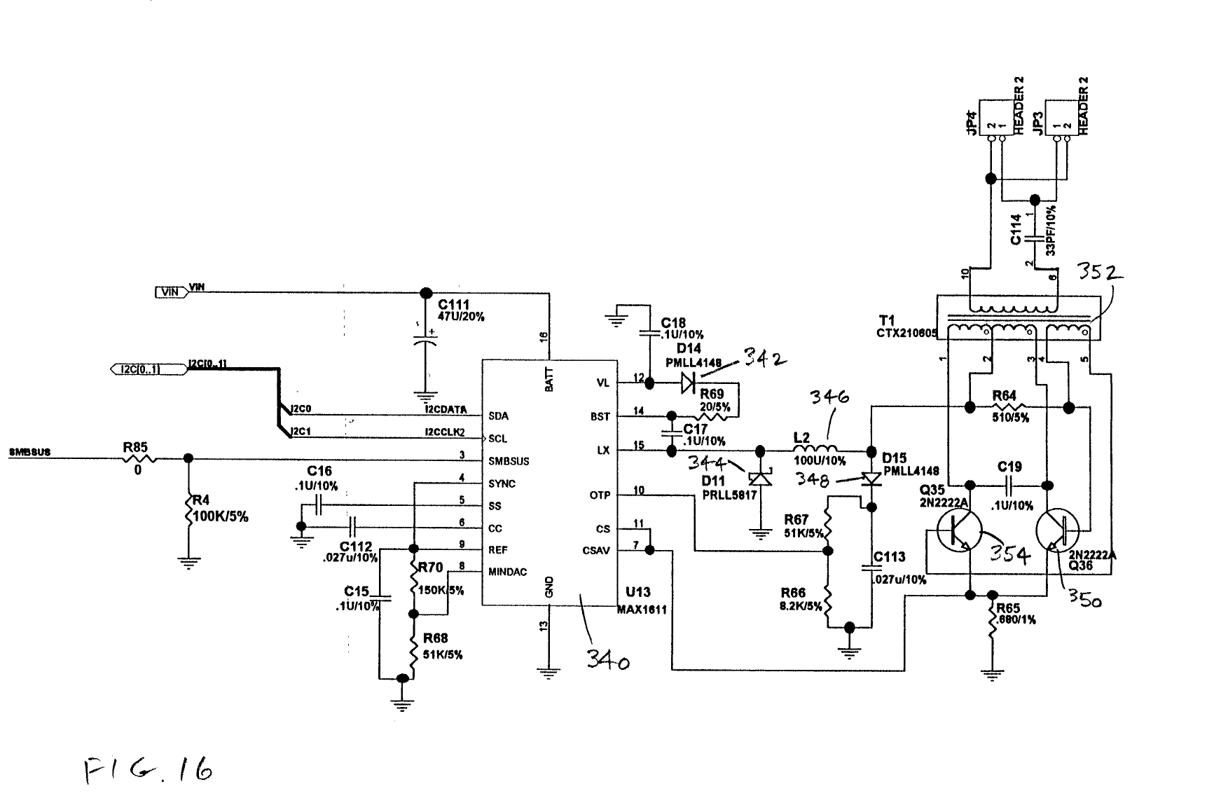

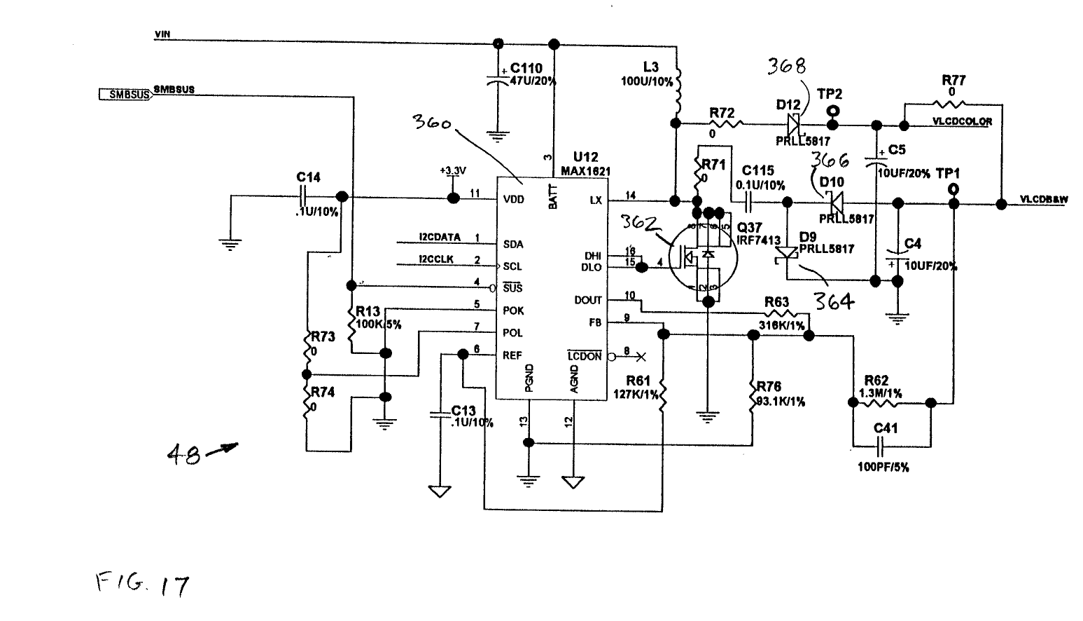

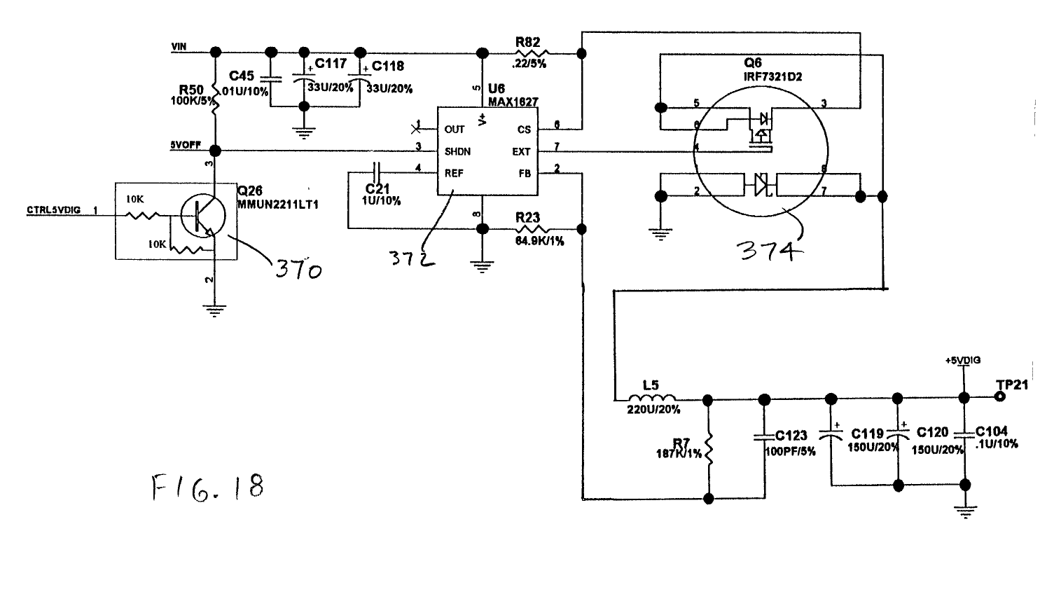

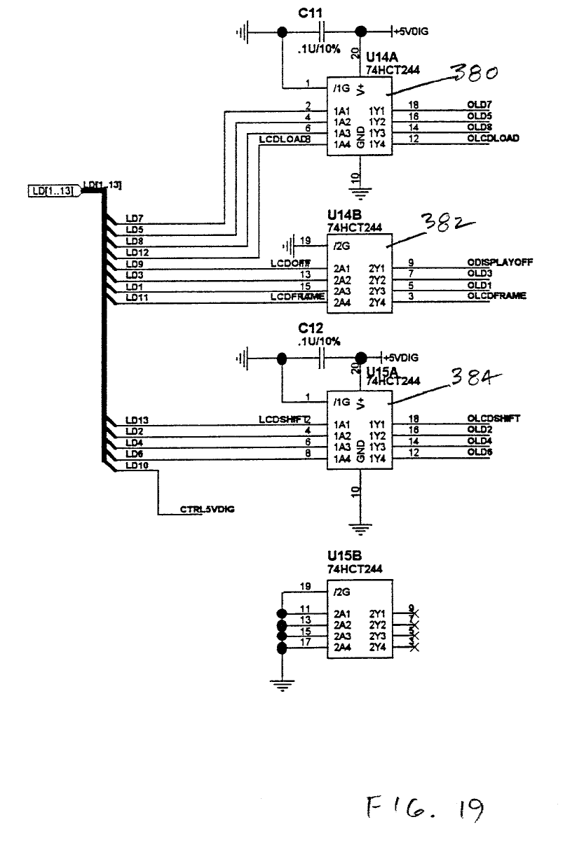

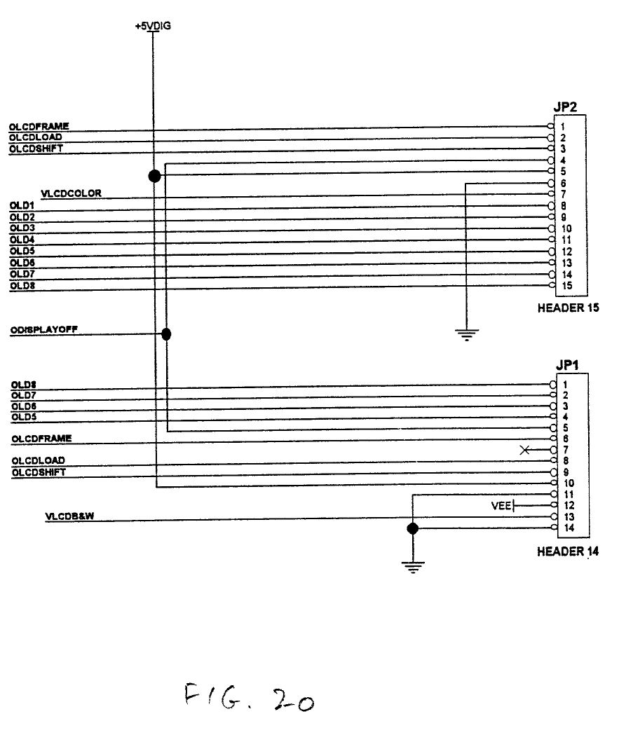

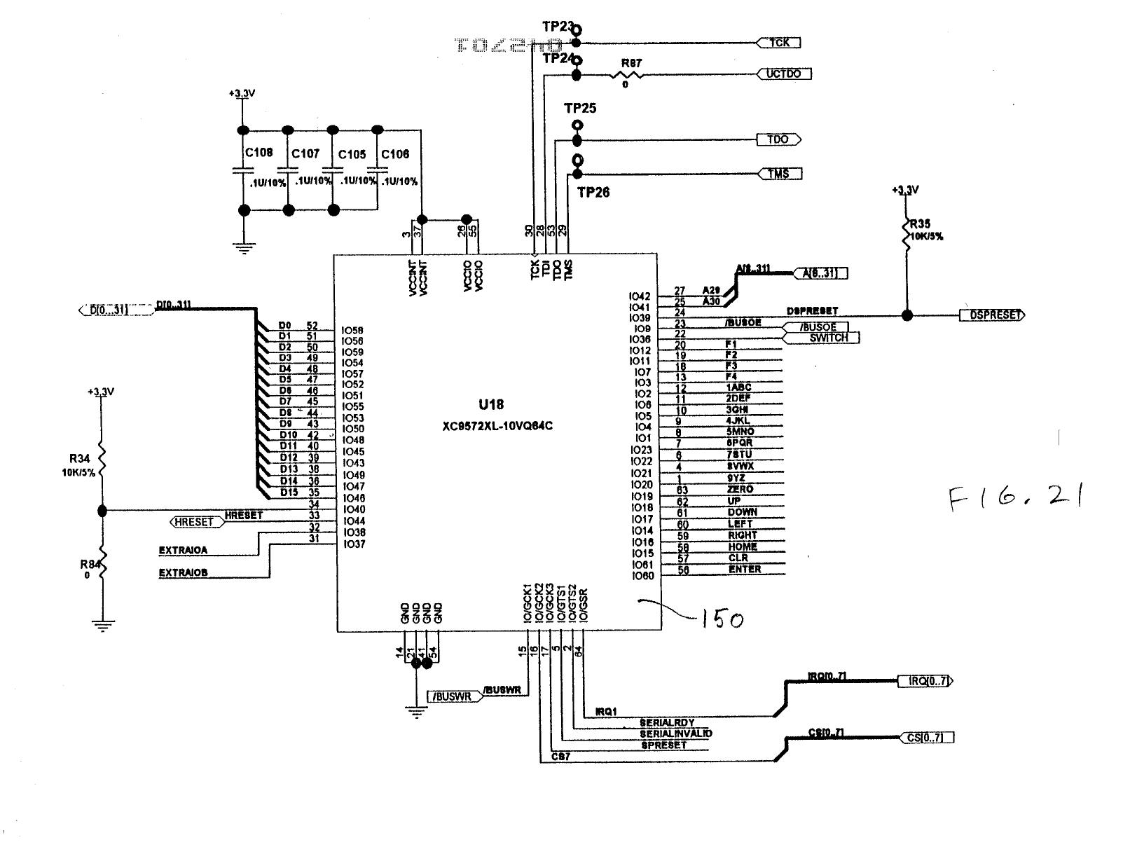

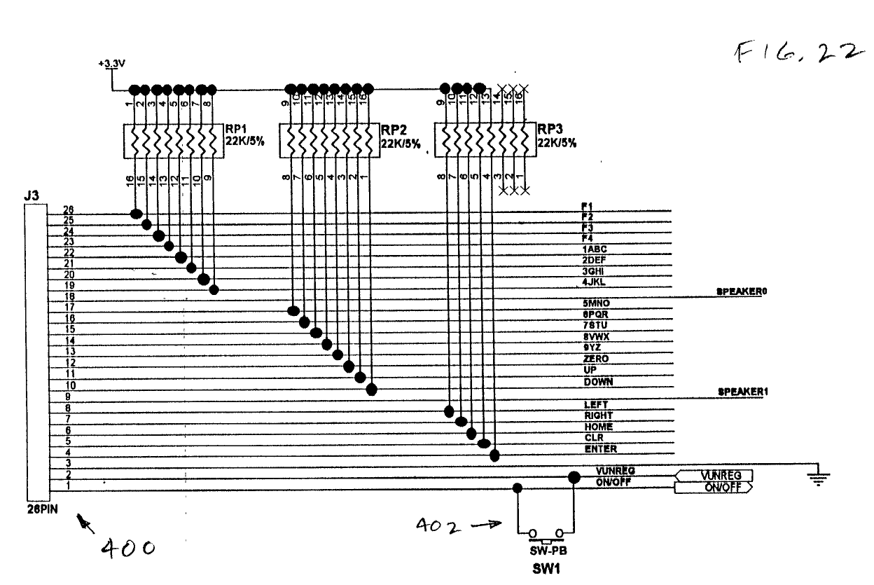

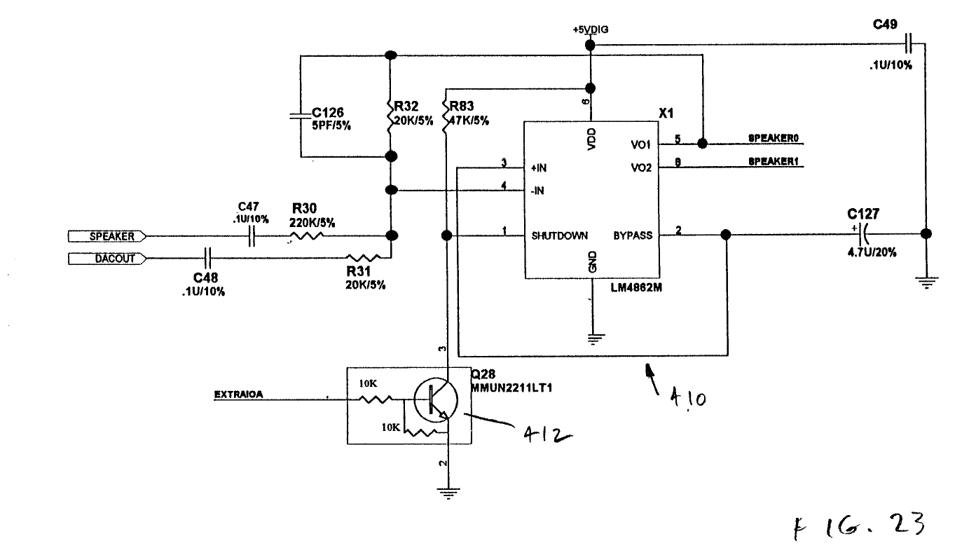

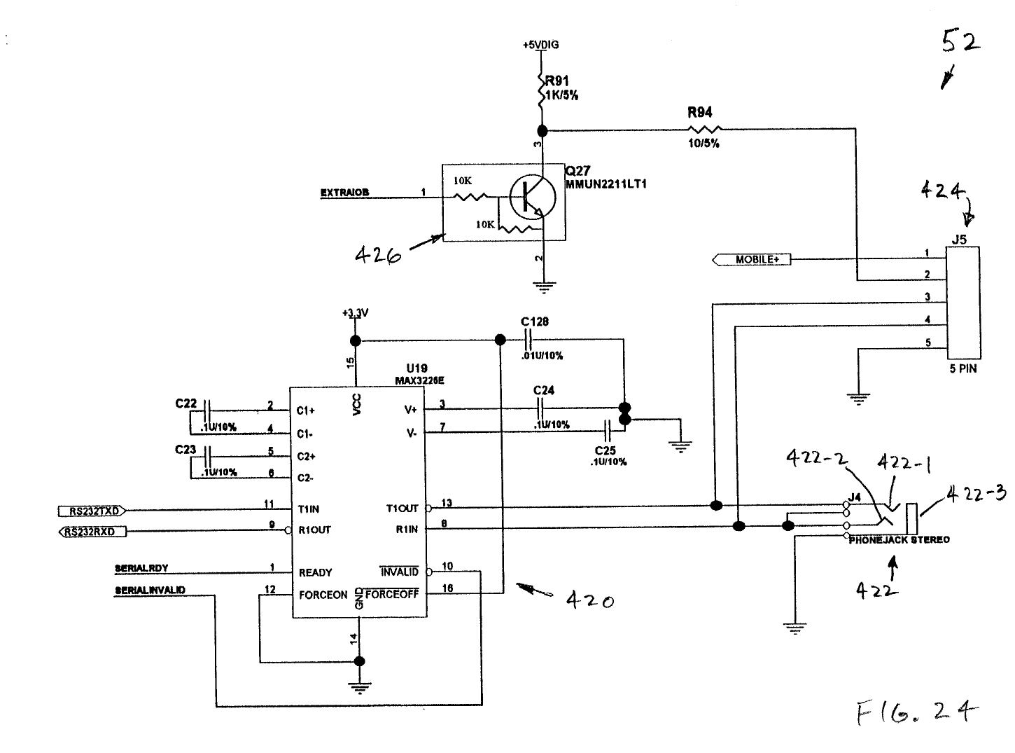

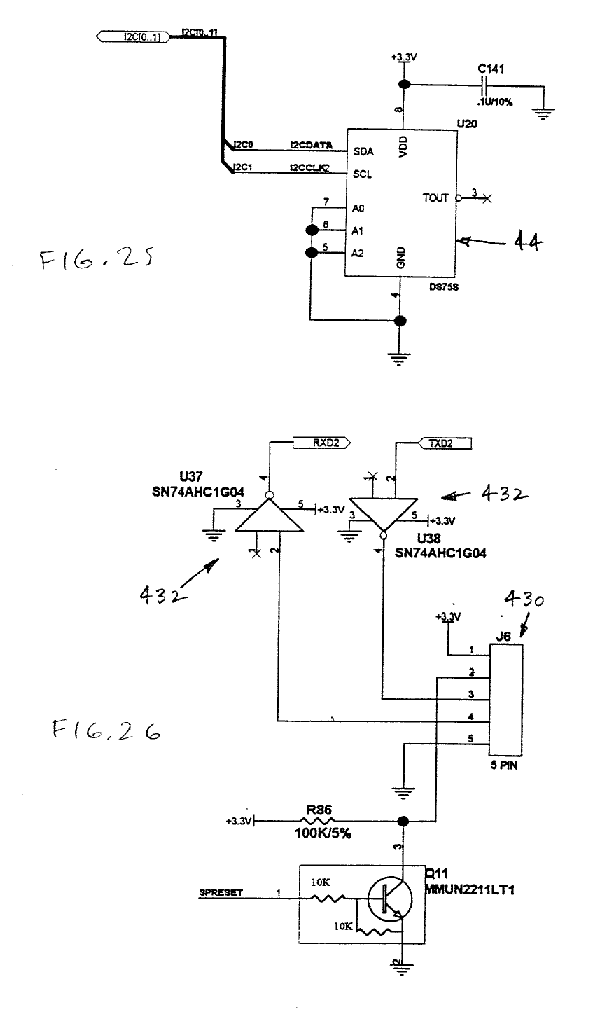

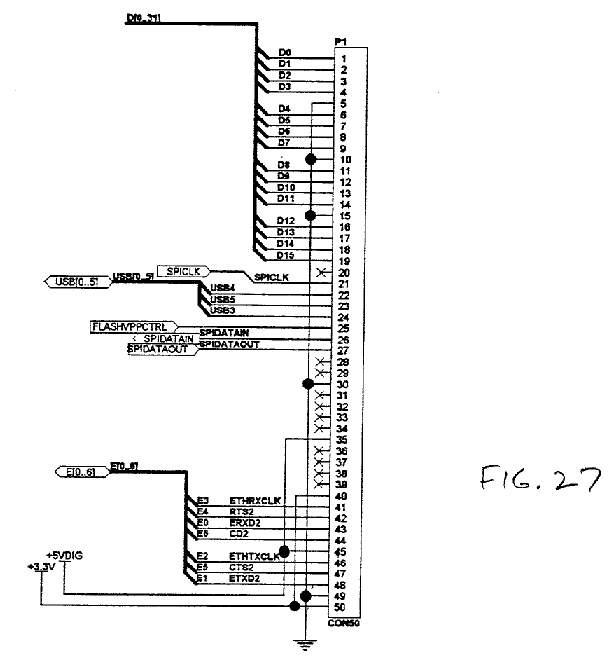

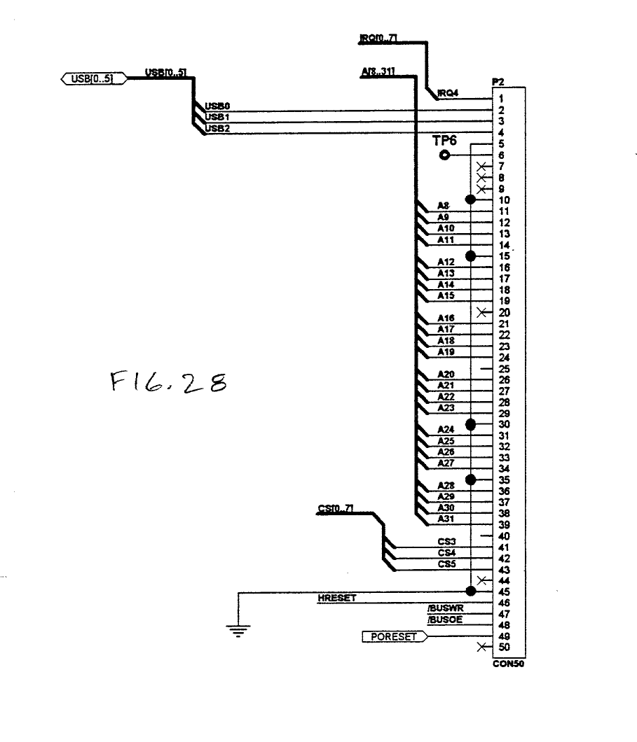

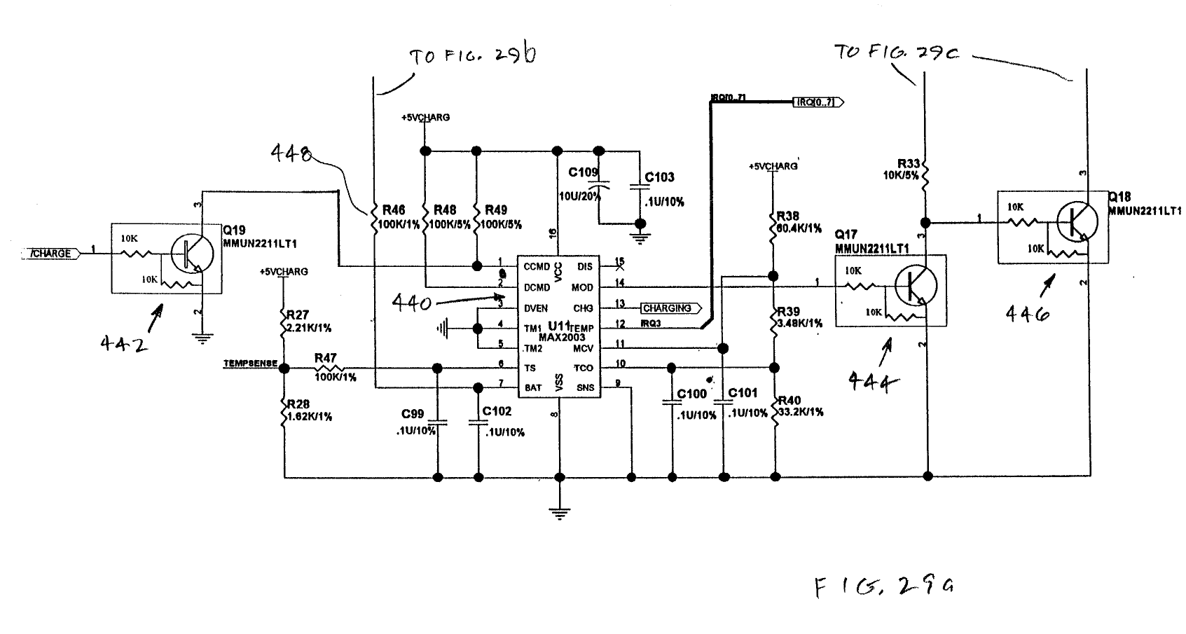

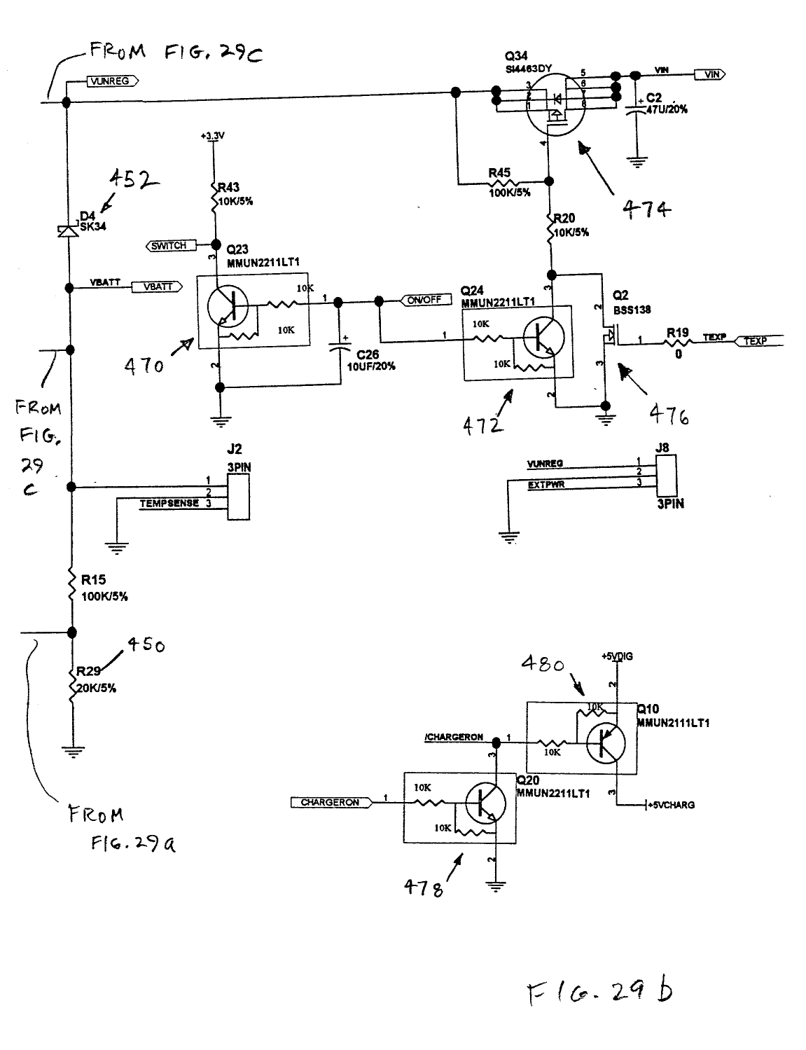

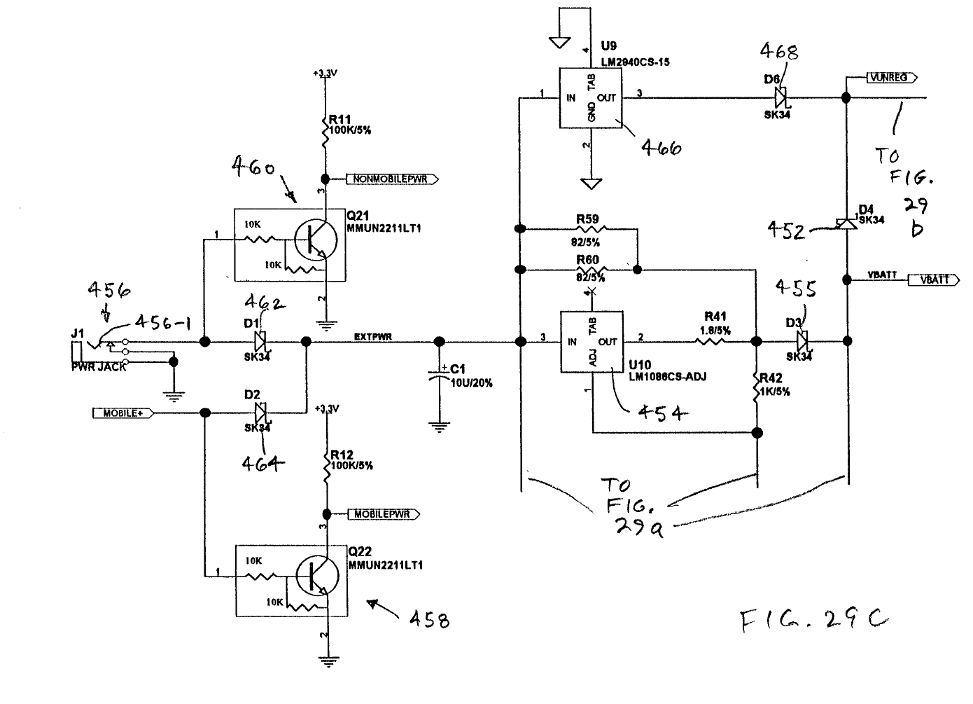

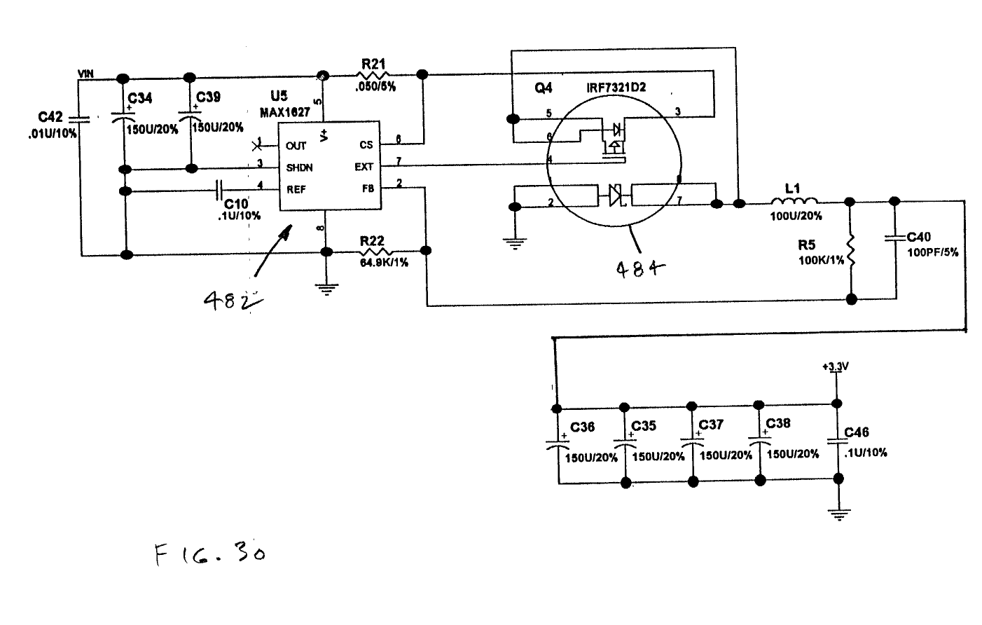

Turning now to FIG. 2, the RF section 38 will be discussed in greater detail. Signal arrives at the instrument 20 by way of a portable antenna 60 with which the instrument 20 itself is equipped, or by way of a mobile antenna 62 which is, for example, mounted on a vehicle (not shown) having a docking platform (not shown) for the instrument 20. Illustratively, placement of the instrument 20 into such a docking station causes an antenna switch 64, such as, for example, a type BA 592 PIN diode switch, to decouple the portable antenna 60 from the instrument 20's RF section 38 and couple the mobile antenna 62 to the instrument 20's RF section 38. Antenna 60 may be, for example, a “rubber duck” type antenna and mobile antenna 62 a vehicle-mounted dipole antenna having the appropriate characteristics. In either case, the output of the antenna switch 64 is coupled to an input port of a tunable bandpass filter 66, such as, for example, a Motorola type MMBV109LT1 varactor tuned BPF. Tuning voltage for BPF 66 is provided from a digital-to-analog (D/A) converter 240 to an input port of a buffer amplifier 69, and from an output port of amplifier 69 to a control input port of BPF 66. Amplifier 69 illustratively is a National Semiconductor type LM 6142 amplifier.

An output port of BPF 66 is coupled to an input port of an amplifier 68, such as, for example, a Mini Circuits type VAM-6 RF amplifier. An output port of amplifier 68 is coupled to an input port of a mixer 70, such as, for example, a Mini Circuits type JMS11X mixer IC. An output port of mixer 70 is coupled to an input port of a switch 72, such as, for example, an Alpha type AS139-73 analog switch. An output port of switch 72 is coupled to an input port of a BPF 74 having a 915 MHz center frequency and a 26 MHz bandwidth. An output port of BPF 74 is coupled to an input port of an amplifier 76, such as, for example, a Stanford Micro type SNA386 RF amplifier. An output port of amplifier 76 is coupled to an input port of a BPF 78 having a 915 MHz center frequency and a 26 MHz bandwidth. BPFs 74 and 78 are available from, for example, Toko. An output port of BPF 78 is coupled to an input port of a mixer 80, such as, for example, a Mini Circuits type JMS5 mixer IC. An output port of mixer 80 is coupled to an input port of an amplifier 82, such as, for example, a Mini Circuits type ERA-3SM RF amplifier. An output port of amplifier 82 is coupled to an input port of a switch 84, such as, for example, an Alpha type AS139-73 analog switch.

One output port of switch 84 is coupled to an input port of a first BPF 86. Another output port of switch 84 is coupled to an input port of a second BPF 88. First BPF 86 illustratively has either a 8 MHz wide passband centered at 36.125 MHz (for example, for European-type television systems) or a 6 MHz wide passband centered at 43.75 MHz (for example, for U.S.-type television systems). Second BPF 88 illustratively has a 10.7 MHz center frequency and a 150 KHz passband. BPF 86 illustratively is a Toshiba surface acoustic wave (SAW) BPF. BPF 88 illustratively is a Toko ceramic BPF. Output ports of BPFs 86 and 88 are coupled to two input ports of a switch 90, such as, for example, an Alpha type AS139-73 analog switch. An output port of switch 90 is coupled to an input port of an amplifier 92, such as, for example, an Analog Devices type AD8011 RF amplifier. An output port of amplifier 92 is coupled to one input port of a switch 94, and through a BPF 96 to the other input port of switch 94. Switch 94 illustratively is a type BA592 PIN diode switch. BPF 96 illustratively has a center frequency of 10.7 MHz and a passband of 17 KHz. BPF 96 illustratively is a Temex crystal filter.

An output port of switch 94 is coupled to an input port of a variable gain amplifier 98, such as, for example, an Analog Devices type AD8011 RF amplifier. An output port of amplifier 98 is coupled to one input port of a switch 100, and through a BPF 102 to another input port of switch 100. Switch 100 illustratively is a type BA592 PIN diode switch. BPF 102 illustratively has a center frequency of 10.7 MHz and a passband of 17 KHz. BPF 102 illustratively is a Temex crystal filter. An output port of switch 100 is coupled to an input port of a variable gain amplifier 104, such as, for example, an Analog Devices type AD8001 RF amplifier. An output port of amplifier 104 is coupled to an input port of a BPF 106 having a center frequency of 10.7 MHz and a passband of 150 KHz, and to an input port of a BPF 108 having a 8 MHz wide passband centered at 36.125 MHz or a 6 MHz wide passband centered at 43.75 MHz. BPF 106 illustratively is a Toko ceramic filter. An output port of BPF 106 is coupled to an input port of a switch 110, such as, for example, an Alpha type AS139-73 analog switch. The output port of amplifier 104 is coupled directly to another input port of switch 110. An output port of switch 110 is coupled to an input port of an amplifier 112, such as, for example, an Analog Devices type AD8001 RF amplifier. The IF signal appearing at an output port of amplifier 112 is coupled to an input port of the DSP 36 where it is A/D converted for further processing.

The signals for mixing in mixers 70, 80 with the signals being processed are generated from a reference crystal 116, such as, for example, a Fox Electronics 12.000 MHz crystal. Reference crystal 116 is coupled to an input port of a Phase Locked Loop (PLL) circuit 118, such as a National Semiconductor LMX2352 PLL IC, and to an input port of a PLL circuit 120, such as a National Semiconductor LMX2352 PLL IC. The output port of PLL IC 118 is coupled to an input port of a voltage controlled oscillator (VCO) 536, such as a Z-Communications type CLV1025E VCO. The output of oscillator 536 is coupled to an input port of an amplifier 126, such as, for example, a Mini Circuits type ERA-3SM RF amplifier. The output of oscillator 124 is coupled to an input port of mixer 80. The output port of PLL IC 120 is coupled to an input port of a VCO including, for example, a type NE85630 transistor 540. An output port of VCO 540 is coupled to an input port of an amplifier 128, such as, for example, a Mini Circuits type ERA-3SM RF amplifier. An output port of amplifier 128 is coupled to an input port of mixer 70.

A signal for calibrating instrument 20 is provided from a reference oscillator 130, such as, for example, a Fox Electronics 30.000 MHz oscillator. Reference oscillator 130 is coupled to one input port of a switch 132, such as, for example, an Alpha type AS139-73 analog switch. A Signal Level Meter INput port of instrument 20 is coupled to another input port of switch 132. An output port of switch 132 is coupled to an input port of a switch 134, such as, for example, an Alpha type AS139-73 analog switch. One output port of switch 134 is coupled to an input port of an amplifier 554, such as, for example, a Mini Circuits type ERA-1SM RF amplifier. An output port of amplifier 554 is coupled to an input port of a switch 552, such as, for example, an Alpha type AS139-73 analog switch. Another output port of switch 134 is coupled directly to an input port of switch 552. An output port of switch 552 is coupled to an input port of a switch 556, such as, for example, an Alpha type AS139-73 analog switch. One output port of switch 556 is coupled to an input port of a 32 dB attenuator in an attenuator circuit 136. An output port of the attenuator is coupled to an input port of a switch 558, such as, for example, an Alpha type AS 139-73 analog switch. Another output port of switch 556 is coupled directly to an input port of switch 558. An output port of switch 558 is coupled to an input port of a variable attenuator IC 560. IC 560 illustratively is an M/ACOM type AT65-0233 IC. Attenuator circuit 136 selectively provides 0 dB, 2 dB, 4 dB, 8 dB, 16 dB or 32 dB of attenuation to the signal at the input port of switch 556. An output port of attenuator IC 560 is coupled to an input port of a mixer 138, such as, for example, a Mini Circuits type JMS11X mixer. An output port of mixer 138 is coupled to an input port of switch 72. Control for the RE section 38 is provided from DSP 36 to a Programmable Logic Device, or PLD, 150, such as, for example, a Xilinx model XC9572XL PLD, and from PLD 150 to PLL ICs 118,120, 141, variable gain amplifiers 98, 104, and to the various other components requiring control.

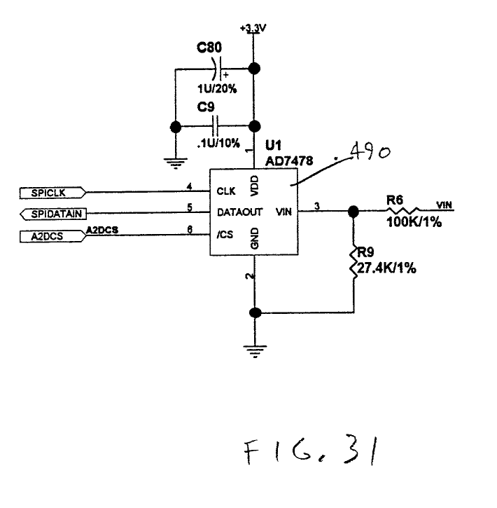

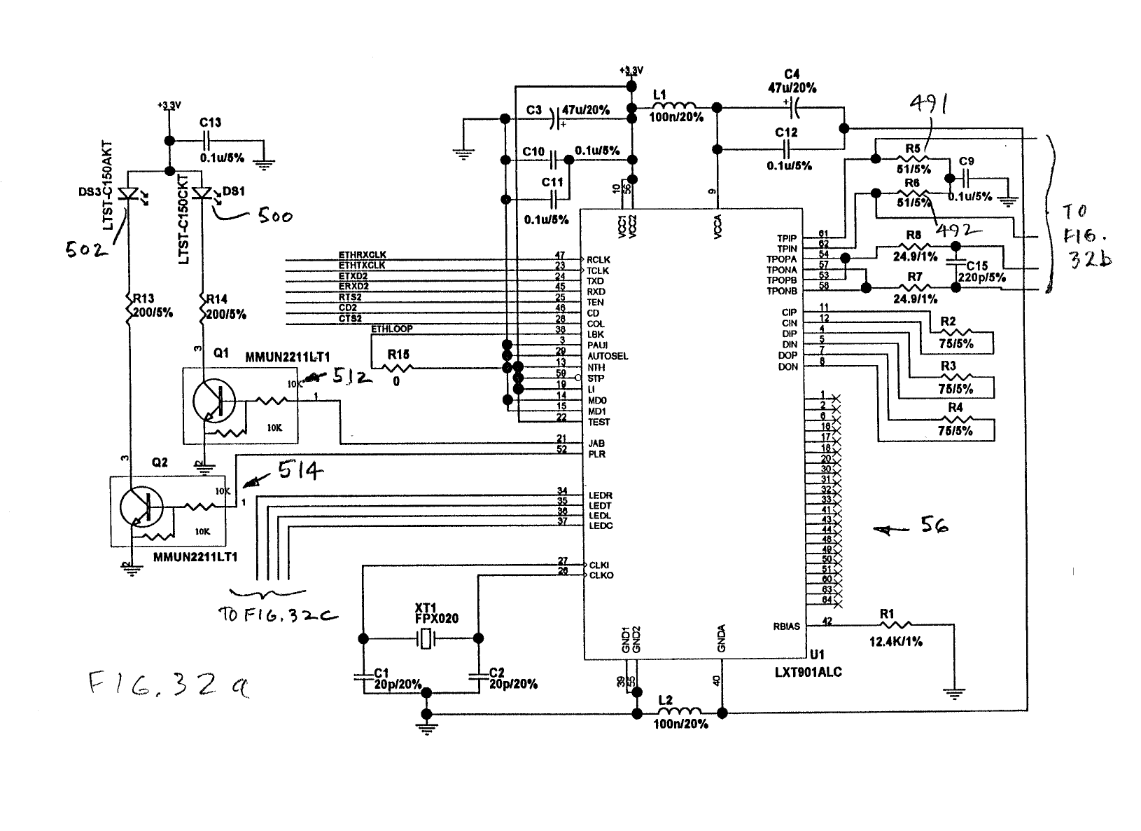

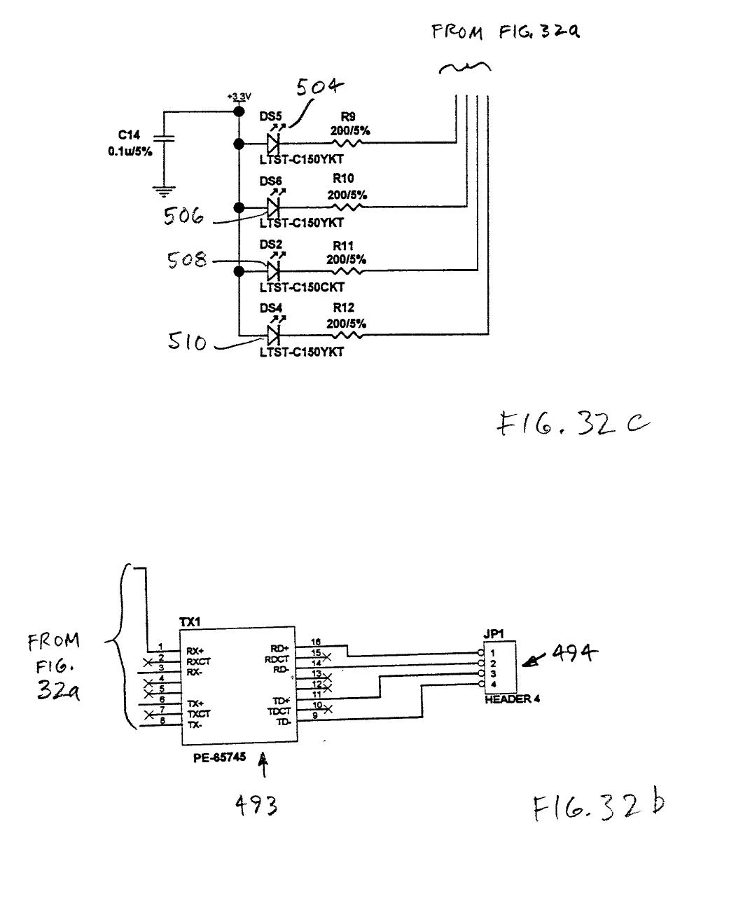

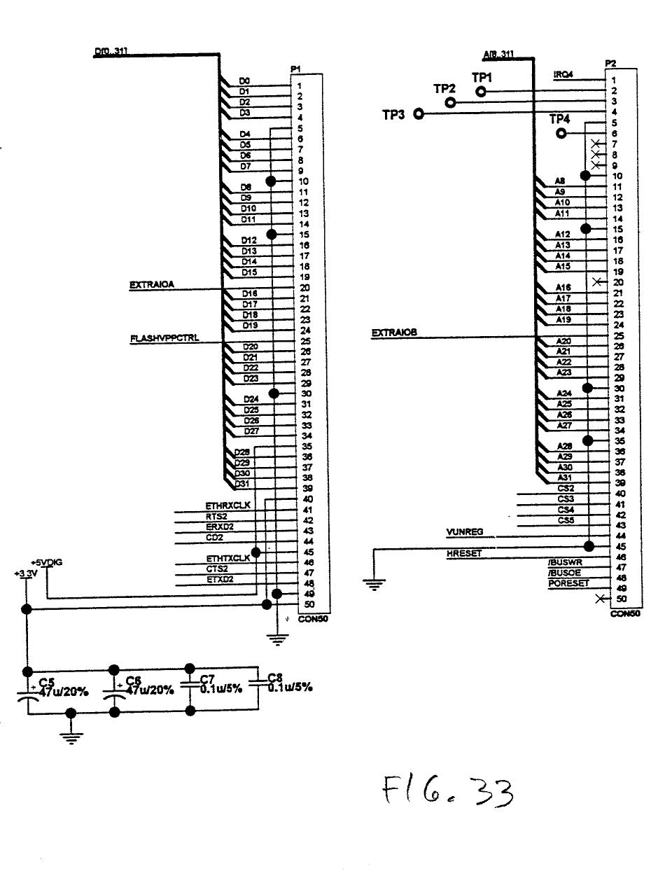

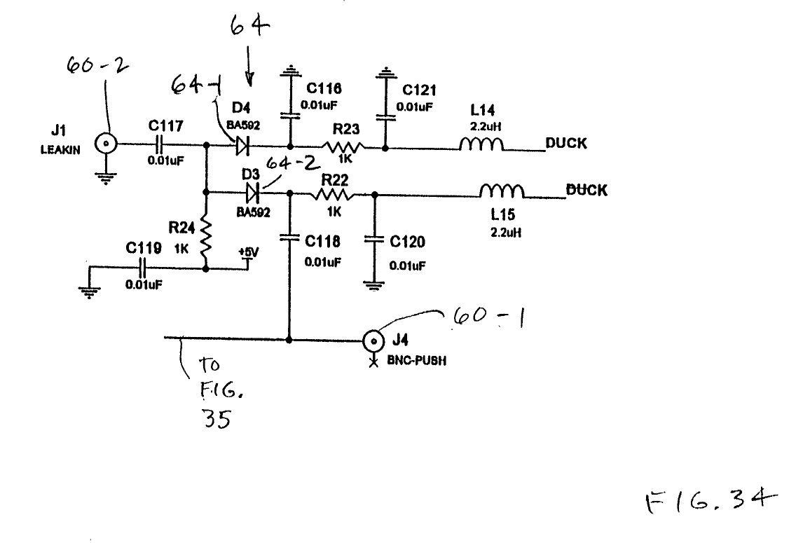

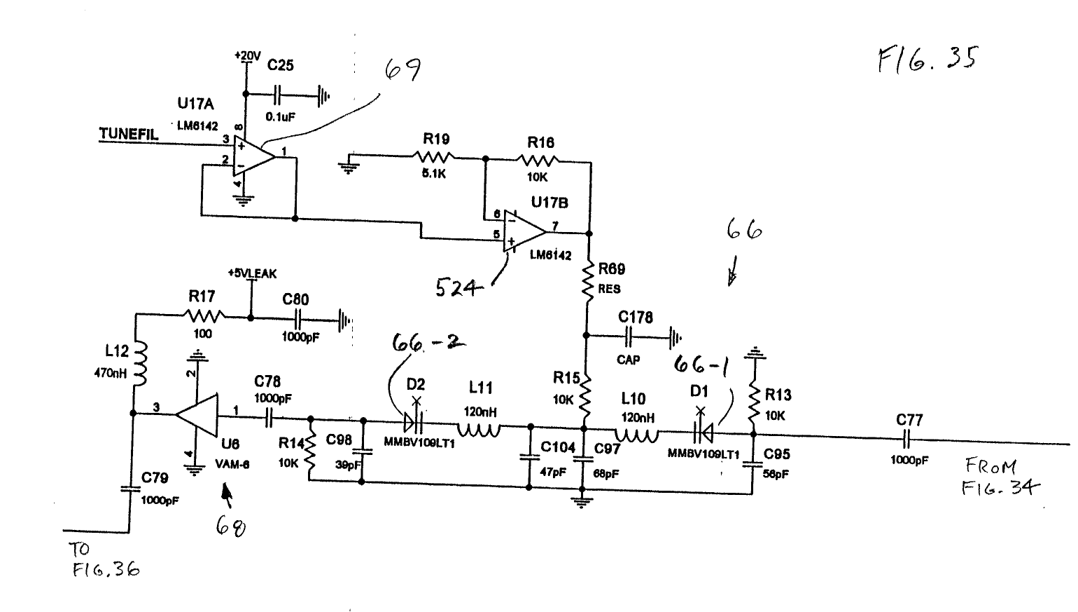

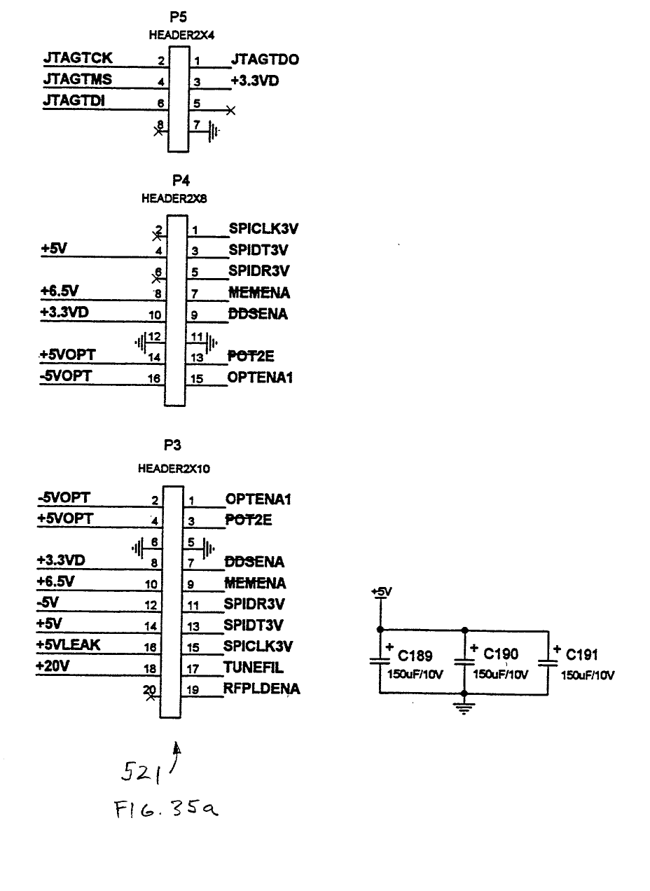

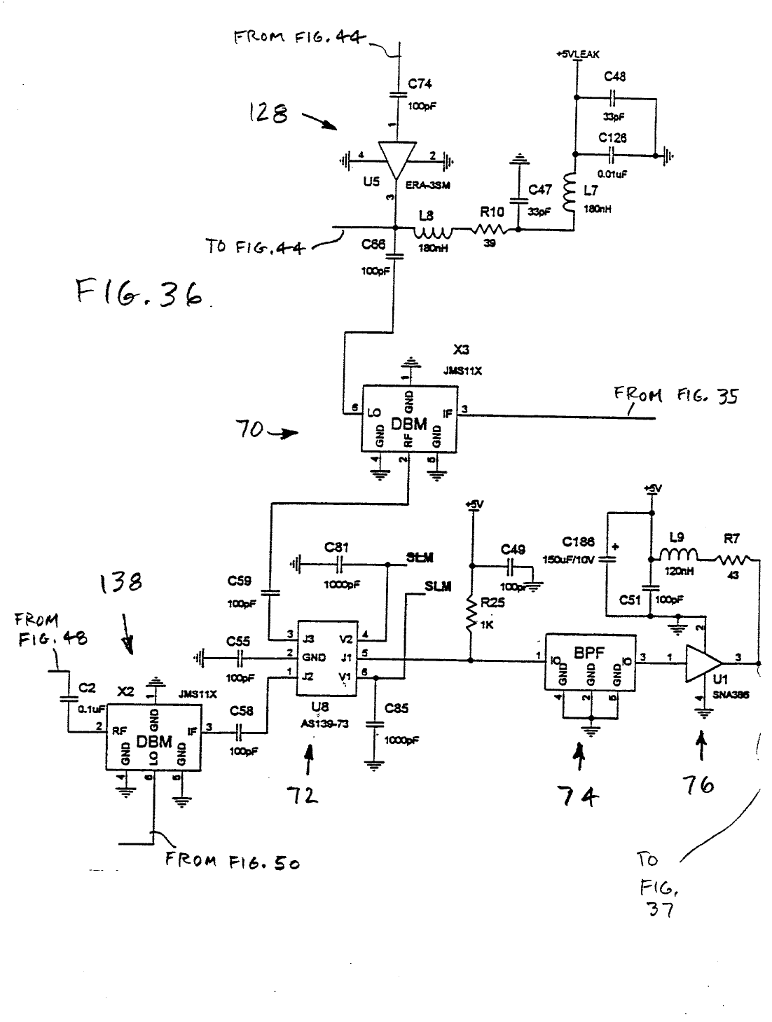

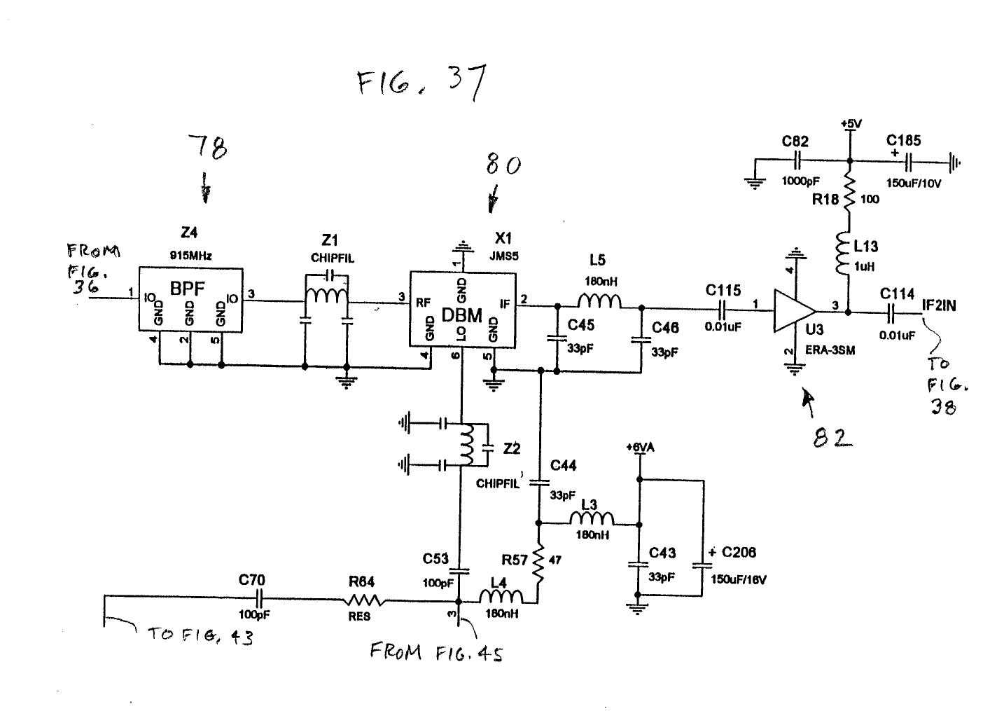

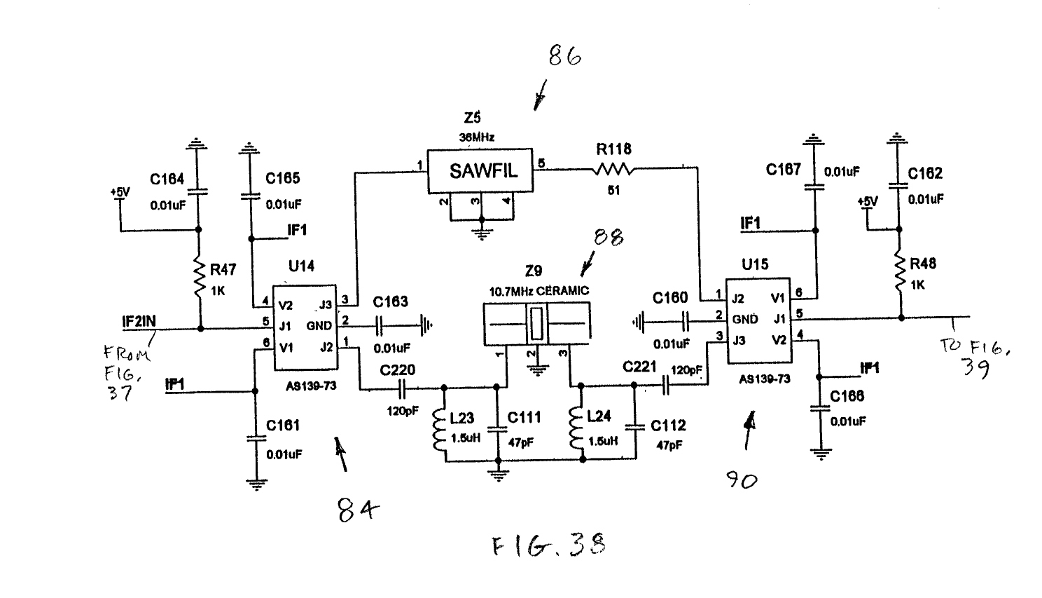

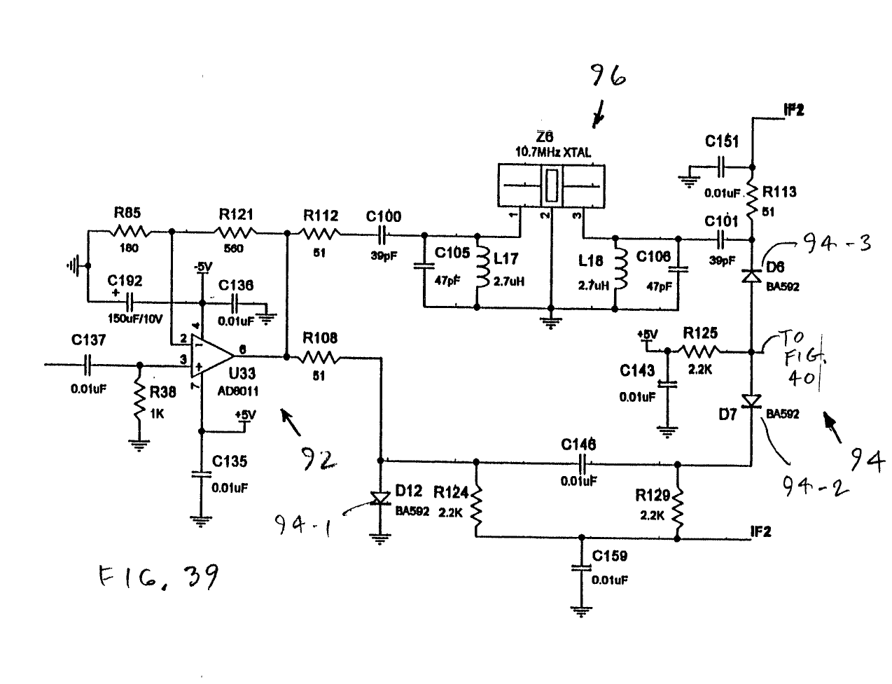

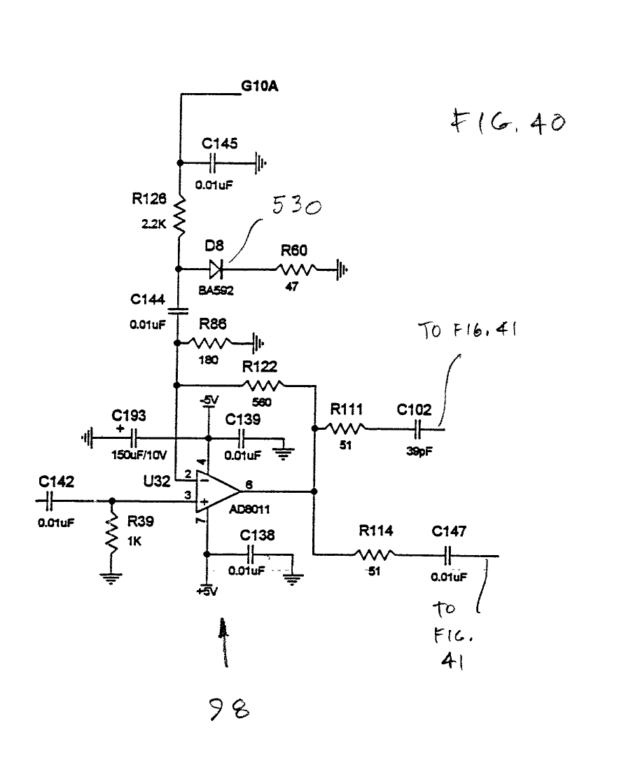

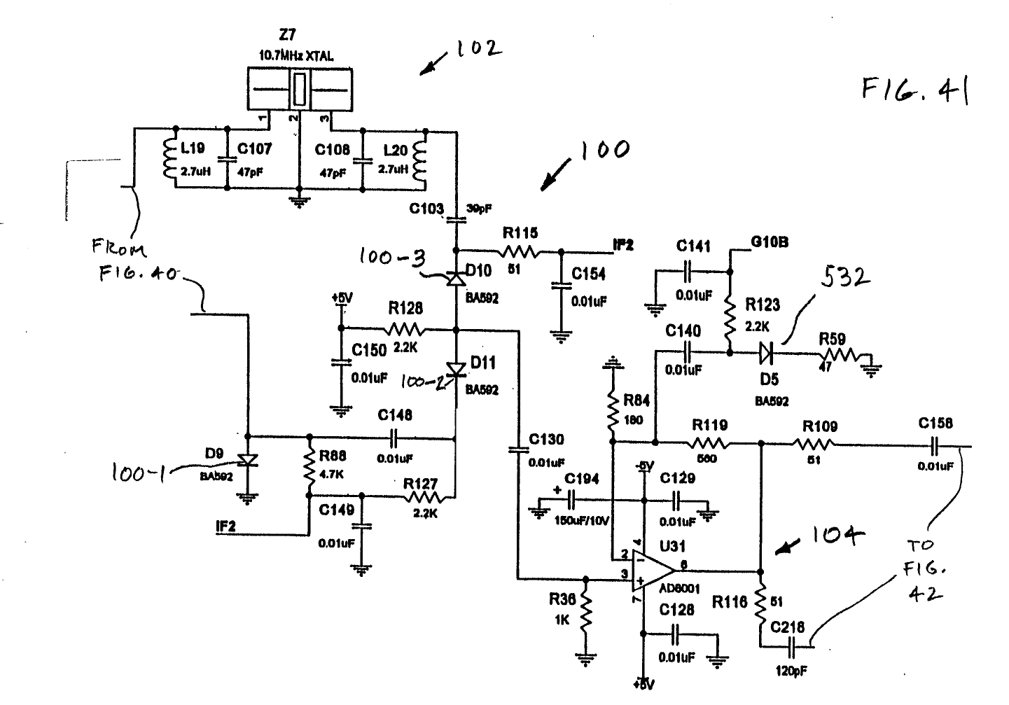

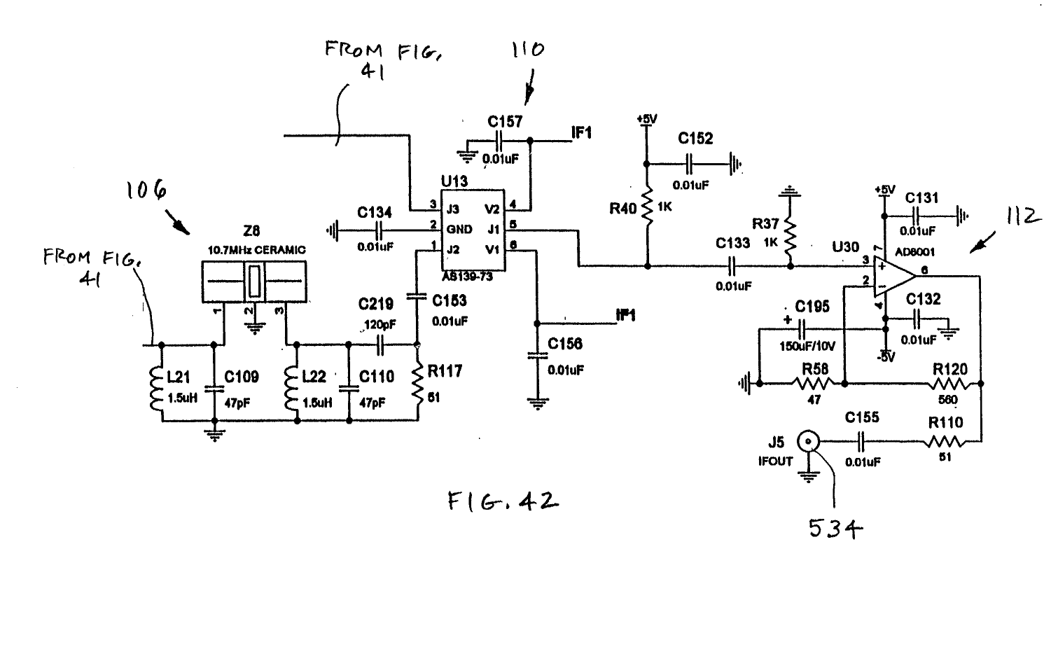

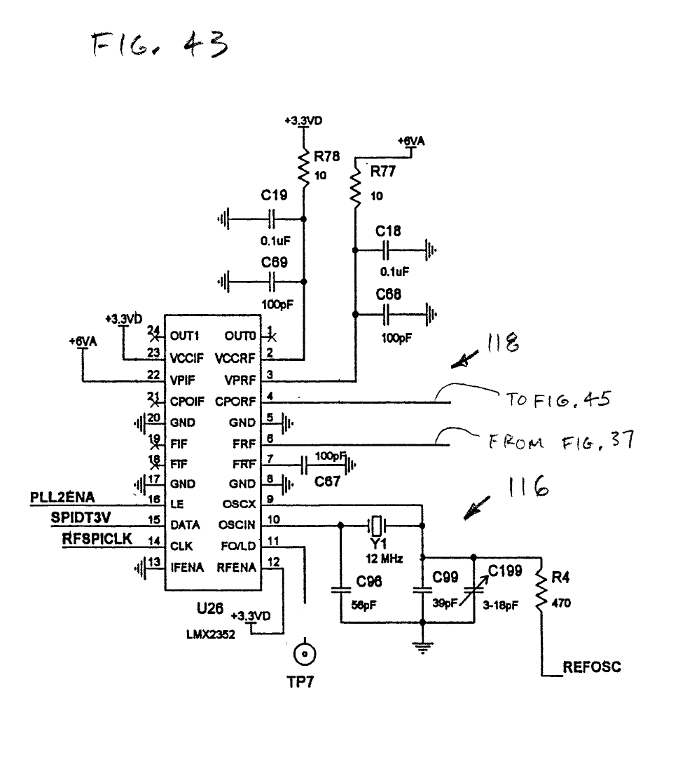

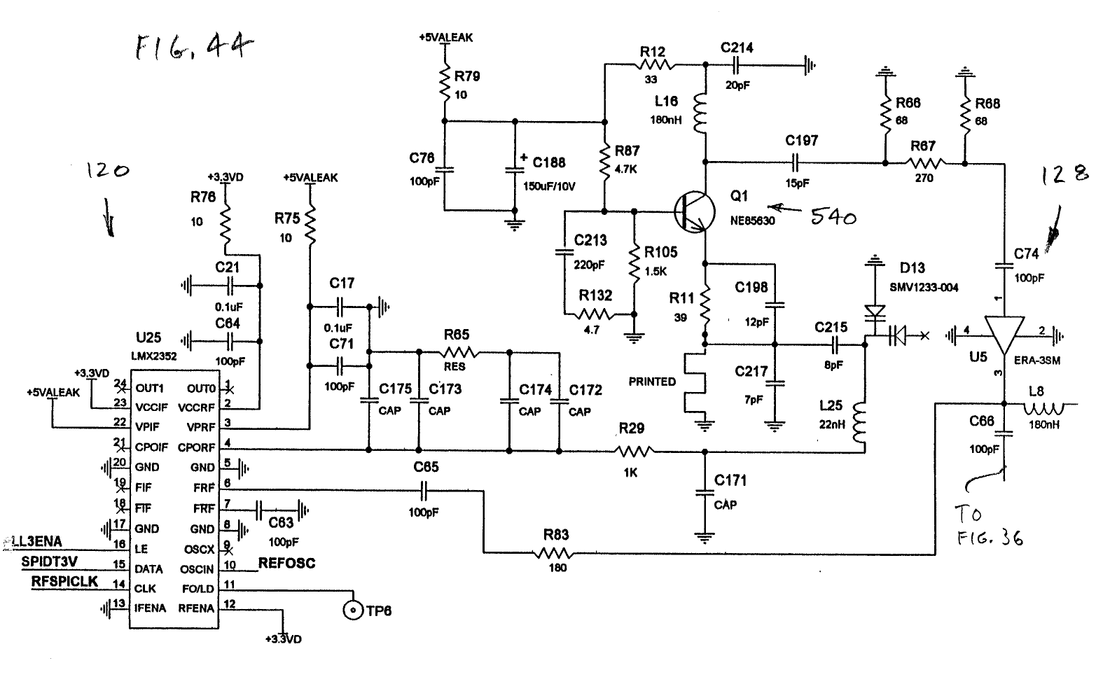

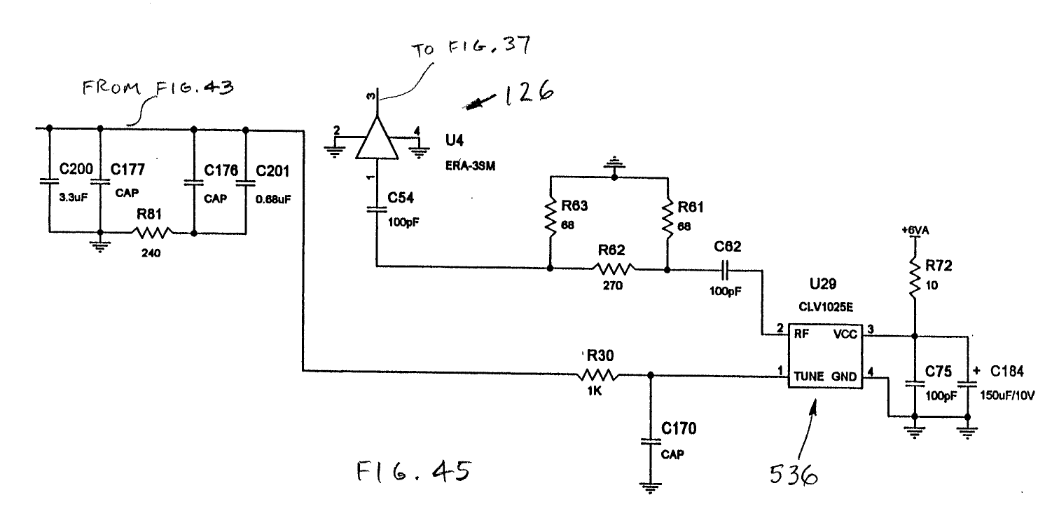

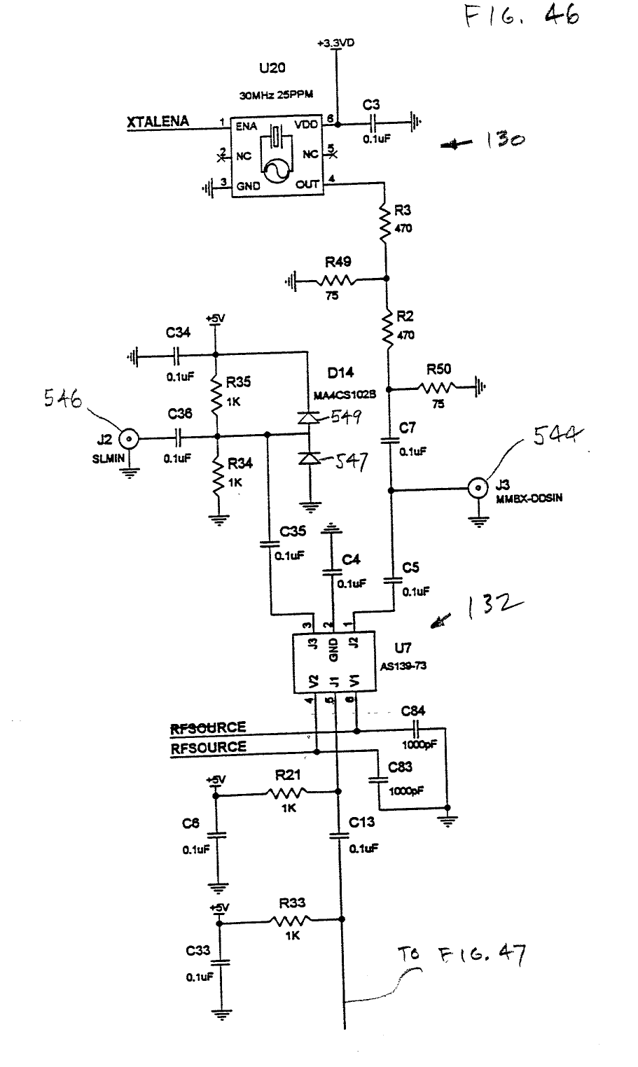

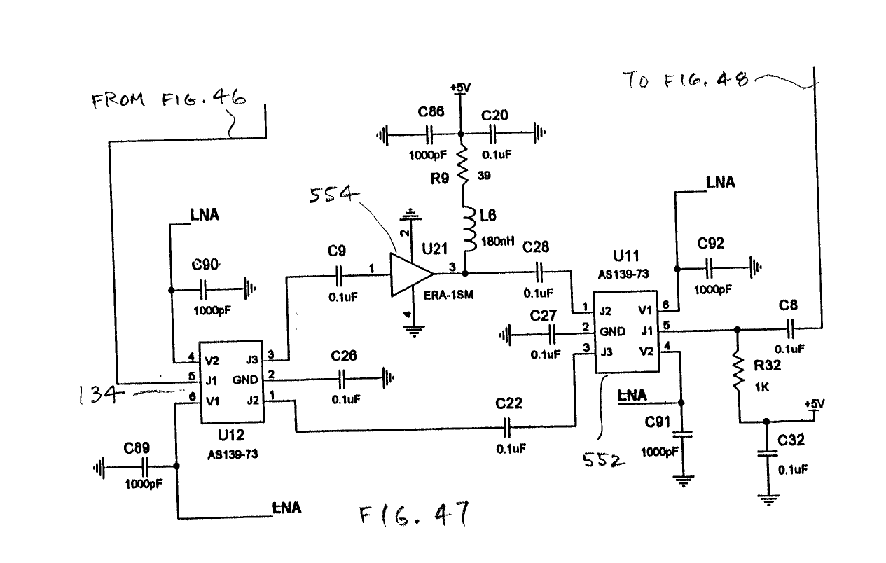

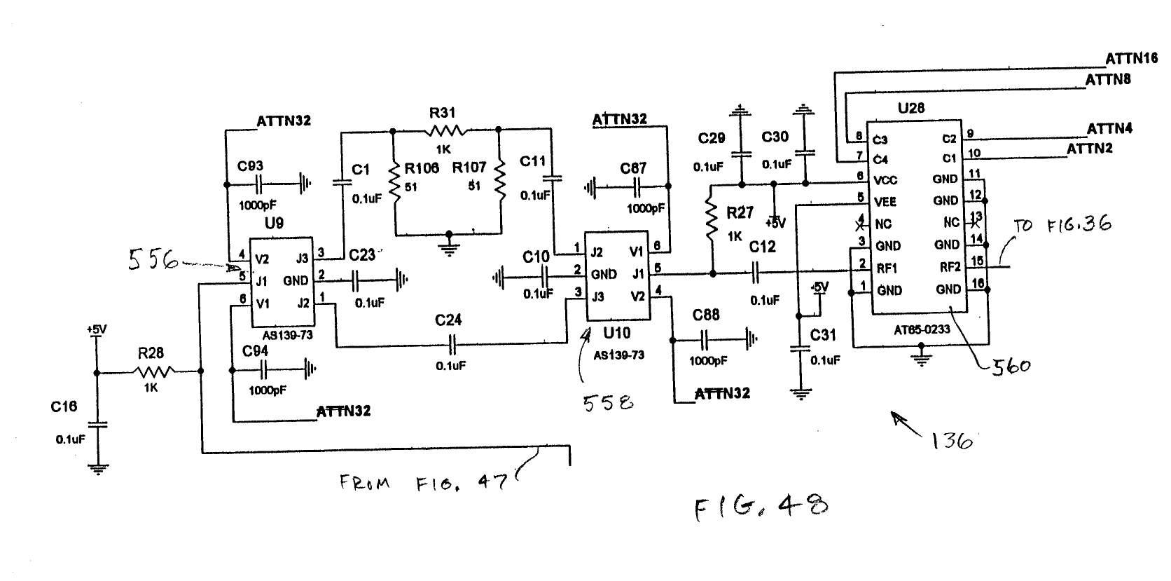

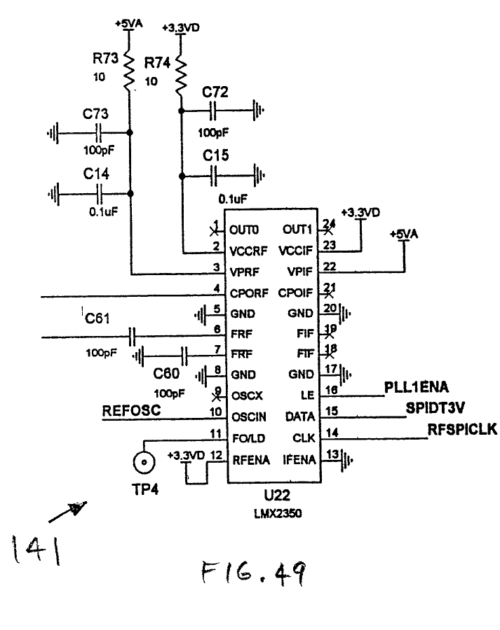

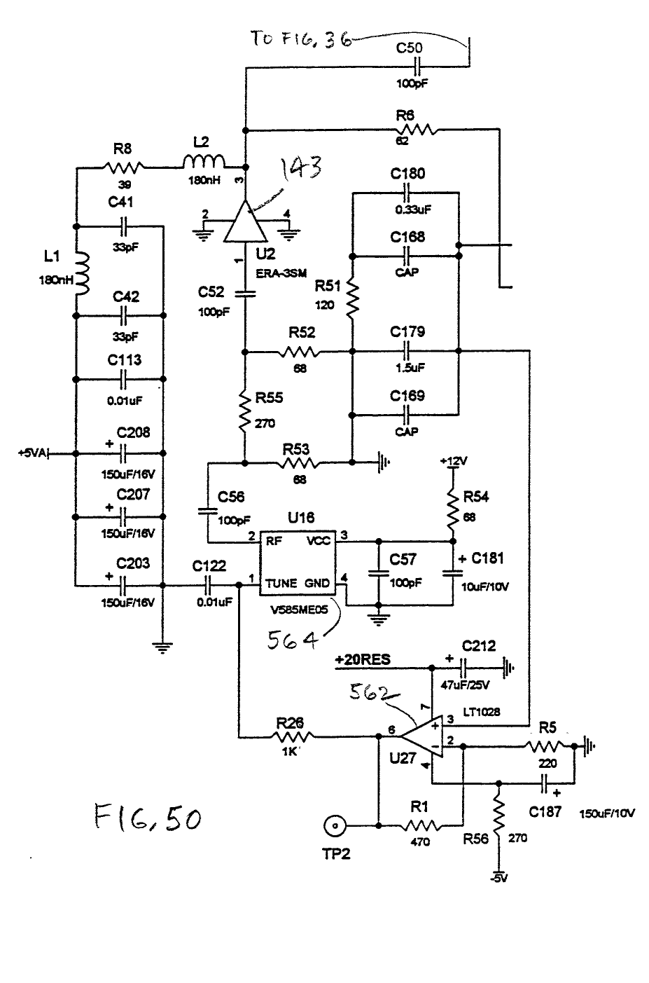

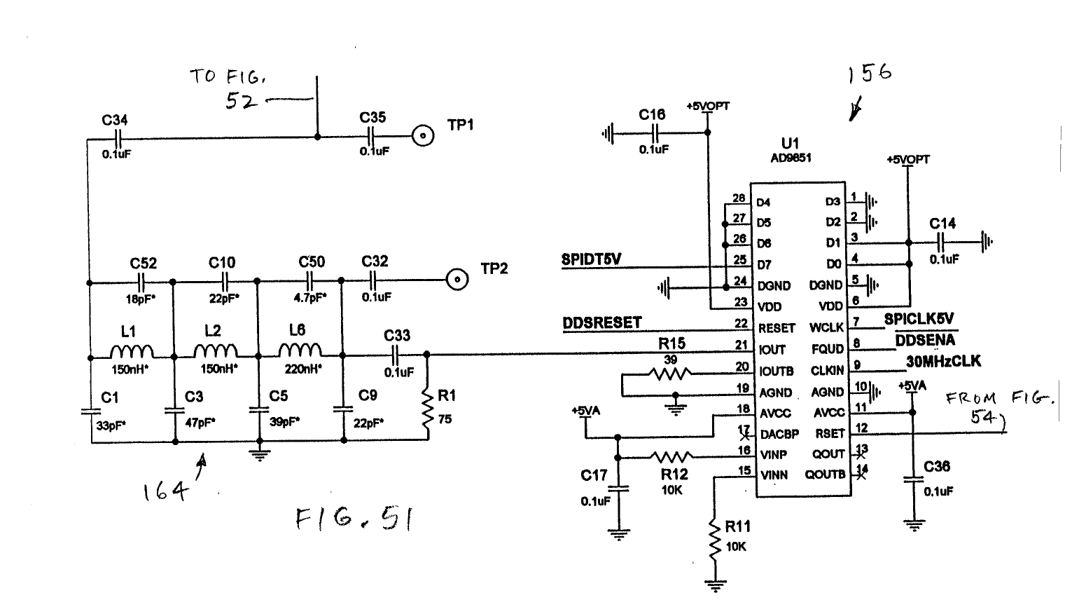

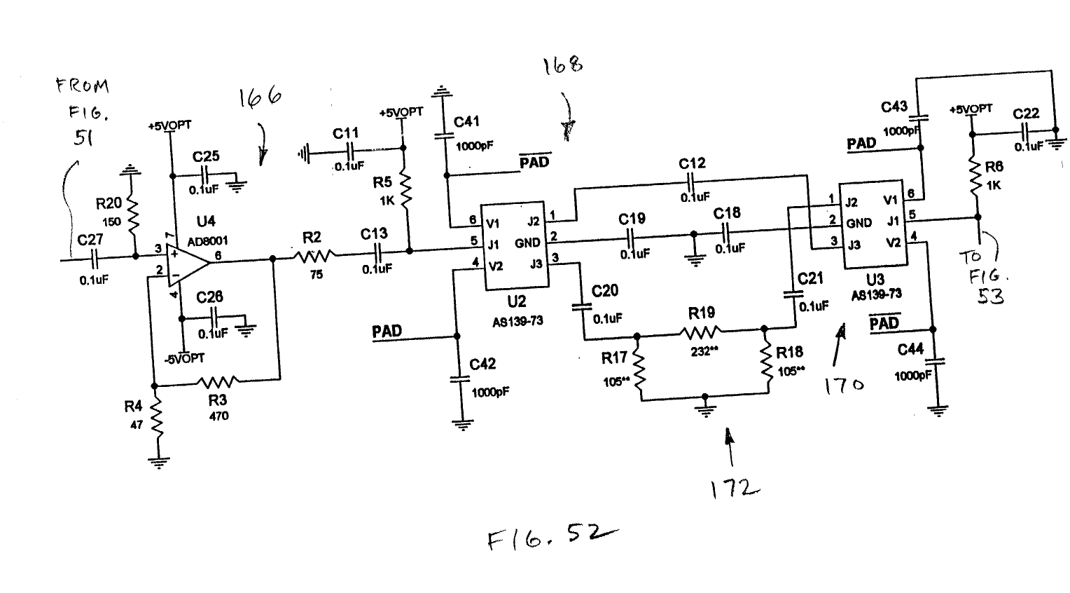

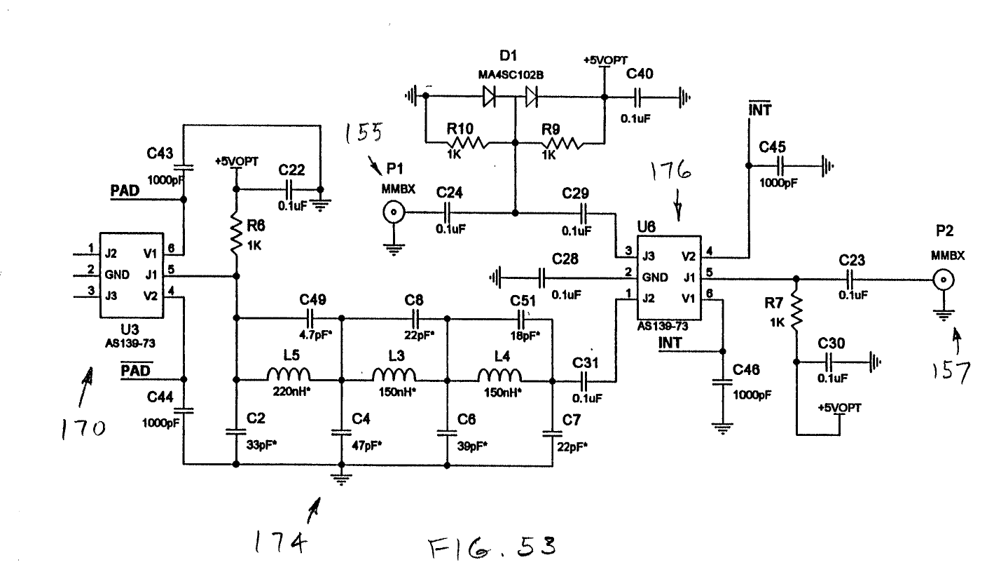

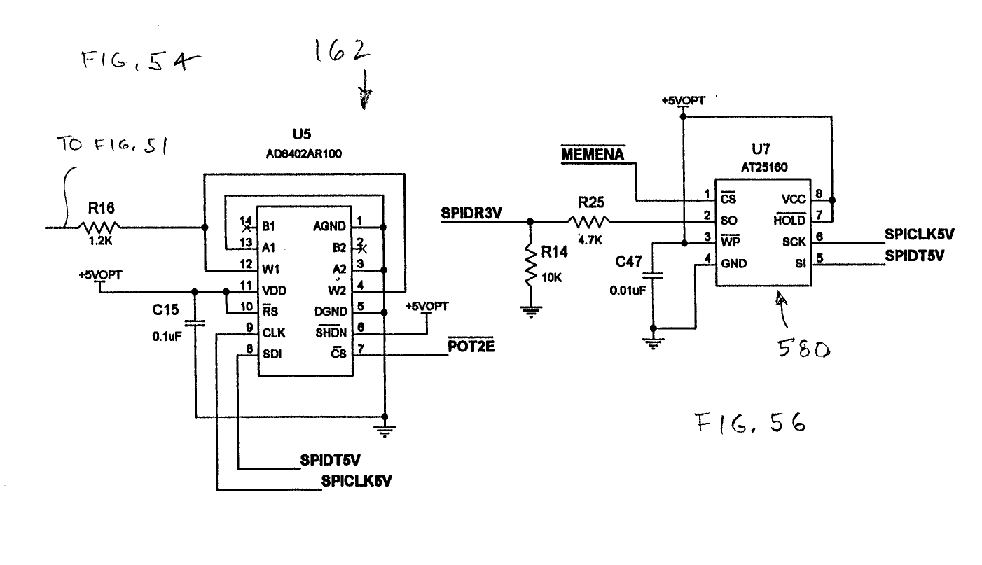

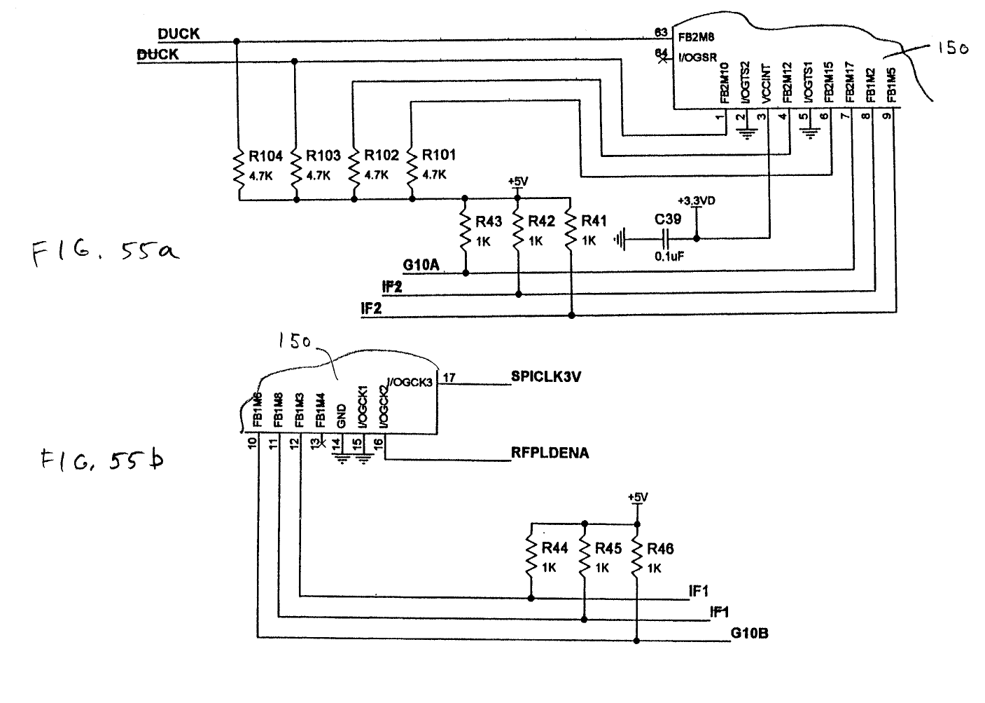

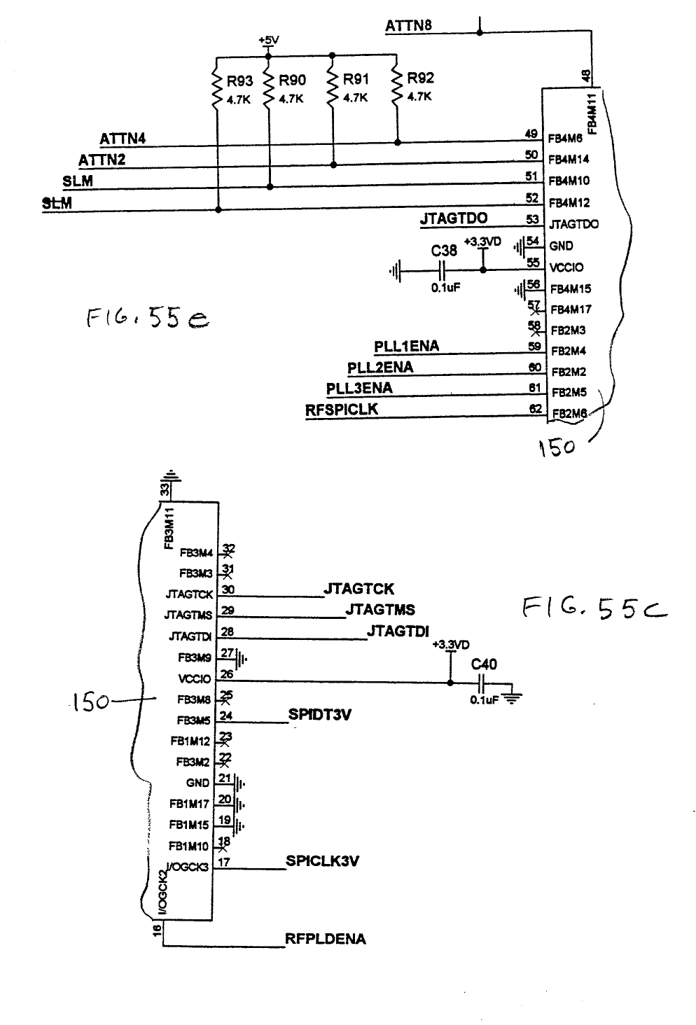

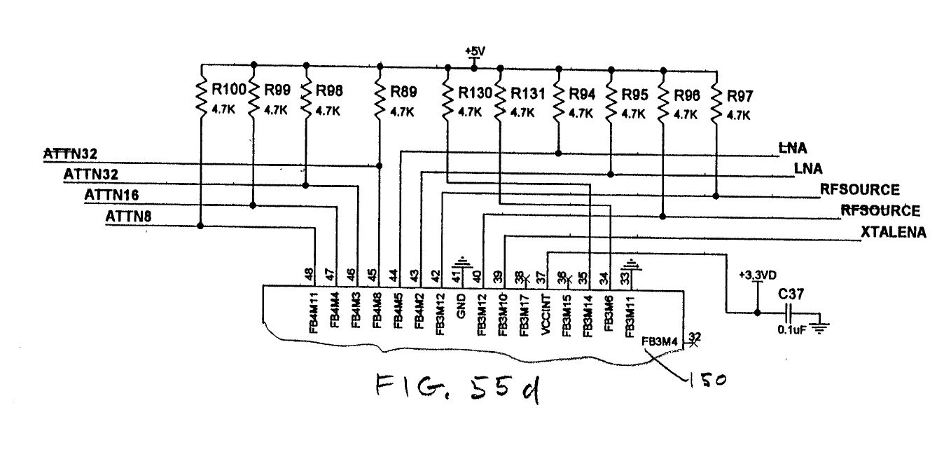

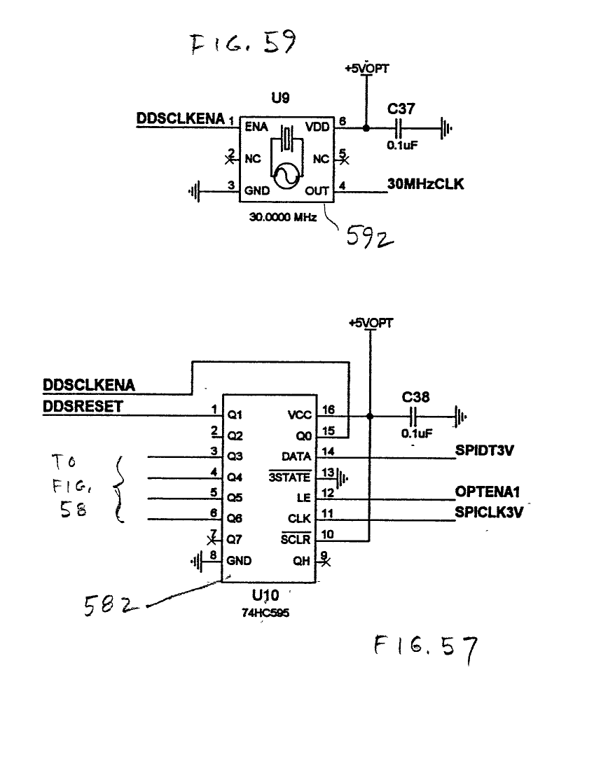

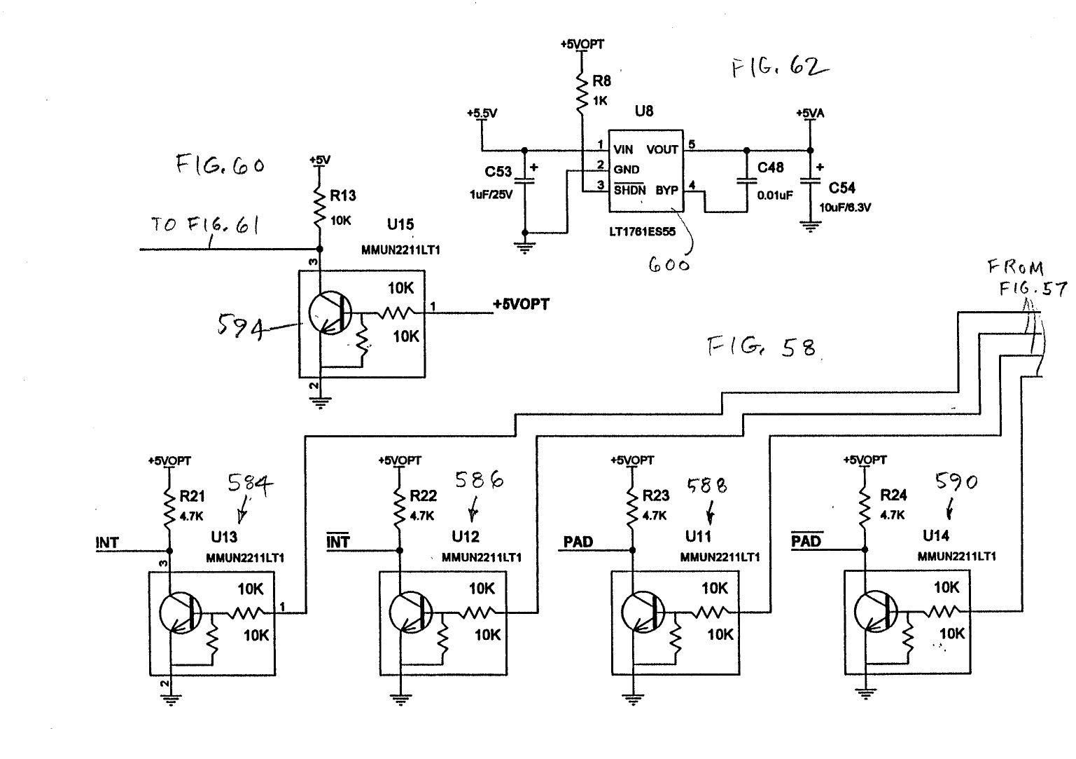

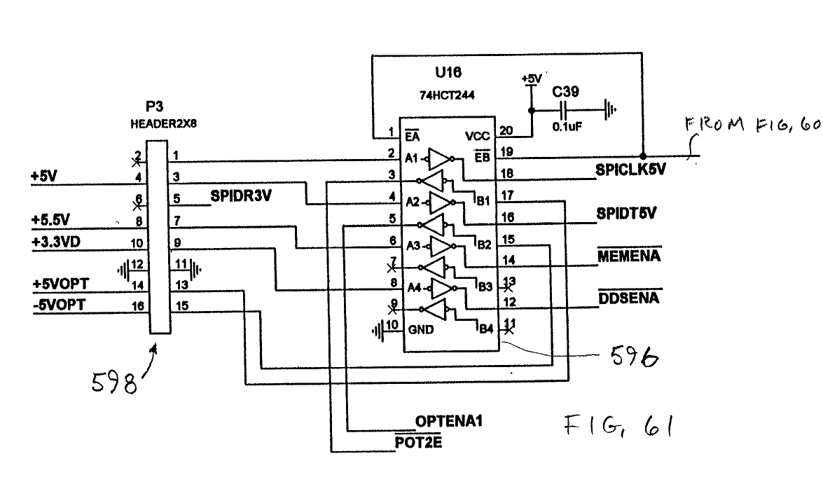

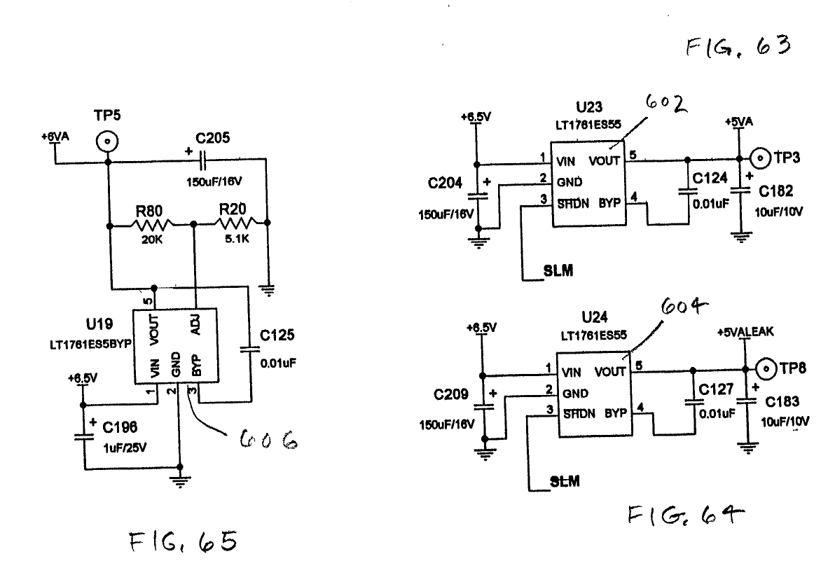

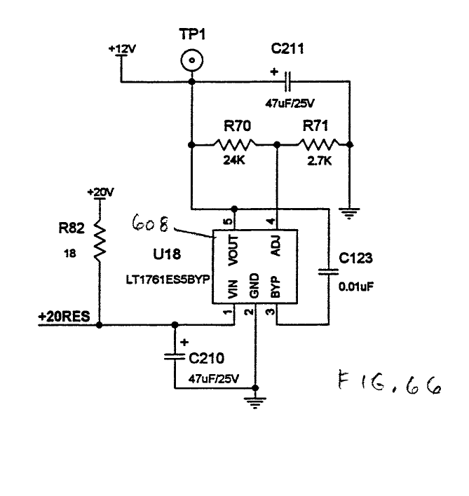

Referring now to FIG. 3, additional circuitry can be provided in the instrument 20, including a direct digital synthesizer (DDS) 156, such as, for example, an Analog Devices type AS9851 DDS, and an erasable programmable read-only memory 158, such as, for example, an Atmel type AT25640 serial EPROM. The DDS 156 can be used to generate RF oscillations at an RF OUTput EXTernal port.

The DDS 156 is controlled from the DSP 36. The DSP 36 also controls the resistance of a variable resistor (VR) 162, such as, for example, an Analog Devices type AD8402, dual 256 position digitally controlled VR. An output port of VR 162 is coupled to an input port of DDS 156. An output port of DDS 156 is coupled to an input port of a Low Pass Filter 164 which illustratively is a 70 MHz discrete LPF. An output port of LPF 164 is coupled to an input port of an amplifier 166, such as, for example, an Analog Devices type AD8001 RF amplifier. An output port of amplifier 166 is coupled to an input port of a switch 168, such as, for example, an Alpha type AS139-73 analog switch. An output port of switch 168 is coupled to an input port of another switch 170, such as, for example, an Alpha type AS139-73 analog switch. Another output port of switch 168 is coupled to an input port of an attenuator 172, such as, for example, a 15 dB attenuator pad. An output port of attenuator 172 is coupled to another input port of switch 170. Switches 168, 170 thus permit attenuator 172 to be placed in the circuit between the input port of switch 168 and the output port of switch 170, or to be removed from it, under the control of μC 22. The output port of switch 170 is coupled to an input port of a LPF 174 which illustratively is a 70 MHz discrete LPF. An output port of LPF 174 is coupled to an input port of a switch 176, such as, for example, an Alpha type AS139-73 analog switch. The RFOUTINT and RFOUTEXT ports of instrument 20 are coupled to the output ports of switch 176.

The instrument 20 permits verification of the return path in a CATV system in the manner described in, for example, U.S. Ser. No. 09/093,243, filed Jun. 8, 1998, titled IN HOME CABLE INGRESS AND EGRESS DETECTION, and assigned to the same assignee as this application. The instrument 20, when queried by a test instrument, such as a Trilithic model SST instrument, in the headend of a CATV system, transmits back to the headend at a queried frequency plus some offset, for example, 90 KHz, 180 KHz, 270 KHz, 360 KHz, etc. Illustratively, there are six offsets to permit six such instruments 20 to respond to the query at once. The instrument 20 always starts its return transmission at its lowest output setting so as not to overload the return path. When the test instrument at the head end receives the return signal, it reports to the instrument 20 the received signal level, or simply whether the received signal level is within an acceptable window. If the signal level is not within an acceptable window, the instrument 20 raises its signal level by a predetermined amount, and the process is repeated until the received signal level is within an acceptable window. Then the instrument 20 raises its signal level an amount which it has now determined will be sufficient to provide a nominal signal level at the headend. Then, as a further test, the instrument 20 lowers its signal level by some small amount and transmits again. If the test instrument at the head end detects the same small amount of reduction in signal level, the test is considered valid. The instrument returns its transmitted signal level to the nominal level and reports that signal level to the user. That is the level at which the subscriber's terminal apparatus is then set to transmit in order for the subscriber's transmissions to reach the headend at the nominal signal level.

The 6 MHz or 8 MHz IF bandwidth, coupled with the instrument 20's high speed A/D conversion capability and DSP 36, permits instrument 20 to tune through, for example, the 50 MHz to 860 MHz CATV forward path frequency range much faster than prior art CATV test and maintenance instruments. The instrument 20 tunes in 6 MHz or 8 MHz bands, digitizes the received signals and analyzes them using, for example, a Fast Fourier Transform (FFT) algorithm. This feature also permits the operator to use the instrument 20 for QAM signal analysis. CATV signal level meters have typically employed an ˜300 kHz IF bandwidth in order to measure the signal power of a CATV video carrier. While this bandwidth may have been necessary for signal level meters which relied on analog methods to measure carrier power, with the advent of DSP and high speed A/D converters, new methods of measuring carrier power that provide increased speed, accuracy, and precision can be implemented. The method employed by instrument 20 utilizes an IF bandwidth wide enough to contain the entire video channel, which includes both the video carrier and any audio carriers that exist in the channel. This method permits the channel to be tuned once to measure the carrier power of the video and audio carriers. By measuring the carrier power of multiple signals while tuned to one frequency, measurement speed is increased. Using DSP of any arbitrary sampled channel, each carrier can be individually measured. The RF section 38 receives RF input, for example, from 5 MHz to 860 MHz, and mixes the bandwidth of interest to an IF, for example 36.125 MHz, passing all frequencies in a bandwidth of ±4 MHz from the center of the bandwidth of interest. The A/D in DSP 36 converts the IF signal to digital samples. The A/D converter must sample at a rate that is at least two times the IF bandwidth, or 16 Million Samples Per Second (MSPS) for a bandwidth of 8 MHz, in order to digitize the IF signal accurately. The samples are supplied to DSP 36 where I/Q demodulation is performed and signal power is calculated.

The instrument 20 employs the I/Q method for demodulating video, which reduces the likelihood of errors due to conversion oscillator inaccuracy. When the instrument 20 samples, owing to the fact that the location of the signal of interest has some frequency uncertainty, it is not guaranteed that digitally mixing the signal to DC will result in the signal residing at DC. To overcome this, the instrument 20 multiplies by the sine and cosine, producing two waveforms, I and Q, exactly 90° out of phase with each other. Trigonometry guarantees that I²+Q² will always equal the instantaneous signal power regardless of the frequency offset of the mixing carrier. There are many ways to measure signal levels. One that has been widely used in CATV signal level instruments is to mix the signal down to DC, lowpass filter the resulting signal through a LPF having a bandwidth of, for example, 300 KHz, and then hold the maximum level of the filter output with a peak detector. This works well for analog instruments, which can dwell on a channel for hundreds of milliseconds to overcome any frequency uncertainty of the signal with respect to the frequency of the mixing carrier.

The method employed by instrument 20 for measuring signal power uses I/Q modulation to divide the signal of interest into two components, the so-called In-phase, or I, component, and the so-called Quadrature, or Q component, that are exactly 90° out of phase with each other. Mathematically, because the I and Q signals are related as cosine and sine, I²+Q² will always equal the instantaneous power, P, of the signal, regardless of any frequency offset of the mixing signal. A mathematical explanation of this operation follows. Let us refer to the input signal as X, where X Acos(2*pi*Fc*t+Ph), A is the amplitude of Fc, which is the value which needs to be obtained from X, Fc is the carrier frequency, and Ph is some constant phase offset. If we multiply X by cos(2*pi*Fm*t) and by sin(2*pi*Fm*t), where Fm is the mixing frequency, we produce two separate results, which we will call I and Q.

I=Acos(2*pi*Fc*t+Ph)*cos(2*pi*Fm*t)

I=A/2 cos(2*pi*(Fc−Fm)*t+Ph)+A/2 cos(2*pi*(Fc+Fm)*t+Ph)

Next, we low pass filter I to remove the (Fc+Fm) component and multiply by 2.

This gives:

I Acos(2*pi*(Fc−Fm)*t+Ph).

Squaring gives:

I²=A² cos²(2*pi*(Fc−Fm)*t+Ph).

Performing the same operations on the Q component:

Q=Acos(2*pi*Fc*t+Ph)*sin(2*pi*Fm*t)

Q=A/2 sin(2*pi*(Fc−Fm)*t+Ph)+A/2 sin(2*pi*(Fc+Fm)*t+Ph

Again, we low pass filter to remove the (Fc+Fm) component and multiply by 2.

This gives:

Q=Asin(2*pi*(Fc−Fm)*t+Ph).

Squaring gives:

Q²=A² sin²(2*pi*(Fc−Fm)*t+Ph).

Adding I² and Q² gives:

I²+Q²=A² cos²(2*pi*(Fc−Fm)*t+Ph)+A² sin²(2*pi*(Fc−Fm)*t+Ph),

or,

I²+Q²=A²[cos²(2*pi*(Fc−Fm)*t+Ph)+sin²(2*pi*(Fc−Fm)*t+Ph)]

But,

cos² (2*pi*(Fc−Fm)*t+Ph)+sin² (2*pi*(Fc−Fm)*t+Ph)=1

and therefore,

I²+Q²=A²

But A² is, by definition, the signal power, P. The utility of this method is thus established.

The instrument 20 is programmed to accept a scripting language, which permits the operator to customize the instrument 20's operation using a relatively simple programming language. This permits the operator to program into all of his instruments 20 instructions about how the various tests of the operator's CATV system are to be conducted.

The instrument 20 is capable of conducting group delay measurements of the type described in, for example, PCT/US00/25349. The disclosure of PCT/US00/25349 is hereby incorporated herein by reference.

The instrument 20 is also capable of conducting time domain reflectometry measurements of the type described in, for example, PCT/US99/01432. The disclosure of PCT/US99/01432 is hereby incorporated herein by reference.

The instrument 20 is capable of digitizing audio, such as, for example, voice communication, and sending the digitized audio both upstream and downstream in a network such as a CATV system on whatever carrier is available, be it telephone, IP, proprietary carrier, or the like.

The instrument 20 provides the capability to analyze many different types of digital modulation. The following is a description of one illustrative method for the invention to demodulate 64 Qudrature Amplitude Modulation (64 QAM). First, the instrument 20 utilizes its A/D converter to sample a digitally modulated signal. A mixer included in the instrument 20 mixes the sampled signal with an estimate of the carrier frequency, Fc. The resulting signal is input to a carrier frequency recovery module. This module performs a precise measurement of the actual carrier frequency and recreates the carrier. This recovered carrier is utilized by a mixer which mixes the digitally modulated signal to the baseband modulated signal. This baseband signal is input to a symbol timing recovery module. This module determines the ideal symbol sampling time. This timing information is utilized by a symbol recovery module which converts the baseband signal into a symbol stream. The symbol stream is utilized by an equalizer, which compensates for any distortion, such as radio frequency (RF) chain distortions caused by the instrument 20. The instrument 20 then make measurements on the recovered symbols.

The instrument 20 may be provided with a mobile mount which provides antenna 62 connection, power connection, an interface to, for example, a Global Positioning System (GPS) for establishing location, and a PCS for transmitting, for example, work orders.

When equipped with a color LCD display, the instrument 20 provides enhanced readability of displays and uses color to make complex displays easier to read.

The instrument 20 can be used to obtain information from an information source on the network and display that information to the technician. For example, the instrument 20 permits displaying of messages to the technician, or obtaining measurement or status data for some element in the CATV system including third party devices or systems. The instrument 20 can also obtain data from a data source connected to the CATV network. The technician can then modify the data and send to the originating element or to a second element in the CATV system. For example, a technician can download a work order, fill in details of the work order, add data from measurements the instrument 20 itself has made, and return the completed work order for storage or processing. The instrument 20 can cause another system or device on the CATV network to take an action. For example, the instrument 20 can cause a standby power supply management system on the CATV network to put a particular supply into standby mode. Conversely, the instrument 20 can receive instructions from some other system or device on the CATV network, causing the instrument 20 to take some action, for example, to take measurements and report them. These functions can be combined, for example, in an interactive test sequence. For example, a technician equipped with the instrument 20 can request a test of the CATV network's standby power supply system. The standby power supply system controller can respond by requesting a reference signal level reading from the instrument 20. The standby control system can then put a particular standby power supply in standby mode and request a second signal level reading from the instrument 20. The standby system can then compare the two signal level readings provided by the instrument 20, and report as a test result whether the two readings are within some established range of each other.

The instrument 20 can be coupled to the broadband network using a proprietary data carrier, DOCSIS modem, or by means independent of the broadband network, such as a PCS data radio or like wireless data link. The instrument 20 can also be coupled by direct Ethernet connection to a network, such as a LAN. The instrument 20 can communicate directly with third party equipment, such as a third party server. Alternatively, a server can be provided specifically for communication with the instrument 20. Such a server can also be connected to the broadband network. Such a server can interface with any desired equipment or server.

The instrument 20 permits two-way communication, which makes electronic messaging possible. The instrument 20 employs proprietary carriers to achieve electronic messaging. This permits dispatching, uploading and downloading of work orders and performance verification data. It also makes possible e-mail communication. The instrument 20 provides an ethernet interface 56, which permits the instrument 20 to exist as an entity on a network. This, in turn, permits the instrument 20 to be addressed and interrogated. Alternatively, it can be coupled to a high speed modem. The instrument 20 includes an internet browser which permits it to interact with, for example, a CATV system operator's website, for example, for downloading work orders and transferring of data using, for example, file transfer protocol.

The signature pad 54 permits CATV system subscribers, for example, to sign for installation and service of their terminal equipment.

The bar code scanner 53 permits the user to enter the bar codes of equipment with which the network is provided, or with which it interfaces, for CATV system records, work orders, and the like.

Overview

The illustrative embodiment of the invention described herein is logically divided into two main portions, the radio frequency (RF) portion, and the digital portion. Because digital portions are electromagnetically noisy and RF sections are inherently sensitive to radiation, placing the two portions on separate printed circuit boards with appropriate shielding measures being taken between the two is convenient. The digital portion is further subdivided into five sections: the μC section, the DSP section, the LCD section, the peripheral section, and the power section. First, the relationships among the various digital sections is described, then each digital section is described in detail, and finally the RF portion is described in detail.

The chip select bus, the address bus, and the data bus are coupled among, and provide communication among, the μC section, the peripheral section and the DSP section. The chip select bus includes lines CS0-CS7. The address bus includes lines A8-A31. The data bus includes lines D0-D31. The interrupt request bus is coupled among the μC section, the peripheral section, the DSP section and the power section. The interrupt request bus includes lines IRQ0-IRQ7. The 12C bus is coupled among the μC section, the peripheral section and the LCD section. The I2C bus includes lines 12C0 and 12C1. The LD bus is coupled between the μC section and the LCD section. The LD bus includes lines LD1-LD13. The Ethernet bus is coupled between the μC section and the peripheral section. The Ethernet bus includes system lines E0-E6.

The following lines also provide communication between the μC section and the peripheral section: PORESET, TCK, TMS, μCTDO, TXD2, SPEAKER, AUDIOCONTROL, RS232TXD, STEERING, FLASHVPPCTRL, /BUSWR, /BUSOE, TDO, RXD2, RS232RXD, and HRESET. The following lines also provide communication between the μC section and the DSP section: ANALOGPWR, RFOPTIONPWR, ENABLELEAK, DSPRESET, and DSPIRQ1. The μC section is further coupled to the LCD section by line SMBSUS.

The following lines also provide communications between the power section and the μC section: /CHARGE, CHARGERON, VBATT, CHARGING, MOBILEPWR, and NONMOBILEPWR. The following lines provide communications between the peripheral section and the power section: MOBILE+, ON/OFF, VUNREG, and SWITCH. Line DACOUT is coupled between the peripheral section and the DSP section. Line VIN is coupled among the power section, the DSP section, and the LCD section.

Microprocessor Section

Turning now to FIGS. 4a-b, the electric circuit of the instrument includes a microcontroller (μC) section including μC 22. μC 22 is coupled to the address bus as follows. Address lines A8-A31 are respectively coupled to μC 22 pins N16, M15, L13, M16, M14, L14, L15, L16, K14, K13, G13, K15, J15, J14, G14, H15, H13, H14, F14, K16, G16, H16, G15, and F16. The instrument 20's+3.3V digital power supply is coupled to μC 22 pins E5-E12, M5-M12, F5, G5, H5, J5, K5, L5, F12, G12, H12, J12, K12, L12, A7, GI, J16, T7 and B1. 1.3 μF of capacitance is coupled between the +3.3V digital power supply and ground. The KeepAlivePoWeR line is coupled to μC 22 pin A3. The data bus lines D0-D31 are respectively coupled to μC 22 pins M1, L1, J2, JI, L2, H1, F1, E1, M2, K2, K3, K1, M4, M3, J3, J4, H2, K4, H3, G2, G3, F2, H4, L4, F3, G4, E4, L3, F4, E2, D2, and E3.

Line TCK is coupled to μC 22 pin T12, to pin 4 of jumper block JP8, and through a 1KΩ resistor to ground. Line TCK is further coupled to jumper block JP7 pin 9. Line TMS is coupled to μC 22 pin R12. Line TMS is also coupled to JP7 pin 7. Pin R11 of μC 22 is coupled to JP7 pin 3, through a 1 KΩ resistor to ground, and to JP8 pin 8. Line μCTDO is coupled to μC pin N12 and to JP8 pin 10. Line TRST is coupled to μC 22 pin P11, and to JP7 pin 1. Jumper block JP7 pins 2, 4, 6, 8, and 10 are coupled to ground.

Line HardRESET is coupled to μC 22 pin B5 and to JP8 pin 7. μC 22 pin C5 is coupled through a 22 KΩ resistor to ground. Line SoftRESET is coupled to >C 22 pin B4, to jumper block JP8 pin 2, and through a 22 KΩ resistor to the KeepAlivePoWeR line. Test point TP16 is coupled to μC 22 pin A4. Line PowerOnRESET is coupled to pin B3 of μC 22. Line SYStemCLocK is coupled to pin A6 of μC 22 and to test point TP20. Pin A5 of μC 22 is coupled to line LOWCLOCK. Pin B2 of μC 22 is coupled through a 0.33 μF capacitor to the +3.3V supply. Line CLocKOUT is coupled to μC 22 pin D1, and to test point TP11. μC 22 pin D5 is coupled to the TEXP line. JP8 pin 1 is coupled to μC 22 pin A8, and through a 22 KΩ resistor to the +3.3V supply. JP8 pin 6 is coupled to μC 22 pin C8, and through a 22 KΩ resistor to the +3.3V supply. JP8 pins 3 and 5 are coupled to ground.

Referring to FIG. 4c, ethernet bus line E0 is coupled to μC 22 pin R14. Ethernet line E1 is coupled to μC 22 pin R13. Ethernet line E2 is coupled to μC 22 pin T8. Ethernet line E3 is coupled to μC 22 pin T6. Ethernet line E4 is coupled to μC 22 pin T16. Ethernet line E5 is coupled to μC 22 pin R8. Ethernet line E6 is coupled to μC 22 pin N8. UniversalSerialBus lines 0-5 are coupled to pins P16, R15, R10, P9, T5 and N6, respectively, of μC 22. Line CHARGING is coupled to μC 22 pin R5. Line RXD2 is coupled to μC 22 pin N10. Line TXD2 is coupled to μC 22 pin T9. Line /CHARGE (notCHARGE) is coupled to μC 22 pin P8. Line SPEAKER is coupled to μC 22 pin R6. Line SerialPeripherallnterfaceSELect is coupled to μC 22 pin N14. Line SPICLocK is coupled to μC 22 pin P15. Line SPIDATAOUTput is coupled to μC 22 pin P14. Line SPIDATAINput is coupled to μC 22 pin T15.

The instrument 20's I² C bus is coupled to μC 22 as follows. Line I2CDATA is coupled to μC 22 pin T14. Line I2CCLocK is coupled to μC 22 pin P12. μC 22 pin T14 is also coupled through a 10 KΩ resistor to the +3.3V supply. Line RS232TXD is coupled to μC 22 pin N11. Line RS232RXD is coupled to μC 22 pin T11. Line ENABLELEAKdetection is coupled to μC 22 pin T11. Line RFOPTIONboardPoWeR is coupled to μC 22 pin R9. Line Analog2DigitalChipSelect is coupled to μC 22 pin R7. Line FLASHVPPConTRoL is coupled to μC 22 pin P7. Line SERialFLASHReaDY is coupled to μC 22 pin N7. Line CHARGING is coupled to μC 22 pin R5.

Line CHARGERON is coupled to μC 22 pin R16. Line SMBSUS is coupled to μC 22 pin P13. Line NONMOBILEPWR is coupled to μC 22 line T13. Line ANALOGPoWeR is coupled to μC 22 line P6. Line MOBILEPoWeR is coupled to μC 22 line T4. μC 22 is coupled to the LiquidcrystalDisplay bus as follows. Lines LDl-LD13 are coupled to μC 22 pins T1, P4, T2, N5, R3, P5, T3, R4, R2, R1, P2, P3 and N4, respectively. Referring to FIG. 4e, μC 22 pins F6-F11, G6-G11 , H6-H11, J6-J11, K6-K11, L6-L11, A1 and A2 are coupled to ground.

Referring now to FIG. 4d, μC 22 pins B10, C10, D10, A11, B11, C11, A12, B12, N1, N2, C2, D3, D4, C3, B7, D9 and A13 are coupled through respective 22 KΩ resistors to the +3.3V supply. Pin A10 of μC 22 is coupled to pin Interrupt request (IRQ) lines IRQ0-IRQ7 are coupled to μC 22 pins N1, N2, D9, C3, D4, D3, C2, and N3. Pin N3 is also coupled through a 22 KΩ resistor to the +3.3V supply. Chip select (CS) bus lines CS0-CS7 are coupled to pins D12, A14, B14, A15, B16, D13, C14, and B15, respectively, of μC 22. Lines BS_A0 and BS_A1 are coupled to pins D16 and E16, respectively, of μC 22. Lines GPL_A0, GPL_A2, GPL_A3, and GPL_A4 are coupled to μC pins E13, C15, D14, and D11, respectively, of μC 22. Line /BUSOE is coupled to pin C16 of μC 22.

Turning to FIGS. 4f-h, DRAM 28 illustratively includes two Micron type MT48LC8M8A2TG-8E ICs 28-1 and 28-2. Address bus lines A21-A30 are coupled respectively to pins 34, 33, 32, 31, 30, 29, 26, 25, 24 and 23 of each of ICs 28-1 and 28-2. Address bus lines A8, A9 and A19 are coupled respectively to pins 21, 20 and 35 of each of ICs 28-1 and 28-2. Lines GPL_A0, GPL_A2, GPL_A3 and GPL_A4 are coupled to pins 22, 18, 17 and 16 respectively of each of ICs 28-1 and 28-2. Line CS1 is coupled to pins 19 of each of ICs 28-1 and 28-2. The +3.3V supply is coupled to pins 1, 3, 9, 14, 27, 37, 43 and 49 of each of ICs 28-1 and 28-2. Data bus lines D0-D7 are coupled to pins 53, 50, 47, 44, 11, 8, 5 and 2 of IC 28-1. Data bus lines D8-D15 are coupled to pins 53, 50, 47, 44, 11, 8, 5 and 2 of IC 28-2. Line BS_A0 is coupled to pin 39 of IC 28-1. Line BS_Al is coupled to pin 39 of IC 28-2. Line CLKOUT is coupled to pins 38 of each of ICs 28-1 and 28-2. Pins 6, 12, 28, 41, 46, 52 and 54 of each of ICs 28-1 and 28-2 are coupled to ground.

Memory 30 illustratively is coupled to the instrument 20's address bus as follows. Address bus lines A12-A30 are coupled to memory 30 pins 16, 17, 48, 18, 18-24 and 25, respectively. Address bus line A9 is coupled to pin 9 of memory 30. Address bus line A10 is coupled to pin 10 of memory 30. Address bus line A11 is coupled to pins 9 and 15 of memory 30. Line /BUSWR is coupled to pin 11 of memory 30. Pin 12 of memory 30 is coupled to the +3.3V supply. Line FLASHWP is coupled to pin 14 of memory 30.

Pin 13 of memory 30 is coupled to the collector of a PNP transistor 200. Transistor 200 illustratively is a type MMUN2111LT1 transistor. The emitter of transistor 200 is coupled to the +3.3V supply. The emitter of transistor 200 is coupled through a 10 KΩ resistor to its base, and through a 10 KΩ resistor to the collector of an NPN transistor 202. The emitter of transistor 202 is coupled to ground. The base of transistor 202 is coupled through a 10 KΩ resistor to the FLASHVPPCTRL line. The base of transistor 202 is also coupled through a 10 KΩ resistor to ground. Transistor 202 illustratively is a type MMUN2211LT1 transistor. A 47 μF capacitor is coupled between the +3.3V supply and ground. Line CSO is coupled to pin 26 of memory 30. Pins 27 and 46 of memory 30 are coupled to ground. Pins 37 and 47 of memory 30 are coupled to the +3.3V supply. Line /BUSOE (notBUSOutputEnable) is coupled to pin 28 of memory 30. The instrument 20's data lines D0-D15 are coupled to memory 30 pins 45, 43, 41, 39, 36, 34, 32, 30, 44, 42, 40, 38, 35, 33, 31, and 29. A 0.1 μF capacitor is coupled between the +3.3V digital power supply and ground.

Referring to FIG. 4i, pin 1 of memory 58, line SERialFLASHReaDY, is coupled through a 22 KΩ resistor to the +3.3V supply. Pins 2, 3 and 7 of memory 58 are coupled to the +3.3V supply. Pin 8 of memory 58 is coupled to ground. A 0.1 μF capacitor is coupled across the +3.3V supply and ground. Line SPISEL is coupled to pin 13 of memory 58. Line SPICLK is coupled to pin 14 of memory 58. Line SPIDATAOUT is coupled to pin 15 of memory 58. Line SPIDATAIN is coupled to pin 16 of memory 58.

Referring to FIG. 4j, a reset controller includes an IC 204, illustratively a MAX6637US22D3-T. Pin 3 of reset controller 204 is coupled to one terminal of a momentary contact switch 206, the other terminal of which is coupled to ground. Pin 1 of controller 204 is coupled to ground. Pin 4 of controller 204 is coupled to the KAPWR line, and through a 22 KQ resistor to pin 2 of controller 204, the PowerOnRESET line.

A low power crystal oscillator includes an IC 208, illustratively an HA7210IB. A 32.768 KHz crystal is coupled across pins 2 and 3 of IC 208. Pins 1, 6, 7, and 8 of IC 208 are coupled to line KAPWR. A 0.1 μF capacitor C98 is coupled across ground and line KAPWR. Pin 4 of IC 208 is coupled to ground. Pin 5 of IC 208 forms the LOWCLOCK line.

A voltage reference 210 illustratively includes a MAX6003EUR-T IC. Pin 1 of IC 210 is coupled to the VBATTery line. Pin 3 of IC 210 is coupled to ground. Pin 2 of IC 210 is coupled to the anode of a Schottky diode 212. The cathode of diode 212 is coupled to the cathode of a Schottky diode 214. Illustratively, diodes 212, 214 are type SD103 diodes. The cathodes of diodes 212 and 214 are coupled through a 10 Ω resistor to the KAPWR line. A .1 F capacitor is coupled across KAPWR and ground.

Referring to FIG. 4k, a HardRESET circuit includes a reset controller IC 216, illustratively a MAX811SEUS-T IC. Pin 3 of IC 216 is coupled to one terminal of a switch, the other terminal of which is coupled to ground. Pin 1 of IC 216 is coupled to ground. Pin 4 of IC 216 is coupled to the +3.3V supply. Pin 2 of IC 216 is coupled through a 22 KΩ resistor to the +3.3V supply, and to pin 2 of a dual Q flip-flop IC 218. KAPWR is coupled to pins 3, 11 and 16 of IC 218, and through respective 100 KΩ resistors to pins 7 and 15 of IC 218. A 10 μF capacitor is coupled across pin 7 of IC 218 and ground. Pins 1, 6, 8 and 14 of IC 218 are coupled to ground. A 1000 pF capacitor is coupled across pin 15 of IC 218 and ground. Q output pin 13 of IC 218 is coupled through a 10 KQ resistor to the base of an NPN transistor 220. The base of transistor 220 is coupled through a 10 KΩ resistor to the emitter of transistor 220. The emitter of transistor 220 is coupled to ground. The collector of transistor 220 is coupled to the HRESET line. The collector of transistor 220 is also coupled through a 10 KΩ resistor to the KAPWR line.

DSP Section

Turning now to FIGS. 5a-e, DSP 36 is coupled to the DSP data bus as follows. DSP data lines DSP_D14-DSP_D23 are coupled to pins 74-79 and 81-84 of DSP 36. The D0-D15 lines are coupled to pins 57, 56, 55, 11, 10, 9, 8, 7, 6, 5, 4, 2, 1, 100, 99 and 98, respectively, of DSP 36. The A28-A30 lines are coupled to pins 63, 62 and 64, respectively, of DSP 36. The DSP is coupled to the data bus as follows. Line CS6 is coupled to DSP pin 61. Test point TP7 is coupled to DSP pin 58.

Referring to FIG. 5b, the +3.3V supply is coupled to pins 15, 36, 67 and 90 of DSP 36. The instrument 20's +2.5V supply is coupled to pins 18 and 59 of DSP 36. 0.1 μF capacitors are coupled across each of pins 15, 18, 36, 59, 67, 90 and ground. Pins 3, 12, 17, 28, 41, 60, 66, 71, 80 and 92 are coupled to ground.

Referring particularly to FIG. 5c, lines DT0, DR0, OPTionboardProgrammableLogicDevicENAblel, CS2, DSPCLK, OPTDtoAConverterWRIte, OPTDACCLK, PCM_LRC, IRQ2, AD_STandBY, AD_OTR and DSP_CLK are coupled to pins 31, 34, 37, 38, 40, 87, 86, 85, 26, 29, 30 and 13, respectively. A 30 MHz clock 226, illustratively a S1703C-30.0000(T), generates the AD_CLK signal. This signal is inverted by an inverter 228, illustratively an inverter of a type 74LCX04 hex inverter, to form the DSP_CLK line. This line is coupled to pin 13 of DSP 36. Line DSPRESET is coupled to pin 44 of DSP 36. Line SYSCLK is coupled to pin 16 of DSP 36.

Referring particularly to FIG. 5d, pins 39, 91, 94 and 89 are coupled through respective 22 KΩ resistors to the +3.3V supply. Pins 88 and 93 of DSP 36 are coupled through respective 22 KΩ resistors to ground. Pin 35 of DSP 36 is coupled to an input of an inverter 222, illustratively an inverter of a type 74LCX04 hex inverter. The output of inverter 222 is coupled to an input of a buffer 224, illustratively, a type 74HC244 octal 3-state buffer.

Referring now to FIG. 5e, pin 52 of DSP 36 is coupled through a 10 KΩ resistor to ground. Pins 43, 45, 47, 49, 50, 52 and 54 of DSP 36 are coupled to respective terminals on one side of a 7×2 jumper. Pins 44, 46, 48, a blank, 51, 53 and ground are coupled to respective opposite terminals. This jumper is used to connect an emulator to the DSP to permit debugging from a PC.

Referring to FIG. 5f, the signals for processing by DSP 36 are provided from a connector 230 through a 0.01 μF capacitor to the non-inverting (+) input terminal of a difference amplifier 232, illustratively a type AD8001 amplifier. The output of amplifier 232 is coupled through a series 51 Ω resistor, a 0.01 μF capacitor and the primary winding of an RF transformer 234, illustratively a type T4-1-KK81 transformer, to ground. The secondary winding of transformer 234 has a center tap coupled to a VREF terminal of an Analog-to-Digital converter (AD) 236, illustratively a type AD9203 AD. The ends of the secondary of transformer 234 are coupled to the AnalogvoltageINPositive and AINNegative terminals, pins 25 and 26, respectively, of AD 236. AD 236 is coupled via a DSP data bus DSP_D14 DSP_D23 to the DSP as follows. AD 236 pins 3-12 are coupled to the DSP data lines DSP_D14-DSP_D23, respectively. Lines DSP_D14 - DSP_D23 are also coupled to pins 74-79 and 81-84 of DSP 36. The +3.3V supply is coupled to AD pin 2. AD pin 2 is also coupled through 10.1 I F capacitance to ground. The +A_{—}3.3V supply is coupled to AD pins 28 and 14. AD pin 28 is also coupled through 10.1 μF capacitance to ground. A 200 Ω resistor R104 is coupled across pins 25 and 26 of AD 236. Pins 23 and 18 of AD 236 are coupled to each other, and through 10.1 μF capacitance to ground. 10.1 μF capacitance is coupled between pins 22 and 24 of AD 236. Each of pins 22 and 24 of AD 236 is further coupled through a 0.1 μF capacitor to ground.

Pins 1, 16 and 27 of AD 236 are coupled to ground. Line AD_STBY is coupled to pin 17 of AD 236. Line AD_CLK is coupled to pin 15 of AD 236. A 51 Ω resistor is coupled between pin 19 of AD 236 and ground. A parallel combination of a 51 KΩ resistor and a 1 μF capacitor is coupled between pin 21 of AD 236 and ground. A 470 Ω resistor is coupled between the output terminal and inverting (−) input terminal of amplifier 232. A 470 Ω resistor is coupled between amplifier 232's input terminal and ground. A 51 Ω resistor is coupled between amplifier 232's +input terminal and ground. The instrument 20's+5V supply is coupled to amplifier 232's positive supply terminal. The instrument 20's -5V supply is coupled to amplifier 232's negative supply terminal.

Referring back to FIG. 5d, a stereo audio digital-to-analog converter (DA) 240 illustratively is a PCM1725U IC. Pins 1, 2, 3, and 14 of DA 240 are coupled to pins 7, 5, 8 and 9 of buffer 224. A 10 μF capacitor is coupled between pin 5 of DA 224 and ground. Pin 9 of DA 240 is coupled to line DACOUT. Pins 7 and 12 of DA 240 are coupled to ground. Pin 19 of buffer 224, the /AUDio_ENAble line, is coupled through an inverter 242, illustratively a type 74LCX04 hex inverter, and a 10 KΩ resistor to the base of an NPN transistor 243. The base of transistor 243 is coupled to ground through a 10 KΩ resistor. The emitter of transistor 243 is coupled to ground. The collector of transistor 243 is coupled through a 10 KΩ resistor to the base of a PNP transistor 244. The base of transistor 244 is coupled to the +5V supply through a 10 KΩ resistor. The emitter of transistor 244 is coupled to the +5V supply. The collector of transistor 244 is coupled to pins 8 and 13 of DA 240. Pins 8 and 13 are coupled to ground through 10.1 μF capacitance. Transistor 243 illustratively is a type MMUN2211LT1 . Transistor 244 illustratively is a type MMUN2111LT1. Pins 11, 13, and 15 of buffer 224 are respectively coupled to lines DSP_CLK, PCM_LRCIN and DT0, respectively.

The instrument 20's RF analog supply control is illustrated in FIG. 6. ANALOGPoWeR line is coupled through a 10 KΩ resistor to the base of an NPN transistor 246. Transistor 246 illustratively is a type MMUN2211LT1. The base of transistor 246 is coupled through a 10 KΩ resistor to ground. The emitter of transistor is coupled to ground. The collector of transistor 246 is coupled to the gate of a Field Effect Transistor (FET) 248. The base of transistor 246 is also coupled through a 100 KΩ resistor to the instrument 20's VIN supply. The drain of FET 248 is coupled to VIN. The source of FET 248 is coupled to the instrument 20's+VIN line.

Turning to FIG. 7, pins 1, 3, 7 and 9 of a 20 pin connector 250 are coupled to pins 18, 16, 14, and 12, respectively, of an octal 3-state buffer 252, illustratively a 74HC244 IC. Pins 5 and 6 of connector 250 are coupled to ground. Pins 13, 15 and 19 of connector 250 are coupled to pins 9, 7 and 5, respectively, of buffer 252. Pin 11 of connector 250 is coupled to pin 2 of an octal three-state buffer 254, which illustratively is also a 74HC244 IC. Pins 2, 4, and 16 of connector 250 are coupled to lines −5VOPT, +5VOPT, and +5VLEAK, respectively. Pin 8 is coupled to the +3.3V supply. Pin 10 is coupled to the instrument 20's+6V supply. Pin 12 is coupled to the −5V supply. Pin 14 is coupled to the +5V supply. Pin 18 is coupled to the system +20V supply.

Pins 1, 2, 4, 6 and 8 of buffer 252 are coupled to system lines RF_3STATE, OPTPLDENA1, OPTPLDENA2, OPTDACWRI, and OPTDACCLK, respectively. Pins 19, 11, 13 and 15 of buffer 252 are coupled to system lines RF_3STATE, DT0, /SCLK0, and RFPLDENA, respectively. Pins 20 of buffers 252, 254 are coupled to +3.3V. Pins 10 of buffers 252, 254 are coupled to ground. Pin 18 of buffer 254 is coupled to system line DRO. Pin 1 of buffer 254 is coupled to system line RF_3STATE.

The instrument 20's +2.5V supply is illustrated in FIG. 8. A low dropout regulator 260 illustratively is a type ADP3330ART-2.5 IC. Pins 2 and 6 of IC 260 are coupled to the system +3.3V digital power supply. Pin 4 of IC 260 is coupled to ground. +2.5V appears across pin 1 of IC 260 and ground A 4.7 μF capacitor is coupled across pin 2 of IC 260 and ground. A 4.7 μF capacitor is coupled across pin 1 of IC 260 and ground

The instrument 20's +VIN to +6V analog supply is illustrated in FIG. 9. Pins 3 and 8 of a step-down DC-DC controller 262, illustratively a type MAX1627 IC, are coupled to ground. A 64.9 KΩ resistor is coupled across pin 2 of IC 262 and ground. A 0.01 μF capacitor and 2.2 μF capacitor in parallel are coupled between pin 5 of IC 262 and ground. A 0.22 Ω resistor is coupled between pins 5 and 6 of controller 262. The source of an FET in a package 264 with a Schottky diode is coupled through a 220 μH inductor to +6V. The drain of the FET in package 264 is coupled to pin 6 of controller 262. Pin 7 of controller 262 is coupled to the gate of the FET and controls conduction between the drain and source terminals of the FET. The anode of the Schottky diode in package 264 is coupled to ground. The cathode of the Schottky diode in package 264 is coupled to the source of the FET. +6V is coupled through a parallel RC circuit including a 100 pF capacitor and a 261 KΩ resistor to pin 2 of controller 262. +6V is also coupled through the parallel combination of a 10 μF capacitor and a 0.1 μF capacitor to ground. When the drain-source path of the FET is conductive, current flows through the inductor and energy is stored in the inductor's magnetic field. When the FET is turned off, a flyback pulse appears across the inductor as the magnetic field collapses and the energy is recovered. The flyback pulse is rectified by the Schottky diode and stored in the capacitors on the +6V side of the supply. The output voltage is fed back through pin 2 of controller 262 to control the signal on pin 7 of controller 262. Package 264 illustratively is a type IRF7321D2 package.

The ±5V supply for the instrument 20's option board is illustrated in FIG. 10. The system RFOPTIONPWR line is coupled to the gate of an FET 270 and to the input of an inverter 272. FET 270 illustratively is a type BSS138 FET. Inverter 272 illustratively is a type 74LCX04 inverter. The output of inverter 272 is coupled through a 10 kΩ resistor to the base of a PNP transistor 274. Transistor 274 illustratively is a type MMUN2111LT1 transistor. The emitter of transistor 274 is coupled to the system +3.3V supply. The base is coupled through a 10 KΩ resistor to the system +3.3V supply. The collector of transistor 274 is coupled through a 10 KΩ resistor to the base of an NPN transistor 276. The collector of transistor 276 is coupled through parallel 0.1 μF and 10 μF capacitors to ground. The base of transistor 276 is coupled through a 10 KΩ resistor to its emitter. The emitter of transistor 276 is coupled to coupled to the option board −5V supply line. The collector of transistor 276 is instrument 20's −5VOPT line. Transistor 276 illustratively is a MMUN2211LT1.

The source of FET 270 is coupled to ground. The drain of FET 270 is coupled through a 100 KΩ resistor to the +5V supply. The drain of FET 270 is also coupled to the gate of an FET 278. FET 278 illustratively is a type BSS84 FET. The drain of FET 278 is coupled to the system +5V supply. The source of FET 278 is coupled through parallel 0.1 μF and 10 μF capacitors to ground. The source of FET 278 is instrument 20's +5VOPT line.

The instrument 20's +VIN to −5V supply is illustrated in FIG. 11. Pins 3 and 8 of a DC-DC controller 282, illustratively a type MAX774 IC, are coupled to ground. Pins 2 and 4 of IC 282 are coupled together and through a 0.1 μF capacitor to ground. A 0.01 μF capacitor and 10 μF capacitor in parallel are coupled between pin 5 of IC 282 and ground. A 1 Ω resistor is coupled between pins 5 and 6 of controller 282. The source of an FET in a package 284 with a Schottky diode is coupled through a 100 μH inductor to ground. The drain of the FET in package 284 is coupled to pin 6 of controller 282. Pin 7 of controller 282 is coupled to the gate of the FET. The anode of the Schottky diode in package 284 is coupled to pin 1 of controller 282, −5V. The cathode of the Schottky diode in package 284 is coupled to the source of the FET. −5V is also coupled through the parallel combination of a 150 μF capacitor and a 0.1 μF capacitor to ground. Package 284 illustratively is a type IRF7321D2 package.

The instrument 20's +VIN to +5V supply is illustrated in FIG. 12. Pins 3 and 8 of a DC-DC controller 292, illustratively a type MAX1627 IC, are coupled to ground. A 64.9 KΩ resistor is coupled across pin 2 of IC 292 and ground. Pin 4 of IC 292 is coupled through a 0.1 μF capacitor to ground. A parallel combination of a 0.01 μF capacitor and two 33 μF capacitors is coupled between pin 5 of IC 292 and ground. A 0.15 Ω resistor is coupled between pins 5 and 6 of controller 292. The source of an FET in a package 294 with a Schottky diode is coupled through a 150 μH inductor to +5V. The drain of the FET in package 294 is coupled to pin 6 of controller 292. Pin 7 of controller 292 is coupled to the gate of the FET. The anode of the Schottky diode in package 294 is coupled to ground. The cathode of the Schottky diode in package 294 is coupled to the source of the FET. +5V is coupled through a parallel RC circuit including a 100 pF capacitor and a 187 KΩ resistor to pin 2 of controller 292. +5V is also coupled through two 150 μF capacitors and a 0.1 μF capacitor, all in parallel, to ground. Package 294 illustratively is a type IRF7321D2 package.

The instrument 20's +5V RF leak voltage supply is illustrated in FIG. 13. The system ENABLELEAK line is coupled through a 10 KΩ resistor to the base of an NPN transistor 300. Transistor 300 illustratively is a type MMUN2211LT1 transistor. The base of transistor 300 is coupled through a 10 KΩ resistor to ground. The emitter of transistor 300 is coupled to ground. The collector of transistor 300 is coupled through a 10 KΩ resistor to the base of a PNP transistor 302. The base of transistor 302 is coupled through a 10 KΩ resistor to +5V. The collector of transistor 302 is coupled to +5V. The emitter of transistor 302 is coupled through the parallel combination of a 0.1 μF capacitor and a 10 μF capacitor to ground. +5V leak voltage appears on the emitter of transistor 302. Transistor 302 illustratively is a type MMUN2111LT1 transistor.

The instrument 20's +VIN to +20V ANAlog supply is illustrated in FIG. 14. Pins 4, 6 and 7 of a DC-DC controller 322, illustratively a type MAX772 IC, are coupled to ground. A 0.01 μF capacitor and 4.7 μF capacitor in parallel are coupled between pin 2 of IC 322 and ground. Pin 3 of IC 322 is coupled through a 47.5 KΩ resistor and ground. Pin 5 of IC 322 is coupled through a 0.1 μF capacitor to ground. A 0.22 Ω resistor is coupled between pin 8 of controller 322 and ground. The source of an FET 324 is coupled to pin 8 of IC 322. The drain of FET 324 is coupled through a 220 μH inductor to pin 2 of controller 322. Pin 1 of controller 322 is coupled to the gate of the FET. The anode of a Schottky diode 326 is coupled to the drain of FET 324. The cathode of Schottky diode 326, the +20V ANA supply terminal, is coupled through a 590 KΩ resistor to pin 3 of IC 322. +20V ANA is also coupled through the parallel combination of a 10 μF capacitor and a 0.01 μF capacitor to ground. FET 324 illustratively is a type IRF7413 FET. Schottky diode 326 illustratively is a type PRLL5817 Schottky diode.

LCD Section

The instrument 20's LCD 50 +5VDIGital to VEE negative power supply is illustrated in FIG. 15. The instrument 20's +5VDIG line is coupled to pin 5 of a DC-DC controller 332, illustratively a type MAX774 IC. Pins 2 and 4 of IC 332 are coupled together through a 150 KΩ resistor, and pin 4 is coupled through a 0.1 μF capacitor to ground. A 0.01 μF capacitor and 10 μF capacitor in parallel are coupled between pin 5 of IC 332 and ground. A 1 Ω resistor is coupled between pins 5 and 6 of controller 332. The source of an FET in a package 334 with a Schottky diode is coupled through a 100 μH inductor to ground. The drain of the FET in package 334 is coupled to pin 6 of controller 332. Pin 7 of controller 332 is coupled to the gate of the FET. The anode of the Schottky diode in package 334, terminal VEE, is coupled through a 2.1 MΩ resistor to pin 2 of IC 332. The cathode of the Schottky diode in package 334 is coupled to the source of the FET. VEE is also coupled through the parallel combination of a 4.7 μF capacitor and a 0.01 μF capacitor to ground. Package 334 illustratively is a type IRF7321D2 package.

Referring to FIG. 16, the instrument 20's LCD cold-cathode fluorescent lamps (CCFL) backlight controller 46 includes a digitally controlled CCFL backlight driver 340, illustratively a MAX1611 IC. Pin 13 of driver 340 is coupled to ground. Pin 8 of driver 340 is coupled through a 51 KΩ resistor to ground and through a 150 KΩ resistor to pins 4 and 9 of driver IC 340. Pins 4 and 9 are also coupled to ground through a 0.1 μF capacitor. Pin 6 of driver 340 is coupled through a 0.027 μF capacitor to ground. Pin 5 of driver 340 is coupled through a 0.1 μF capacitor to ground. Pin 3 of driver 340 is coupled through a 100 KΩ resistor to ground and to instrument 20's SMBSUS line. Pins 1 and 2 of driver 340 are coupled to system line I2C0, which is I2CDATA, and line 12C1, which is I2CCLK, of the system I² C bus, respectively. Pin 16 of driver 340 is coupled to the VIN line and through a 47 μF capacitor to ground.

Pin 12 of driver 340 is coupled through a 0.1 μF capacitor to ground. Pin 12 is also coupled to the anode of diode 342, illustratively a PMLL4148. The cathode of diode 342 is coupled through a 20 Ω resistor to pin 14 of driver 340. Pin 14 is also coupled through a 0.1 μF capacitor to pin 15 of driver 340. Pin 15 is also coupled to the cathode of a Schottky diode 344, the anode of which is coupled to ground. Schottky diode 344 illustratively is a type PRLL5817 diode. Pin 15 is also coupled through a 100 μH inductor 346 to the anode of a diode 348. The cathode of diode 348 is coupled through a 51 KΩ resistor to pin 10 of driver 340. Diode 348 illustratively is a type PMLL4148 diode. Pin 10 of driver 340 is also coupled through an 8.2 KΩ resistor to ground. The cathode of diode 348 is also coupled through a 0.027 μF capacitor to ground. The anode of diode 348 is coupled through a 510 Ω resistor to the base of an NPN transistor 350. The base of transistor 350 is coupled through a feedback winding of a transformer 352 to the base of an NPN transistor 354. Transistors 350, 354 illustratively are type 2N2222A transistors. Transformer 352 illustratively is a type CTX210605 transformer. The emitters of transistors 350, 354 are joined and coupled to pins 7 and 11 of driver 340. The joined emitters of transistors 350, 354 are also coupled through a 0.68 Ω resistor to ground. The collectors of transistors 350, 354 are coupled to the ends of a primary winding of transformer 352. A center tap of the primary winding of transformer 352 is coupled to the anode of diode 348. A 0.1 μF capacitor is also coupled between the collectors of transistors 350, 352. The secondary of transformer is coupled in series with a 33 pF capacitor across the cold cathode fluorescent lamps (not shown) of the backlight.

Two different embodiments of the instrument 20's LCD contrast controller 48 are illustrated in FIG. 17. The first embodiment is for a black and white (B&W) display. The second is for a color display. Difference between these embodiments are noted in the description that follows. The display LCD contrast supply includes a digitally adjustable LCD bias supply 360, illustratively a MAX1621 IC. Pins 1 and 2 of IC 360 are coupled to line I2CDATA, and line I2CCLK of the system I² C bus, respectively. The VIN line is coupled to pin 3 of IC 360. Pin 3 is also coupled to ground through a 47 μF capacitor. The instrument 20's SMBSUS line is coupled to pin 4 of IC 360. Pin 4 is coupled through a 100 KΩ resistor to ground. Pin 5 of IC 360 is coupled to ground. Pin 11 of IC 360 is coupled to +3.3V. Pin 11 is also coupled through a 0.1 μF capacitor to ground. If the contrast supply is for a B & W display, Pin 7 of IC 360 is coupled to ground.

If IC 360 is for a color display, pin 9 is coupled through a 93.1KΩ resistor to ground. If IC 360 is for a B & W display, pin 9 is coupled through a 127 KΩ resistor to pin 6. Pin 6 is coupled through a 0.1 μF capacitor to ground. Pin 10 of IC 360 is coupled through a 316 KΩ resistor to pin 9. If the contrast supply is for a color display, pin 11 is coupled to pin 7. Pins 12and 13 of IC 360 are coupled to ground. Pins 15 and 16 of IC 360 are coupled to the gate of an FET 362, illustratively a type IRF7413 FET. The source of FET 362 is coupled to ground. The drain of FET 362 is coupled through a 100 μH inductor to VIN. Pin 14 of IC 360 is coupled to the drain of FET 362. If IC 360 is for a B & W display, the drain of FET 362 is coupled through a 0.1 μF capacitor to the anode of a Schottky diode 364. The anode of Schottky diode 364 is coupled to ground. If IC 360 is for a B & W display, the anode of Schottky diode 364 is coupled to the cathode of a Schottky diode 366. The anode of Schottky diode 366 is coupled through a 10 μF capacitor to ground. The anode of Schottky diode 366 forms the LCD B & W voltage line VLCDB&W. VLCDB&W is coupled through a parallel RC circuit including a 1.3 MΩ resistor and a 100 pF capacitor to pin 9 of IC 360. If IC 360 is for a color display, the drain of FET 362 is coupled to the anode of a Schottky diode 368. The cathode of Schottky diode 368 is coupled through a 10 μF capacitor to ground. The cathode of Schottky diode 368 forms the LCD color voltage line VLCDCOLOR. VLCDCOLOR is coupled through a parallel RC circuit including a 1.3 MΩ resistor and a 100 pF capacitor to pin 9 of IC 360. Schottky diodes 364, 366, 368 illustratively are type PRLL5817 Schottky diodes.

Instrument 20's +VIN to +5VDIGital power supply is illustrated in FIG. 18. System line ConTRoL5VDIGital is coupled through a 10 KΩ resistor to the base of an NPN transistor 370. Transistor 370 illustratively is a type MMUN221LLT1 transistor. The base of transistor 370 is coupled to ground through a 10 KΩ resistor. The emitter of transistor 370 is coupled to ground. The collector of transistor 370 forms the 5VOFF line. The collector of transistor 370 is coupled through a 100 KΩ resistor to VIN. The collector of transistor 370 is also coupled to pin 3 of a step-down DC-DC controller, illustratively a MAX1627 IC 372. Pin 8 of controller 372 is coupled to ground. A 64.9 KΩ resistor is coupled across pin 2 of IC 372 and ground. Pin 4 of IC 372 is coupled through a 0.1 μF capacitor to ground. A parallel combination of a 0.0 μF capacitor and two 33 μF capacitors is coupled between pin 5 of IC 372 and ground. A 0.22 Ω resistor is coupled between pins 5 and 6 of controller 372. The source of an FET in a package 374 with a Schottky diode is coupled through a 220 μH inductor to +5VDIG. The drain of the FET in package 374 is coupled to pin 6 of controller 372. Pin 7 of controller 372 is coupled to the gate of the FET. The anode of the Schottky diode in package 374 is coupled to ground. The cathode of the Schottky diode in package 374 is coupled to the source of the FET. +5VDIG is coupled through a parallel RC circuit including a 100 pF capacitor and a 187 KΩ resistor to pin 2 of controller 372. +5VDIG is also coupled through two 150 μF capacitors and a 0.1 μF capacitor, all in parallel, to ground. Package 374 illustratively is a type IRF7321D2 package.

Instrument 20's LCD buffers 380, 382 and 384 are illustrated in FIG. 19. Buffers 380, 382 and 384 illustratively are each half of a type 74HCT244 IC. Instrument 20's LCD bus lines LD7, LD5, LD8, LD12, LD9, LD3, LD1, LD11, LD13, LD2, LD4 and LD6 are coupled to pins 2, 4, 6 and 8 of buffer 380, pins 11, 13, 15 and 17 of buffer 382, and pins 2, 4, 6 and 8 of buffer 384, respectively. Pins 12, 14, 16 and 18 of buffer 380 are coupled to system lines OLCDLOAD, OLD8, OLD5 and OLD7, respectively. Pins 3, 5, 7 and 9 of buffer 382 are coupled to system lines OLCDFRAME, OLD1, OLD3 and ODISPLAYOFF, respectively. Pins 12, 14, 16 and 18 of buffer 384 are coupled to lines OLD6, OLD4, OLD2 and OLCDSHIFT, respectively. Pins 1,10 and 19 of buffers 380, 382, 384 are coupled to ground. Pins 20 of buffers 380, 382, 384 are coupled to +5VDIG. 0.1 μF capacitors are coupled between pins 20 and ground. LCD bus line LD12 forms the system LCDLOAD line. LCD bus line LD9 forms the system LCDOFF line. LCD bus line LD11 forms the system LCDFRAME line. LCD bus line LD13 forms the system LCDSHIFT line. LCD bus line LD10 forms the system CTRL5VDIG line. Instrument 20's LCD connectors are illustrated in FIG. 20.

Peripheral Section

The instrument 20's microcontroller reset and keyboard circuitry is illustrated in FIGS. 21-27. FIG. 21 illustrates PLD 150. As previously noted, PLD 150 illustratively is a XC9572XL-10VQ64C. System lines D0- D15 are coupled to pins 52-42, 40-38, 36 and 35, respectively, of PLD 150. For debugging, pin 34 of PLD 150 is coupled to ground. For in-circuit testing of various ICs, JointTestActionGroup pin 34 is coupled through a 10 KΩ resistor to +3.3V. The HRESET line is coupled to pin 33 of PLD 150. Pins 32 and 31 are coupled to the EXTRAInputOutputA and EXTRAIOB lines, respectively, of instrument 20. Pins 27 and 25 of PLD 150 are coupled to lines A29 and A30, respectively. Pin 24 is coupled to the DSPRESET line, and through a 10 KΩ resistor to +3.3V. Pins 23 and 22 are coupled to the /BUSOE and SWITCH lines. Pins 20-18 and 13 are coupled to the keypad Function1-F4 lines, respectively, of a DTMF-type keypad (not shown). Pins 12-6, 4, 1, and 63-56 are coupled to the keypad's 1ABC, 2DEF, 3GHI, 4JKL, 5MNO, 6PQR, 7STU, 8VWX, 9YZ, ZERO, UP, DOWN, LEFT, RIGHT, HOME, CleaR and ENTER keys, respectively, of the keypad. Pins 14, 21, 41, and 54 of PLD 150 are coupled to ground. Pin 15 of PLD 150 is coupled to the /BUSWR line. Pin 16 of PLD 150 is coupled to the CS7 line. Pins 2, 5 and 17 of PLD 150 are coupled to system lines SERIALReaDY, SERIALINVALID and SignaturePadRESET, respectively. Pin 64 of PLD 150 is coupled to the IRQ1 line. Pins 3, 37, 26 and 55 of PLD 150 are coupled to +3.3V. 0.4 μF capacitance is coupled between joined pins 3, 37, 26, 55 and ground. Pins 30, 28, 53 and 29 of PLD 150 are coupled to system lines TCK, μCTDO, TDO and TMS, respectively.

FIG. 22 illustrates instrument 20's keyboard and speaker connectors. Pins 4-8, 10-17 and 19-26 of a twenty-six pin connector 400 are coupled through respective 22KΩ resistors to +3.3V. Pins 26-19, 17-10 and 8-4 form the instrument 20's F1-F4, 1ABC, 2DEF, 3GHI, 4JKL, 5MNO, 6PQR, 7STU, 8VWX, 9YZ, ZERO, UP, DOWN, LEFT, RIGHT, HOME, CleaR and ENTER lines, respectively, for coupling to these respective keys of the keypad. Pins 18 and 9 of connector 400 are coupled to the SPEAKER0 and SPEAKER1 lines, respectively. Pin 3 of connector 400 is coupled to ground. Pins 2 and 1 of connector 400 are coupled to system lines VUNREG and ON/OFF. On/off switch 402 is coupled between pins 1 and 2 of connector 400.

FIG. 23 illustrates the instrument 20's audio amplifier. An audio power amplifier 410 with shutdown mode, illustratively an LM4862M IC, has pin 6 coupled to +5VDIG and pin 7 coupled to ground. Pin 6 is coupled through a 0.1 μF capacitor to ground. Pin 1 is coupled to the collector of an NPN transistor 412, illustratively a type MMUN2211LT1 transistor. The EXTRAIOA line is coupled through a 10 KΩ resistor to the base of transistor 412. The base of transistor 412 is coupled through a 10 KΩ resistor to ground. The emitter of transistor 412 is coupled to ground. The collector of transistor 412 is coupled through a 47 KΩ resistor to pin 6 of IC 410. Pins 2 and 3 of IC 410 are coupled together and through a 4.7 μF capacitor to ground. The DACOUT line is coupled through the series combination of a 0.1 μF capacitor and a 20 KΩ resistor to pin 4 of IC 410. The SPEAKER line is coupled through the series combination of a 0.1 μF capacitor and a 220 KΩ resistor to pin 4 of IC 410. Pins 5 and 8 of IC 410 are coupled to the instrument's SPEAKER0 and SPEAKER1 lines, respectively. Pin 5 is coupled through a parallel RC circuit including a 20 KΩresistor and a 5 pF capacitor to pin 4 of IC 410.

FIG. 24 illustrates the instrument 20's RS-232 port 52. An RS-232 transceiver 420, illustratively a MAX3226E IC, has a pin 13 coupled to a ring contact 422-1 of a stereo phone jack 422, and a pin 8 coupled to a tip contact 422-2 of jack 422. A sleeve 422-3 of jack 422 is coupled to ground. Pins 12 and 14 of IC 420 are coupled to ground. Pins 15 and 16 of IC 420 are coupled to +3.3V. Pins 1 and 10 of IC 420 are coupled to the SERIALRDY and SERIALINVALID lines, respectively. Pins 11 and 9 of IC 420 are coupled to the RS232TXD and RS232RXD lines. Pin 2 is coupled through a 0.1 μF capacitor to pin 4. Pin 5 is coupled through a 0.1 μF capacitor to pin 6. Pins 15, 3 and 7 are coupled through a 0.01 μF capacitor, a 0.1 μF capacitor, and a 0.1 μF capacitor, respectively, to ground. Additionally, this interface automatically connects to a serial jack 424 in a mobile mount of, for example, a CATV network service vehicle, when the instrument 20 is placed in the mobile mount. Jack 424 includes a five-pin connector, pin 1 of which supplies MOBILE+power to the instrument 20 when the instrument 20 is in the mount and connected to jack 424. Pin 5 of jack 424 is coupled to ground. Pins 3 and 4 are coupled to pins 13 and 8, respectively, of IC 420. Pin 2 of jack 424 is coupled through a 10 Ω resistor to the collector of an NPN transistor 426, illustratively a type MMUN2211LT1 transistor. Instrument 20's EXTRAIOB line is coupled through a 10 KΩ resistor to the base of transistor 426. The base of transistor 426 is coupled to ground. The emitter of transistor 426 is coupled to ground. The collector of transistor 426 is coupled through a 1 KΩ resistor to +5VDIG.

Referring to FIG. 25, temperature sensor 44 has its pins 4-7 coupled to ground, its pin 8 coupled to +3.3V and through a 0.1 μF capacitor to ground, its pin 1 coupled to instrument 20's I2CDATA line, and its pin 2 coupled to instrument 20's I2CCLK line.

Referring to FIG. 26, a five pin signature pad 54 connector 430 has a pin 1 coupled to +3.3V, a pin 5 coupled to ground, a pin 2 coupled through a 100 KΩ resistor to +3.3V, and a pin 4 coupled to an input of an inverter 432, the output of which is coupled to the instrument 20's RXD2 line. The instrument 20's TXD2 line is coupled to an input of an inverter 434, the output of which is coupled to pin 3 of connector 430. Inverters 432, 434 illustratively are type SN74AHC1G04 inverters.

FIGS. 27 and 28 illustrate instrument 20's option circuit board connectors.

Power Supply Section

Referring now to FIGS. 29a-c, the instrument 20's power supply includes an IC fast charging controller 440, illustratively a MAX2003 IC. Pin 16 of IC 440 is coupled to +5VCHARGing. Pins 3-5, 8 and 9 of IC 440 are coupled to ground. Pin 1 of IC 440 is coupled to the collector of an NPN transistor 442, illustratively a type MMUN2211LT1 transistor. Instrument 20's /CHARGE line is coupled through a 10 KΩ resistor to the base of transistor 442. The base of transistor 442 is coupled through a 10 KΩ resistor to ground. The emitter of transistor 442 is coupled to ground. The collector of transistor 442 is also coupled to +5VCHARG through a 100 KΩ resistor. Pin 2 of IC 440 is coupled through a 100 KΩ resistor to +5VCHARG. Pin 6 of IC 440 is coupled through a 100 KΩ resistor to the TEMPSENSE line. The TEMPSENSE line is also coupled through a 2.21 KΩ resistor to +5VCHARG and through a 1.62 KΩ resistor to ground. Pin 6 is also coupled through a 0.1 μF capacitor to ground. Pins 7, 10 and 11 of IC 440 are coupled through respective 0.1 μF capacitors to ground. Pin 10 is also coupled through a 33.2 KΩ resistor to ground and through a 3.48 KΩ resistor to pin 11. Pin 11 is also coupled through a 60.4 KΩ resistor to +5VCHARG. Pin 12 of IC 440 is coupled to the IRQ3 line. Pin 13 is coupled to instrument 20's CHARGING line. Pin 14 of IC 440 is coupled through a 10 KΩ resistor to the base of an NPN transistor 444, illustratively a type MMUN2211LT1 transistor. The base of transistor 444 is coupled through a 10 KΩ resistor to ground. The emitter of transistor 444 is coupled to ground. The collector of transistor 444 is coupled through a 10 KΩ resistor to the base of an NPN transistor 446, again, illustratively a type MMUN2211LT1 transistor. The base of transistor 446 is coupled through a 10 KΩ resistor to ground.

Referring now to FIG. 29b, pin 7 of IC 440 is coupled through series 100 KΩ and 20 KΩ resistors 448, 450 to ground. The common terminal of resistors 448, 450 is coupled through a 100 KΩ resistor to the anode of a Schottky diode 452. The cathode of Schottky diode 452 is coupled to the instrument 20's VUNREGulated line. The anode of Schottky diode 452 is coupled to the instrument 20's VBATTery line.

Referring to FIG. 29c, the collector of transistor 444 is coupled through a 10 KΩ resistor to an input terminal, illustratively pin 3, of a voltage regulator 454, illustratively an LM1086CS-ADJ IC. The collector of transistor 446 is coupled to pin 1 of IC 454. Pin 2 of IC 454 is coupled through a 1.8 Ω resistor to the anode of a Schottky diode 455. The cathode of Schottky diode 455 is coupled to the anode of Schottky diode 452. Pin 1 of IC 454 is coupled through a 1 KΩ resistor to the anode of Schottky diode 455. The anode of Schottky diode 455 is also coupled through 41 Ω resistance to pin 3 of IC 454. Power can be supplied to instrument 20 in several ways, either through its own rechargeable battery, or through the previously mentioned mobile mount via the MOBILE+ line, or through a power jack 456 from, for example, an AC-to-DC converter, not shown. If power is being supplied from the mobile mount, this condition is signaled to the instrument through its MOBILEPoWeR line. The base of an NPN transistor 458 is coupled through a 10 KΩ resistor to MOBILE+. Transistor 458 illustratively is a type MMUN2211LT1 transistor. The base of transistor 458 is coupled to ground through a 10 KΩ resistor. The collector of transistor 458 is coupled to the MOBILEPWR line, and through a 100 KΩ resistor to +3.3V. If power is being supplied through power jack 456, this condition is signaled to the instrument through its NONMOBILEPWR line. The base of an NPN transistor 460 is coupled through a 10 KΩ resistor to the tip contact 456-1 of jack 456. Transistor 460 illustratively is a type MMUN2211LT1 transistor. The base of transistor 460 is coupled to ground through a 10 KΩ resistor. The collector of transistor 460 is coupled to the NONMOBILEPW R line, and through a 100 KΩ resistor to +3.3V. Tip contact 456-1 is coupled to the anode of a Schottky diode 462. MOBILE+ is coupled to the anode of a Schottky diode 464. The cathodes of Schottky diodes 462 and 464 are coupled together to form the instrument 20's EXTernalPoWeR line. EXTPWR is coupled to pin 3 of IC 454. EXTPWR is also coupled to ground through a 10 μF capacitor. EXTPWR is also coupled to an input terminal, for example, pin 1, of a voltage regulator 466, illustratively an LM2940CS-15 IC. Pins 2 and 4 of IC 466 are coupled to ground. Pin 3 of IC 466 is coupled to the anode of a Schottky diode 468, the cathode of which is coupled to instrument 20's VUNREG line.

Returning to FIG. 29b, instrument 20's ON/OFF line is coupled through a 10 KΩ resistor to the base of an NPN transistor 470, such as, for example, a type MMUN2211LT1 transistor. The base of transistor 470 is coupled through a 10 KΩ resistor to ground. The emitter of transistor 470 is coupled to ground. The collector of transistor 470 is coupled to the SWITCH line. The collector of transistor 470 is also coupled through a 10 KΩ resistor to +3.3V. The ON/OFF line is also coupled through a 10 μF capacitor to ground. The ON/OFF line is also coupled through a 10 KΩ resistor to the base of an NPN transistor 472, such as, for example, a type MMUN2211LT1 transistor. The base of transistor 472 is coupled to ground through a 10 KΩ resistor. The emitter of transistor 472 is coupled to ground. The collector of transistor 472 is coupled through a 10 KΩ resistor to the gate of an FET 474. FET 474 illustratively is a type SI4463DY FET. The drain of FET 474 is coupled to the VUNREG line. The drain of FET 474 is also coupled through a 100 KΩ resistor to its gate. The source of FET 474 is coupled to the VIN line. The source is also coupled through a 47 μF capacitor to ground. The source of an FET 476 is coupled to the collector of transistor 472. The drain of FET 476 is coupled to ground. The gate of FET 476 is coupled to the TEXP line. FET 476 illustratively is a type BSS138 FET.

The CHARGERON line is coupled through a 10 KΩ resistor to the base of an NPN transistor 478. The base of transistor 478 is coupled through a 10 KΩ resistor to ground. The emitter of transistor 478 is coupled to ground. The collector of transistor 478 is coupled to the /CHARGERON line. The /CHARGERON line is also coupled through a 10 KΩ resistor to the base of a PNP transistor 480. The base of transistor 480 is coupled through a 10 KΩ resistor to +5VDIG. The emitter of transistor 480 is also coupled to +5VDIG. The collector of transistor 480 is coupled to the +5VCHARG line. Transistor 478 illustratively is a type MMUN2211LT1 transistor. Transistor 480 illustratively is a type MMUN2111LT1 transistor.

The instrument 20's +VIN to +3.3V supply is illustrated in FIG. 30. VIN is coupled to an input terminal, illustratively pin 5, of a step-down DC-DC controller 482, illustratively a MAX1627 IC. Pin 8 of controller 482 is coupled to ground. A 64.9 KΩ resistor is coupled across pin 2 of IC 482 and ground. Pin 4 of IC 482 is coupled through a 0.1 μF capacitor to ground. A parallel combination of a 0.01 μF capacitor and two 150 μF capacitors is coupled between pin 5 of IC 482 and ground. A 0.05 Ω resistor is coupled between pins 5 and 6 of controller 482. The source of an FET in a package 484 with a Schottky diode is coupled through a 100 μH inductor to +3.3V. The drain of the FET in package 484 is coupled to pin 6 of controller 482. Pin 7 of controller 482 is coupled to the gate of the FET. The anode of the Schottky diode in package 484 is coupled to ground. The cathode of the Schottky diode in package 484 is coupled to the source of the FET. +3.3V is coupled through a parallel RC circuit including a 100 pF capacitor and a 100 KΩ resistor to pin 2 of controller 482. +3.3V is also coupled through four 150 μF capacitors and a 0.1 μF capacitor, all in parallel, to ground. Package 484 illustratively is a type IRF7321D2 package.

FIG. 31 illustrates an instrument 20 AD 490. AD 490 illustratively is a type AD7478 IC. VIN is coupled through a 100 KΩ resistor and a 27.4 KΩ resistor to ground. The common terminal of the 100 KΩ and 27.4 KΩ resistors is coupled to an input terminal, pin 3 of IC 490. Pin 2 of IC 490 is coupled to ground. Pin 1 of IC 490 is coupled to +3.3V, and through parallel 0.1 μF and 1 μF capacitors to ground. Pins 4, 5 and 6 of IC 490 are coupled to the SPIJCLK, SPIDATAIN and A2DCS lines, respectively.

Option Board

The instrument 20 includes a digital option board, illustrated in FIGS. 32a-c and 33. Referring particularly to FIG. 32a, ethernet interface 56 illustratively includes the previously identified ethernet interface IC. Pins 10, 13, 19, 56 and 59 of IC 56 are coupled to +3.3V. Pin 9 of IC 56 is coupled through a 100 nH inductor to +3.3V and through parallel 47 μF and 0.1 μF capacitors to pin 40 of IC 56. Pin 40 is coupled through a 100 nH inductor to ground. Pins 3, 14, 15, 29, 38, 39, 55 are coupled to ground. Instrument 20's ETHernetRXCLK, ETHTXCLK, ETXD2, ERXD2, RTS2, CD2 and CTS2 lines are coupled to pins 47, 23, 24, 45, 25, 46 and respectively. Pin 4 is coupled through a 75 Ω resistor to pin 5. Pin 7 is coupled through a 75 Ω resistor to pin 8. Pin 11 is coupled through a 75 Ω resistor to pin 12. Pin 42 is coupled through a 12.4 KΩ resistor to ground. Pins 61 and 62 of IC 56 are coupled together through series 51 Ω resistors 491, 492. The junction of resistors 491, 492 is coupled through a 0.1 μF capacitor to ground. Pins 61 and 62 are coupled, illustratively to pins 1 and 3, respectively, of a 10baseT isolation transformer 493, illustratively a type PE-65745 device. See FIG. 32b. Pins 53 and 54 of IC 56 are coupled together. Pins 57 and 58 of IC 56 are coupled together. Pins 53, 54 are coupled through a 24.9 Ω resistor to pin 6 of transformer 493. Pins 57, 58 are coupled through a 24.9 Ω resistor to pin 8 of transformer 493. A 220 pF capacitor is coupled across pins 6 and 8 of transformer 493. Pins 1-4 of an ethernet connector 494 are coupled to pins 16, 14, 11 and 9, respectively, of transformer 493.

The state of interface 56 is displayed on a group of LEDs 500, 502, 504, 506, 508, 510. See also FIG. 32c. The anode of LED 500 is coupled to +3.3V. Its cathode is coupled through a 200 Ω resistor to the collector of an NPN transistor 512. The emitter of transistor 512 is coupled to ground. The base of transistor 512 is coupled through a 10 KΩ resistor to pin 21 of IC 56. The base is also coupled through a 10 KΩ resistor to ground. The anode of LED 502 is coupled to +3.3V. Its cathode is coupled through a 200 Ω resistor to the collector of an NPN transistor 514. The emitter of transistor 514 is coupled to ground. The base of transistor 514 is coupled through a 10 KΩ resistor to pin 52 of IC 56. The base is also coupled through a 10 KΩ resistor to ground. Transistors 512 and 514 illustratively are type MMUN2211LT1 transistors. The anodes of LEDs 504, 506, 508 and 510 are coupled to +3.3V. The cathodes of LEDs 504, 506, 508 and 510 are coupled through respective 200 Ω resistors to pins 34-37, respectively, of IC 56. A 20 MHz clock, such as a type FPX020 device, is coupled across pins 26 and 27 of IC 56. The option board connectors are illustrated in FIG. 33.

RF Section 1

Referring now to FIGS. 34-66, the RF section 38 of instrument 20 receives input signals from several sources, including an antenna connector 60-1 for connection to a so-called rubber DUCK antenna, an antenna connector 60-2 for connection to some other type of LEAKageINput antenna, a mobile antenna 62, and so on. These inputs are coupled to an antenna switch 64 such as, for example, a type BA592 diode switch. Connector 60-2 is coupled through a .01 μF capacitor to the anode of a diode 64-1 in switch 64. The anode of diode 64-1 is also coupled through a 1 KΩ resistor to +5V. A 0.01 μF capacitor is coupled between +5V and ground. The cathode of diode 64-1 is coupled through a 1 KΩ resistor and 2.2 μH inductor in series to the DUCK control terminal of the switch 64. The cathode of diode 64-1 is also coupled to ground through a 0.01 μF capacitor, and the common terminal of the 1 KΩ resistor and 2.2 μH inductor is also coupled to ground through a 0.01 μF capacitor. The anode of a diode 64-2 in switch 64 is coupled to the anode of diode 64-1. The cathode of diode 64-2 is coupled through a 1 KΩ resistor and 2.2 μH inductor in series to the notDUCK control terminal of the switch 520. The cathode of diode 64-2 is coupled through a 0.01 μF capacitor to connector 60-1. The common terminal of the 1 KΩ resistor and 2.2 μH inductor in the cathode circuit of diode 64-2 is coupled to ground through a 0.01 μF capacitor.

The output of the antenna switch 64 is coupled through a 1000 pF capacitor to the anode of a varactor diode 66-1 of a varactor-tuned BPF 66, FIG. 35. The cathode of diode 66-1 is coupled through two 120 nH inductors in series to the cathode of a varactor diode 66-2 of BPF 66. Varactor diodes 66-1 and 66-2 illustratively are MMBV109LT1 varactor diodes. TUNEFIL tuning voltage for BPF 66 is provided from DA 240 via a connector 521, FIG. 35a, to an input terminal of a buffer amplifier 69, and from an output terminal of amplifier 69 via an amplifier 524 and series 2.2 KΩ and 10 KΩ resistors to the common terminal of the two 120 nH inductors. The common terminal of the series 2.2 KΩ and 10 KΩ resistors is coupled through a 0.1 μF capacitor to ground. The common terminal of the two 120 nH inductors is coupled to ground through parallel 47 pF and 68 pF capacitors. The anode of diode 66-1 is coupled to ground through a parallel RC circuit including a 10 KΩ resistor and a 56 pF capacitor. The anode of diode 66-2 is coupled to ground through a parallel RC circuit including a 10 KΩ resistor and a 39 pF capacitor. The output terminal of amplifier 524 is also coupled through series 10 KΩ and 5.1 KΩ resistors to ground, and the common terminal of the 10 KΩ and 5.1 KΩ resistors is coupled to the-input terminal of amplifier 524.

The output appearing at the anode of diode 66-2 is coupled through a 1000 pF capacitor to an input terminal of amplifier 68. An output terminal of amplifier 68 is through the series combination of a 470 nH inductor, a 100 Ω resistor and a 1000 pF capacitor to ground. The common terminal of the 100 Ω resistor and a 1000 pF is coupled to +5VLEAK. The output terminal of amplifier 68 is also coupled through a 1000 pF capacitor to an input terminal of mixer 70, FIG. 36. An output terminal of mixer 70 is coupled to an input terminal of switch 72. The control terminals of switch 72 are coupled to the instrument 20's SLM and notSLM lines. An output terminal of switch 72 is coupled to an input terminal of BPF 74. As previously noted, BPF 74 has a 915 MHz center frequency and a 26 MHz bandwidth. An output terminal of BPF 74 is coupled to an input terminal of amplifier 76. The output terminal of amplifier 76 is coupled through the series combination of a 43 Ω resistor and a 120 nH inductor to +5V. Parallel 150 μF and 100 pF capacitors are coupled between +5V and ground. The output terminal of amplifier 76 is also coupled to an input terminal of BPF 78. As previously noted, BPF 78 has a 915 MHz center frequency and a 26 MHz bandwidth. An output terminal of BPF 78 is coupled through a 915 MHz LPF, such as, for example, a Toko 915 MHz low pass chip filter, to an input terminal of mixer 80. An output terminal of mixer 80 is coupled through a series 180 nH inductor and 0.01 μF capacitor to an input terminal of amplifier 82. An output terminal of amplifier 82 is coupled through a 0.01 μF capacitor to an input terminal of switch 84. This input terminal is also coupled through a 1 KΩ resistor to +5V. +5V is coupled to ground here through a 0.01 μF capacitor. The output terminal of amplifier 82 is also coupled through a series 1 μH inductor and 100 Ω resistor to +5V. +5V is here also coupled to ground through the parallel combination of a 1000 pF capacitor and a 150 μF capacitor. The control terminals of switch 84 are coupled to instrument 20's IF1 and notIF1 lines.

One output terminal of switch 84 is coupled to an input terminal of a first BPF 86. Another output terminal of switch 84 is coupled through a 120 pF capacitor to an input terminal of a second BPF 88. As previously noted, first BPF 86 illustratively has either a 8 MHz wide passband centered at 36.125 MHz (for example, for European-type television systems) or a 6 MHz wide passband centered at 43.75 MHz (for example, for U.S.-type television systems). Second BPF 88 illustratively has a 10.7 MHz center frequency and a 150 KHz passband. A parallel LC circuit including a 1.5 μH inductor and a 47 pF capacitor is coupled between the input terminal of BPF 88 and ground. An output terminal of BPF 86 is coupled through a 51 Ω resistor to an input terminal of switch 90. An output terminal of BPF 88 is coupled through a 120 pF capacitor to an input terminal of switch 90. A parallel LC circuit including a 1.5 μH inductor and a 47 pF capacitor is coupled between the input terminal of BPF 88 and ground.

An output terminal of switch 90 is coupled through a 0.01 μF capacitor to the + input terminal of amplifier 92. The +input terminal of amplifier 92 is also coupled to ground through a 1 KΩ resistor. The output terminal of switch 90 is also coupled through a 1 KΩ resistor to +5V. +5V is coupled to ground here through a 0.01 μF capacitor. The control terminals of switch 90 are coupled to instrument 20's IF1 and notIF1 lines. An output terminal of amplifier 92 is coupled through a 51 Ω resistor to the anode of a diode 94-1 in switch 94. The cathode of diode 94-1 is coupled to ground. The anode of diode 94-1 is also coupled through a 2.2 KΩ resistor to the IF2 line. The anode of diode 94-1 is also coupled through a 0.01 μF capacitor to the cathod of a diode 94-2 in switch 94. The cathode of diode 94-2 is also coupled through a 2.2 KΩ resistor to IF2. IF2 is also coupled through a 0.01 μF capacitor to ground. The output terminal of amplifier 92 is also coupled through a series resistive feedback circuit including a 560 Ω resistor and a 180 Ω resistor to ground. The common terminal of these resistors is coupled to-the input terminal of amplifier 92. The output terminal of amplifier 92 is also coupled through a series RC circuit including a 51 Ω resistor and a 39 pF capacitor to an input terminal of BPF 96. The output terminal of BPF 96 is coupled through a 39 pF capacitor to the cathode of a diode 94-3 in switch 94. A parallel LC circuit including a 2.7 μH inductor and a 47 pF capacitor is coupled between the input terminal of BPF 96 and ground. A parallel LC circuit including a 2.7 μH inductor and a 47 pF capacitor is coupled between the output terminal of BPF 96 and ground. The cathode of diode 94-3 is also coupled through a 51 Ω resistor to IF2. IF2 is also coupled to ground here through a 0.01 μF capacitor. The anodes of diodes 94-2 and 94-3 are coupled together and through a 2.2 KΩ resistor to +5V. +5V is here also coupled to ground through a 0.01 μF capacitor. BPF 96 illustratively has a center frequency of 10.7 MHz and a passband of 17 KHz.

An output terminal of switch 94 is coupled through a 0.01 μF capacitor to an input terminal of variable gain amplifier 98, FIG. 40. An output terminal of amplifier 98 is coupled through a series circuit including a 51 Ω resistor and a 0.01 μF capacitor to the anode of a diode 100-1, FIG. 41, in switch 100. The cathode of diode 100-1 is coupled to ground. The anode of diode 100-1 is also coupled through a 4.7 KΩ resistor to the IF2 line. The anode of diode 100-1 is also coupled through a 0.01 μF capacitor to the cathode of a diode 100-2 in switch 100. The cathode of diode 100-2 is also coupled through a 2.2 KQ resistor to IF2. IF2 is also coupled through a 0.01 μF capacitor to ground. The output terminal of amplifier 98 is also coupled through a series resistive feedback circuit including a 560 Ω resistor and a 180 Ω resistor to ground. The common terminal of these resistors is coupled to the-input terminal of amplifier 98. The-input terminal of amplifier 98 is also coupled through a 0.01 μF capacitor to the anode of a diode 530, the cathode of which is coupled through a 47 Ω resistor to ground. The anode of diode 530 is also coupled through a 2.2 KΩ resistor to the G10A line. The G10A line is coupled to ground through a 0.01 μF capacitor here.

The output terminal of amplifier 98 is also coupled through a series RC circuit including a 51 Ω resistor and a 39 pF capacitor to an input terminal of BPF 102, FIG. 1. The output terminal of BPF 102 is coupled through a 39 pF capacitor to the cathode of a diode 100-3 in switch 100. A parallel LC circuit including a 2.7 μH inductor and a 47 pF capacitor is coupled between the input terminal of BPF 102 and ground. A parallel LC circuit including a 2.7 μH inductor and a 47 pF capacitor is coupled between the output terminal of BPF 102 and ground. The cathode of diode 100-3 is also coupled through a 51 Ω resistor to IF2. IF2 is also coupled to ground here through a 0.01 μF capacitor. BPF 102 illustratively has a center frequency of 10.7 MHz and a passband of 17 KHz. The joined anodes of diodes 100-2 and 100-3 are coupled through a 2.2 KΩ resistor to +5V. +5V is here coupled through a 0.01 μF capacitor to ground. The joined anodes of diodes 100-2 and 100-3 are coupled through a 0.01 μF capacitor to the + input terminal of amplifier 104. The + input terminal of amplifier 104 is also coupled to ground through a 1 KΩ resistor. The output terminal of amplifier 104 is coupled through a series resistive feedback circuit including a 560 Ω resistor and a 180 Ω resistor to ground. The common terminal of these resistors is coupled to the-input terminal of amplifier 104. The-input terminal of amplifier 104 is also coupled through a 0.01 μF capacitor to the anode of a diode 532, the cathode of which is coupled through a 47 Ω resistor to ground. The anode of diode 532 is also coupled through a 2.2 KΩ resistor to the G10B line. The G10B line is coupled to ground through a 0.01 μF capacitor here.

The output terminal of amplifier 104 is also coupled through a series RC circuit including a 51 Ω resistor and a 120 pF capacitor to an input terminal of BPF 106, FIG. 42. The output terminal of BPF 106 is coupled through series 120 pF and 0.01 μF capacitors to an input terminal of switch 110. The common terminal of these capacitors is coupled through a 51 Ω resistor to ground. A parallel LC circuit including a 1.5 μH inductor and a 47 pF capacitor is coupled between the input terminal of BPF 106 and ground. A parallel LC circuit including a 1.5 μH inductor and a 47 pF capacitor is coupled between the output terminal of BPF 106 and ground. The output terminal of amplifier 104 is also coupled through a 51 Ω resistor and 0.01 μF capacitor in series to another input terminal of switch 110.

The output terminal of switch 110 is coupled through a 0.01 μF capacitor to the +input terminal of amplifier 112. The output terminal of switch 110 is also coupled through a 1 KΩ resistor to +5V. +5V is here coupled through a 0.01 μF capacitor to ground. The +input terminal of amplifier 112 is also coupled through a 1 KΩ resistor to ground. The output terminal of amplifier 112 is coupled through a series combination of a 51 Ω resistor and a 0.01 μF capacitor to the IF output 534 from which it is coupled to the DSP 36 where it is A/D converted for further processing. The output terminal of amplifier 112 is also coupled through a feedback resistive circuit including series 560 Ω and 47 Ω resistors to ground. The common terminal of these resistors is coupled to the-input terminal of amplifier 112.

The signals for mixing in mixers 70, 80 with the signals being processed are generated from a reference crystal 116, FIG. 43, such as, for example, a Fox Electronics 12.000 MHz oscillator. Reference crystal 116 is coupled across pins and 10 of a Phase Locked Loop (PLL) circuit 118, such as a National Semiconductor LMX2352 PLL IC. Pin 9 of IC 118 is coupled through a 470 Ω resistor to pin 10 of PLL IC 120, FIG. 44. Pin 9 of PLL IC 118 is also coupled to ground through the parallel combination of a 39 pF capacitor and a capacitor adjustable in value between 3 pF and 18 pF. Pin 10 of PLL IC 118 is coupled through a 56 pF capacitor to ground. PLL IC 120 illustratively also is a National Semiconductor LMX2352 PLL IC. Pin 4 of PLL IC 118 is coupled through a 1 KΩ resistor to an input terminal, pin 1, of a VoltageControlledoscillator IC 536, such as, for example, a Z-Communications type CLV1025E. See FIG. 45. Pin 4 of PLL IC 118 is also coupled to ground through a parallel circuit, one leg of which includes a 3.3 μF capacitor, and the other leg of which includes the series combination of a 0.68 μF capacitor and a 240 Ω resistor. An output terminal, pin 2, of IC 536 is coupled through a series circuit including a 100 pF capacitor, a 270 Ω resistor, and a 100 pF capacitor to an input terminal of amplifier 126. Both terminals of the 270 Ω resistor are coupled to ground through respective 68 Ω resistors. The output terminal of amplifier 126 is coupled through a 100 pF capacitor and a 915 MHz LPF, such as, for example, a Toko 915 MHz low pass chip filter, to the LocalOscillator input terminal, pin 6 of mixer 80, FIG. 37. The output terminal of amplifier 126 is also coupled through a series RC circuit including a 62 Ω resistor and a 100 pF capacitor to pin 6 of PLL IC 118, FIG. 43. The output terminal of amplifier 126 is also coupled through a series 180 nH inductor, 47 Ω resistor and 33 pF capacitor to ground. The common terminal of the 47 Ω resistor and 33 pF capacitor is coupled through a 180 nH inductor to +6VA. +6VA is here coupled to ground through a 33 pF capacitor and a 150 μF capacitor in parallel.

Pin 4 of PLL IC 120 is coupled through a 1 KΩ resistor and 22 nH inductor to the cathode of a varactor diode 538. The anode of diode 538 is coupled to ground. Diode 538 illustratively is a diode of a type SMV1233-004 package. Pin 4 of PLL IC 120 is also coupled to ground through a parallel circuit, one leg of which includes a 560 pF capacitor, and the other leg of which includes a 2700 pF capacitor in series with a 15 KΩ resistor. The cathode of diode 538 is also coupled through series 8 pF and 7 pF capacitors to ground. The common terminal of these capacitors is coupled through a parallel RC circuit including a 39 Ω resistor and a 12 pF capacitor to the emitter of an NPN oscillator transistor 540. A printed trace tuning inductance is coupled in parallel with the 7 pF capacitor. The base of transistor 540 is coupled through a 1.5 KΩ resistor in parallel with the series combination of a 220 pF capacitor and a 4.7 Ω resistor to ground. The collector of transistor 540 is coupled through the series combination of a 180 nH inductor, a 33 Ω resistor and a 10 Ω resistor to +5VALEAK. The common terminal of the 33 Ω resistor and 10 Ω resistor is coupled through parallel 100 pF and 150 μF capacitors to ground. The common terminal of the 180 nH inductor and 33 Ω resistor is coupled through a 20 pF capacitor to ground. Transistor 540 illustratively is a type NE85630 transistor.

The collector of transistor 540 is also coupled through the series combination of a 15 pF capacitor, a 270 Ω resistor and a 100 pF capacitor to the input terminal of amplifier 128. The terminals of the 270 Ω resistor are coupled to ground through respective 68 Ω resistors. The output terminal of amplifier 128 is coupled through a 100 pF capacitor to the LO input terminal, pin 6, of mixer 70. FIG. 36. The output terminal of amplifier 128 is also coupled through the series combination of a 180 Ω resistor and a 100 pF capacitor to pin 6 of PLL IC 120. The output terminal of amplifier 128 is also coupled through a series 180 nH inductor, 39 Ω resistor and 33 pF capacitor to ground. The common terminal of the 39 Ω resistor and 33 pF capacitor is coupled through a 180 nH inductor to +5VLEAK. +5VLEAK is here coupled to ground through a 33 pF capacitor and a 0.01 μF capacitor in parallel.

Pins 2 of both PLL ICs 118, 120 are coupled through respective 10 Ω resistors to +3.3VD. Pins 5, 8, 13, 17 and 20 of both PLL ICs 118, 120 are coupled to ground. Pins 7 of both PLL ICs 118, 120 are coupled through respective 100 pF capacitors to ground. Pins 12 and 23 of both PLL ICs 118, 120 are coupled to +3.3VD. Pins 14 of both PLL ICs 118, 120 are coupled to the RFSPICLK line. Pins 15 of both PLL ICs 118, 120 are coupled to the SPIDT3V line. Pin 3 of IC 118 is coupled through a 10 Ω resistor to +6VA. Pin 3 of IC 120 is coupled through a 10 Ω resistor to +5VALEAK. Pin 16 of PLL IC 118 is coupled to the PLL2ENA line. Pin 16 of PLL IC 120 is coupled to the PLL3ENA line. Pin 22 of IC 118 is coupled to +6VA. Pin 22 of IC 120 is coupled to +5VALEAK.

Referring now to FIG. 46, a signal for calibrating instrument 20 is provided from reference oscillator 130. The oscillator 130 is controlled by the instrument 20's XTALENAble line, which is coupled to pin 1, the ENAble input terminal, of oscillator 130. An OUTput terminal, pin 4, of reference oscillator 130 is coupled through series 470 Ω resistor, 470 Ω resistor, 0.01 μF capacitor and 0.01 μF capacitor to one input terminal of switch 132. The common terminal of the 470 Ω resistors is coupled to ground through a 75 Ω resistor. The common terminal of one of the 470 Ω resistors and one of the 0.01 μF capacitors is also coupled to ground through a 75 μ resistor. A DDS 156 input connector 544 permits injection of a signal from the DDS 156 into the signal path at this point. A SignalLevelMeterINput 546 of instrument 20 is coupled through two series 0.1 μF capacitors to another input port of switch 132, permitting an external calibrate signal to be input via the SLMIN 546 of instrument 20. The common terminal of these two 0.1 μF capacitors is coupled to the common terminal of two series 1 KΩ resistors which are coupled between +5V and ground. This common terminal is also coupled to the cathode of a diode 547 and the anode of a diode 549. The anode of diode 547 is coupled to ground. The cathode of diode 549 is coupled to +5V. +5V is here also coupled through a 0.1 μF capacitor to ground. Diodes 547, 549 illustratively are a type MA4CS102B device. The control terminals of switch 132 are coupled to instrument 20's RFSOURCE and notRFSOURCE lines.

An output terminal of switch 132 is coupled through a 0.1 μF capacitor to an input terminal of a switch 134. The output terminal of switch 132 and input terminal of switch 134 are both coupled to +5V through respective 1 KΩ resistors. +5V is coupled to ground through respective 0.1 μF capacitors at both of these locations. One output terminal of switch 134 is coupled through a 0.1 μF capacitor to an input terminal of a switch 552. The other output terminal of switch 134 is coupled through a 0.1 μF capacitor to an input terminal of an amplifier 554, illustratively a type ERA-1SM RF amplifier. The output terminal of amplifier 554 is coupled through a 0.1 μf capacitor to another input terminal of switch 552. Switches 134, 552 are both controlled from instrument 20's LNA and notLNA lines. The output terminal of amplifier 554 is also coupled through the series combination of a 180 nH inductor and a 39 Ω resistor to +5V. +5V is here coupled through parallel 1000 pF and 0.1 μF capacitors to ground.

The output terminal of switch 552 is coupled through a 0.1 μF capacitor to an input terminal of a switch 556, FIG. 48. The input terminal of switch 556 is also coupled through a 1 KΩ resistor to +5V. +5V is also here coupled through a 0.1 μF capacitor to ground. One output terminal of switch 556 is coupled through a 0.1 μF capacitor to an input terminal of a switch 558. The other output terminal of switch 556 is coupled through the series combination of a 0.1 μF capacitor, a 1 KΩ resistor and a 0.1 μF capacitor to the other input terminal of switch 558. The terminals of the 1 KΩ resistor are coupled through respective 51 Ω resistors to form a 32 dB attenuation pad. Switches 556 and 558 are controlled by instrument 20's ATTN32 and notATTN32 lines. Switches 132, 134, 552, 556 and 558 illustratively are type AS139-73 analog switches. The output terminal of switch 558 is coupled through a 0.1 μF capacitor to an input terminal, pin 2, of a variable attenuator IC 560 in variable attenuator 136. The output terminal of switch 558 is also coupled through a 1 KΩ resistor to +5V. +5V is here coupled to pin 6 of IC 560, and through two parallel 0.1 μF capacitors to ground. As previously noted, IC 560 illustratively is a type AT650233 attenuator. Pins 1, 3, 11, 12, 14 and 16 of IC 560 are coupled to ground. Pin 5 is coupled to −5V. −5V is also here coupled through a 0.1 μF capacitor to ground. Pins 7-10 of IC 560 are coupled to instrument 20's ATTN16, ATTN8, ATTN4 and ATTN2 lines, respectively.

An output terminal, pin 15, of attenuator IC 560 is coupled through a 0.1 μF capacitor to an input terminal of mixer 138, FIG. 36, such as, for example, a Mini Circuits type JMS11X mixer. The signal for mixing in mixer 138 with the signal from attenuator 136 is provided by a PLL IC 141, FIG. 49, such as a National Semiconductor LMX2350 PLL IC. An output terminal, pin 4, of PLL IC 141 is coupled to the +input terminal of an amplifier 562, FIG. 50, such as a type LT1028 amplifier. Pin 4 of PLL IC 141 is also coupled to ground through a parallel circuit, one leg of which includes a 1.5 μF capacitor, and the other leg of which includes a series combination of a 0.33 μF capacitor and a 120 Ω resistor. A feedback circuit including series 470 Ω and 220 Ω resistors is coupled from the output terminal of amplifier 562 to ground. The common terminal of the 470 Ω and 220 Ω resistors is coupled to the-input terminal of amplifier 562. The output terminal of amplifier 562 is coupled through a 1 KΩ resistor to pin 1, the TUNE input terminal, of a VCO IC such as the Z-Communications type V585ME05 IC. Pin 1 of IC 564 is also coupled to ground through a 0.01 μF capacitor. The RF output terminal, pin 2, of IC 564 is coupled through the series combination of a 100 pF capacitor, a 270 Ω resistor, and a 100 pF capacitor to the input terminal of an amplifier 143, such as, for example, a Mini Circuits type ERA-3SM RF amplifier. Both terminals of the 270 Ω resistor are coupled through 68 Ω resistors to ground. The output terminal of amplifier 143 is coupled through a 100 pF capacitor to the LO input terminal of mixer 138, FIG. 36. The output terminal of amplifier 143 is also coupled through the series combination of a 62 Ω resistor and a 100 pF capacitor to pin 6 of IC 141. The output terminal of amplifier 143 is also coupled through the series combination of a 180 nH inductor, a 39 Ω resistor, and a 180 nH inductor to +5VA. +5VA is here coupled to ground through a 33 pF capacitor, a 0.01 μF capacitor, and three 150 μF capacitors, all in parallel. The common terminal of the 39 Ω resistor and the last-mentioned 180 nH inductor is coupled to ground through a 33 pF capacitor.

An output terminal of mixer 138 is coupled through a 100 pF capacitor to an input terminal of switch 72. Switch 72 is controlled by instrument 20's SLM and notSLM lines. Pin 2 of PLL IC 141 is coupled through a 10 Ω resistor to +3.3VD. Pins 5, 8, 13, 17 and 20 of PLL IC 141 are coupled to ground. Pin 7 of PLL IC 141 is coupled through a 100 pF capacitor to ground. Pins 12 and 23 of PLL IC 141 are coupled to +3.3VD. Pin 14 of PLL IC 141 is coupled to the RFSPICLK line. Pin 15 of PLL IC 141 is coupled to the SPIDT3V line. Pin 3 of IC 141 is coupled through a 10 Ω resistor to +5VA. Pin 16 of PLL IC 141 is coupled to the PLL1ENA line. Pin 22 of IC 141 is coupled to +5VA.

Referring now to FIG. 51, DDS 156 can be used to generate RF oscillations to be used externally, via port 157. See FIG. 53. The DDS 156 is controlled from the DSP 36. The DSP 36 also controls the resistance of a variable resistor 162, FIG. 56, such as, for example, an Analog Devices type AD8402AR100 IC. Pins1, 3, 5 and 13 of IC 162 are coupled to ground. Pins 6, 10 and 11 of IC 162 are coupled to +5VOPT. Pins 7-9 of IC 162 is coupled to instrument 20's notPOTentiometer2E, SPIDT5V and SPICLK5V lines, respectively.

Pins 4 and 12 of VR 162 are coupled together and through a 1.2 KΩ resistor to pin 12 of DDS 156, FIG. 51. Pins 1, 2, 5, 10, 19, 24 and 26-28 of DDS 156 are coupled to ground. Pins 3, 4, 6 and 23 of DDS 156 are coupled to +5VOPT. Pins 7-9, 22 and 25 of DDS 156 are coupled to instrument 20's SPICLK5V, notDDSENA, 30 MHzCLK, DDSRESET and SPIDT5V lines, respectively. Pins 11 and 18 of DDS 156 are coupled to +5VA. Pin 15 of DDS 156 is coupled through a 10 KΩ resistor to ground. Pin 16 of DDS 156 is coupled through a 10 KΩ resistor to +5VA, and through a 0.1 μF capacitor to ground. Pin 20 of DDS 156 is coupled to ground through a 39 Ω resistor to ground.

Pin 21 of DDS 156 is coupled through a 75 Ω resistor to ground and through a 0.1 μF capacitor to an input terminal of a 70 MHz discrete LPF 164. LPF 164 includes three sections, the first including a 220 nH inductor and a 4.7 pF capacitor in parallel, the second including a 150 nH inductor and a 22 pF capacitor in parallel, and the third including a 150 nH inductor and an 18 pF capacitor in parallel. The common terminal of the input 0.1 μF capacitor and the first section is coupled through a 22 pF capacitor to ground. The common terminal of the first and second sections is coupled through a 39 pF capacitor to ground. The common terminal of the second and third sections is coupled through a 47 pF capacitor to ground. The output terminal of the third section is coupled through a 33 pF capacitor to ground.

An output terminal of LPF 164 is coupled through two series 0.1 μF capacitors to the +input terminal of amplifier 166, FIG. 52. The +input terminal of amplifier 166 is also coupled through a 150 Ω resistor to ground. The output terminal of amplifier 166 is coupled through a 470 Ω feedback resistor to its-input terminal. The-input terminal of amplifier 166 is coupled through a 47 Ω resistor to ground. The output terminal of amplifier 166 is also coupled through a series 75 Ω resistor and 0.1 μF capacitor to an input terminal of switch 168. The input terminal of switch 168 is also coupled through a 1 KΩ resistor to +5VOPT. +5VOPT is here coupled to ground through a 0.1 μF capacitor. One output terminal of switch 168 is coupled through a 0.1 μF capacitor to an input terminal of switch 170. Another output terminal of switch 168 is coupled through the series combination of a 0.1 μF capacitor, a 232 Ω resistor and a 0.1 μF capacitor to the other input terminal of switch 170. Both terminals of the 232 Ω resistor are coupled to ground through respective 105 Ω resistors. The 232 Ω resistor and 105 Ω resistors form a 15 dB attenuator pad 172. Switches 168, 170 thus permit attenuator 172 to be placed in the circuit between the input terminal of switch 168 and the output terminal of switch 170, or to be removed from it, under the control of μC 22. Control for switches 168 and 170 is provided from instrument 20's PAD and notPAD lines.

The output terminal of switch 170 is coupled to an input terminal of a 70 MHz discrete LPF 174, FIG. 53. The output terminal of switch 170 is also coupled through a 1 KΩ resistor to +5VOPT. +5VOPT is here coupled to ground through a 0.1 μF capacitor. LPF 174 includes three sections, the first including a 220 nH inductor and a 4.7 pF capacitor in parallel, the second including a 150 nH inductor and a 22 pF capacitor in parallel, and the third including a 150 nH inductor and an 18 pF capacitor in parallel. The output terminal of switch 170 is coupled through a 33 pF capacitor to ground. The common terminal of the first and second sections is coupled through a 47 pF capacitor to ground. The common terminal of the second and third sections is coupled through a 39 pF capacitor to ground. The output terminal of the third section is coupled through a 22 pF capacitor to ground, and through a 0.1 μF capacitor to an input terminal of switch 176. Port 155 is coupled through two series 0.1 μF capacitors to the other input terminal of switch 176. The common terminal of these 0.1 μF capacitors is coupled to the common terminal of two series 1 KΩ resistors. The cathode of a diode 565 and the anode of a diode 567 are also coupled to the common terminal of these 0.1 μF capacitors. The anode of diode 565 is coupled to ground. The cathode of diode 567 is coupled to +5VOPT. +5VOPT is here also coupled to ground through a 0.1 μF capacitor. Port 157 is coupled through a 0.1 μF capacitor to the output terminal of switch 176. The output terminal of switch 176 is also coupled through a 1 KΩ resistor to +5VOPT. +5VOPT is also here coupled through a 0.1 μF capacitor to ground. Control for switch 176 is provided from instrument 20's INT and not INT lines.

Control for the RF section 38 is provided from DSP 36 to a Programmable Logic Device, or PLD, 150, such as, for example, a Xilinx model XC9572XL PLD, and from PLD 150 to PLL ICs 118, 120, 141, and to the various other components requiring control. Referring now to FIGS. 55a-e, pins 2, 5, 14, 15,19-21, 27, 33, 41, 54 and 56 of PLD 150 are coupled to ground. Pins 1, 4, 6, 34, 35, 40, 42-52 and 63 of PLD 150 are coupled through respective 4.7 KΩ resistors to +5V. Pins 7-12 of PLD are coupled through respective 1 KΩ resistors to +5V. Pins 26, 37 and 55 are coupled to +3.3V and through respective 0.1 μF capacitors to ground. Pins 1, 7-12, 16, 17, 24, 28-30, 39, 40, 42-53 and 59-63 form instrument 20's notDUCK, G10A, notIF2, IF2, G10B, notIF1, IF1, RFPLDENA, SPICLK3V, SPIDT3V, JTAGTDI, JTAGTMS, JTAGTCK, XTALENA, notRFSOURCE, RFSOURCE, LNA, notLNA, notATTN32, ATTN32, ATTN16, ATTN8, ATTN4, ATTN2, SLM, notSLM, JTAGTDO, PLL1ENA, PLL2ENA, PLL3ENA and RFSPICLK lines, respectively.

Referring now to FIG. 56, pin 1 of a serial electrically erasable programmable read-only memory (EEPROM) 580, illustratively a type AT25160, is coupled to system line notMEMoryENAble. Pin 2 of EEPROM 580 is coupled through 4.7KΩ resistor to SPIDR3V. SPIDR3V is also coupled through a 10KΩ resistor to ground. Pins 3, 7 and 8 of EEPROM 580 are coupled to +5V OPT and to ground through a 0.01 μF capacitor. Pin 4 of EEPROM 580 is coupled to ground. Pins 5 and 6 of EEPROM 580 are coupled to the SPIDT5V and SPICLK5V lines, respectively.

Referring now to FIG. 57, a latched eight-bit shift register 582, illustratively a type 74HC595 IC, has its pins 10 and 16 coupled to +5VOPT and through a 0.01 μF capacitor to ground. Pins 8 and 13 of IC 582 are coupled to ground. Pins 1, 11, 12, 14 and 15 of IC 582 are coupled to instrument 20's DDSRESET, SPICLK3V, OPTENA1, SPIDT3V and DDSCLKENA lines, respectively. Pins 3-6 of IC 582 are coupled through respective 10 KΩ resistors to the bases of respective NPN transistors 584, 586, 588, 590. See FIG. 58. The bases of transistors 584, 586, 588, 590 are coupled through respective 10 KΩ resistors to ground. The emitters of transistors 584, 586, 588, 590 are coupled to ground. The collectors of transistors 584, 586, 588, 590 are coupled through respective 4.7 KΩ resistors to +5VOPT. The collectors of transistors 584, 586, 588, 590 are also coupled to instrument 20's INT, notINT, PAD and notPAD lines, respectively. Transistors 584, 586, 588, 590 illustratively are type MMUN2211LT1 transistors.

Referring now to FIG. 59, a 30 MHz oscillator 592 has its ENAble terminal coupled to instrument 20's DDSCLKENA line. Its VDD and GND terminals are coupled to +5VOPT and ground, respectively. 30 MHzCLocK signal appears on its OUTput terminal.

Referring now to FIG. 60, +5VOPT is coupled through a 10 KΩ resistor to the base of an NPN transistor 594. The base of transistor 594 is coupled to ground through a 10 KΩ resistor. The emitter of transistor 594 is coupled to ground. The collector of transistor 594 is coupled through a 10 KΩ resistor to +5V. The collector of transistor 594 is coupled to terminals notEA and notEB, pins 1 and 19 of an octal three-state buffer 596, FIG. 61, illustratively a type 74HCT244 IC. Pins 1, 3, 7, 9, 13 and 15 of a connector 598 are coupled to pins 2, 4, 6, 8, 17, and 15, respectively, of IC 596. Pin 5 of connector 598 is coupled to line SPIDR3V. Pins 5 and 3 of IC 596 are respectively coupled to system lines OPTENA1 and notPOT2E. Pins 12, 14, 16, and 18 of IC 596 are respectively coupled to system lines notDDSENA, notMEMENA, SPIDT5V, and SPICLK5V. Pin 20 of IC 596 is coupled to +5V and through a 0.1 μF capacitor to ground. Pin 10 of IC 596 is coupled to ground.

Referring now to FIG. 62, a micropower regulator 600, illustratively a type LT1761ES55 IC, includes an input terminal, pin 1, coupled to +5.5V, and through a 1 μF capacitor to ground. Pin 2 of IC 600 is coupled to ground. Pin 3 of IC 600 is coupled through a 1 KΩ resistor to +5VOPT. +5VA is provided at pin 5 of IC 600. Pin 5 is coupled through a 0.01 μF capacitor to pin 4 and through a 10 μF capacitor to ground.

Referring now to FIG. 63, a micropower regulator 602, illustratively a type LT1761ES55 IC, includes an input terminal, pin 1, coupled to +6.5V, and through a 150 μF capacitor to ground. Pin 2 of IC 602 is coupled to ground. Pin 3 of IC 602 is coupled to instrument 20's SLM line. +5VA is provided at pin 5 of IC 600. Pin 5 is coupled through a 0.01 μF capacitor to pin 4 and through a 10 μF capacitor to ground.

Referring now to FIG. 64, a micropower regulator 604, illustratively a type LT1761ES55 IC, includes an input terminal, pin 1, coupled to +6.5V, and through a 150 μF capacitor to ground. Pin 2 of IC 604 is coupled to ground. Pin 3 of IC 604 is coupled to instrument 20's notSLM line. +5VALEAK is provided at pin 5 of IC 604. Pin 5 is coupled through a 0.01 μF capacitor to pin 4 and through a 10 μF capacitor to ground.

Referring now to FIG. 65, a micropower regulator 606, illustratively an LT1761ES5BYP IC, includes an input terminal, pin 1, coupled to +6.5V, and through a 1 μF capacitor to ground. Pin 2 of IC 606 is coupled to ground. Pin 4 is coupled through a 20 KΩ resistor to pin 5, and through a 5.1 KΩ resistor to ground. +6VA is provided at pin 5 of IC 606. Pin 5 is coupled through a 0.01 μF capacitor to pin 3 and through a 150 μF capacitor to ground. Referring now to FIG. 66, a micropower regulator 608, illustratively an LT1761ES5BYP IC, includes an input terminal, pin 1, coupled to instrument 20 +20RES line, through an 18 Ω resistor to +20V, and through a 47 μF capacitor to ground. Pin 2 of IC 608 is coupled to ground. Pin 4 is coupled through a 24 KΩ resistor to pin 5, and through a 2.7 KΩ resistor to ground. +12V is provided at pin 5 of IC 608. Pin 5 is coupled through a 0.01 μF capacitor to pin 3, and through a 47 μF capacitor to ground.

What is claimed is:

1. An instrument for testing a CATV network, the instrument including
an input port for receiving first information from the network, a computer coupled to the input port for processing the first information received from the network, a user interface permitting a user to create second information for communication over the network, and a serial port for coupling the second information to the network.

2. The instrument of claim 1 wherein the serial port is an RS-232 port.

3. The instrument of claim 1 further including an RF section for processing signals received from the CATV network.

4. The instrument of claim 3 further including an analog-to-digital (A/D) converter, the A/D converter coupled to the RF section for conversion of RF section output into digital RF-related signals.

5. The instrument of claim 4 further including a digital signal processor (DSP), the A/D converter coupled to the DSP for processing of the digital RF-related signals.

6. The instrument of claim 1 wherein the first information is first analog information, the instrument further including an analog-to-digital (A/D) converter for converting the first analog information to first digital information.

7. The instrument of claim 6 further including a digital signal processor (DSP), the A/D converter coupled to the DSP for processing the first digital information.

8. The instrument of claim 1 further including an audio transducer coupled to the computer for producing audio signals in response to third information received from the computer.

9. The instrument of claim 8 further including a digital-to-analog (D/A) converter coupled between the computer and the audio transducer for converting the third information into signals to be transduced by the audio transducer.

10. The instrument of claim 9 further including a digital signal processor (DSP) coupled to the computer and to the D/A converter for processing third information and for supplying processed third information to the D/A converter.

11. The instrument of claim 1 further including a signature pad coupled to the serial port permitting transmission of signature pad-related signals over the network

12. The instrument of claim 11 wherein the signature pad is coupled to the serial port through the computer.

13. An instrument for testing a CATV network, the instrument including
an input port for receiving first information from the network, a computer coupled to the input port for processing the first information, a signature pad permitting a user to enter handwritten communication for transmission over the network, and a port for coupling handwritten communication-related signals to the network.

14. The instrument of claim 13 wherein the first information if first radio frequency (RF) analog information, the instrument further including an RF section coupled to the input port for processing the first information.

15. The instrument of claim 14 further including an analog-to-digital (A/D) converter, the A/D converter coupled to the RF section for conversion of RF section output into digital RF-related signals.

16. The instrument of claim 15 further including a digital signal processor (DSP), the A/D converter coupled to the DSP for processing of the digital RF-related signals.

17. The instrument of claim 13 wherein the first information is first analog information, the instrument further including an analog-to-digital (A/D) converter for converting the first analog information to first digital information.

18. The instrument of claim 17 further including a digital signal processor (DSP), the A/D converter coupled to the DSP for processing the first digital information.

19. The instrument of claim 13 further including an audio transducer coupled to the computer for producing audio signals in response to third information received from the computer.

20. The instrument of claim 19 further including a digital-to-analog (D/A) converter coupled between the computer and the audio transducer for converting the third information into signals to be transduced by the audio transducer.

21. The instrument of claim 20 further including a digital signal processor (DSP) coupled to the computer and to the D/A converter for processing third information and for supplying processed third information to the D/A converter.

22. The instrument of claim 13 wherein the port includes a serial port.

23. The instrument of claim 22 wherein the port includes an RS232 port.

24. The instrument of claim 22 wherein the port includes an ethernet interface.

25. An instrument for testing a CATV network, the instrument including
an input port for receiving first information from the network, a computer coupled to the input port for processing the first information, a user interface permitting a user to create second information for communication over the network, and an ethernet interface for coupling the second information to the network.

26. The instrument of claim 25 including a Web browser capable of handling internet communication protocols.

27. The instrument of claim 25 further including a signature pad coupled to the serial port permitting transmission of signature pad-related signals over the network

28. The instrument of claim 27 wherein the signature pad is coupled to the serial port through the computer.

29. The instrument of claim 25 wherein the first information is first analog information, the instrument further including an analog-to-digital (A/D) converter for converting the first analog information to first digital information.

30. The instrument of claim 29 further including a digital signal processor (DSP), the AID converter coupled to the DSP for processing the first digital information.

31. The instrument of claim 25 wherein the first information if first radio frequency (RF) analog information, the instrument further including an RF section coupled to the input port for processing the first information.

32. The instrument of claim 31 further including an analog-to-digital (A/D) converter, the A/D converter coupled to the RF section for conversion of RF section output into digital RF-related signals.

33. The instrument of claim 32 further including a digital signal processor (DSP), the A/D converter coupled to the DSP for processing of the digital RF-related signals.

34. The instrument of claim 1 including a Web browser capable of handling internet communication protocols.

35. The instrument of claim 13 including a Web browser capable of handling internet communication protocols.

36. The instrument of claim 1 wherein the input port and output port are RF ports.

37. The instrument of claim 13 wherein the input port and output port are RF ports.

38. The instrument of claim 25 wherein the input port and output port are RF ports.

39. An instrument for determining received signal power, the instrument including a receiver for receiving the signal, and a device for multiplying the received signal amplitude by the sine and cosine, squaring these products, and adding the squared products together to produce an indication of the received signal power.

40. The instrument of claim 39 further including an analog-to-digital (A/D) converter coupled to the receiver for sampling the received signal amplitude and to the device for providing sampled received signal amplitudes to the device for multiplying by the sine and cosine.

41. A method for determining received signal power, the method including receiving the signal, multiplying the received signal by the sine and cosine, squaring the products of these multiplications, adding the squared products, and producing an indication of the received signal power.
